(19) United States
(12) Patent Application Publication
(10) Pub. No.: US 2008/0081120 A1
(43) Pub. Date: Apr. 3, 2008

(54) Superprimer

(76) Inventors: Wim Johan Van Ooij, Fairfield, OH (US); Trilok Mugada, Cincinnati, OH (US); Karthik Suryanarayanan, Cincinnati, OH (US); Anuj Seth, Cincinnati, OH (US); Danqing Zhu, Cincinnati, OH (US); Lin Yang, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/821,089

(22) Filed: Jun. 21, 2007

Related U.S. Application Data
(63) Continuation of application No. PCT/US05/47036, filed on Dec. 22, 2005.
(60) Provisional application No. 60/638,729, filed on Dec. 22, 2004.
(60) Provisional application No. 60/695,333, filed on Jun. 30, 2005.

(51) Int. Cl. C08K 3/08; B05D 3/02

(52) U.S. Cl. 427/387; 524/186; 524/320; 524/403; 524/405; 524/406; 524/408; 524/413; 524/414; 524/419; 524/434; 524/588; 528/33

(57) ABSTRACT

A composition capable of coating a substrate and curing to provide a hydrophobic film inhibiting corrosion, the composition comprising: (a) a bis-silane comprising between about 0.5 weight percent to about 50 weight percent of the composition; and (b) a water soluble or dispersible polymer comprising between 10 weight percent to about 80 weight percent of the composition. A further exemplary superprimer in accordance with the instant invention includes a composition capable of coating a substrate and curing to provide a hydrophobic film inhibiting corrosion, the composition comprising: (a) a mixture of silanes; (b) a dispersible or soluble resin; and (c) an aqueous or non-aqueous solvent. Moreover, the invention includes the aforementioned superprimer composition, wherein the mixture of silanes includes at least one of a bis-sulfur silane, a bis-benzene silane, a bis-alkane silane, a bis-alkene silane, and a bis-amino silane.

### CROSS-REFERENCE TO RELATED APPLICATIONS

This application is a continuation that claims priority under 35 U.S.C. §120 of Patent Cooperation Treaty Application Serial No. PCT/US05/47036 filed on Dec. 22, 2005, entitled “SUPERPRIMER” which claimed priority to U.S. Provisional Patent Application Ser. No. 60/638,729, entitled “IMPROVED SUPERPRIMER,” filed Dec. 22, 2004, and U.S. Provisional Patent Application Ser. No. 60/695,333, entitled “SILANE ENHANCED ZINC-RICH COATING,” filed Jun. 30, 2005, the disclosures of which are hereby incorporated by reference.

### FEDERAL FUNDING STATEMENT

This invention was made with Government Support under Multidisciplinary University Research Initiative Contract No. G100218-100206-7200300000 and under Strategic Environmental Research and Development Program Contract No. G100346-1002189-7200300000. The Government has certain rights in this invention.

### FIELD OF THE INVENTION

The present inventions relates to corrosion protection and increased adhesion between substrates and a subsequent bonded material. More specifically, the present invention is related to primers, manufactured from at least one organofunctional bis-silane, having increased film thickness, chemical and scratch resistance, as well as being substantially chromate-free and comprising little to no VOCs.

### SUMMARY OF THE INVENTION

The present invention provides an improved superprimer that can be used in a wide range of environments, on all metals of engineering interest, as a standalone process or as a primer for a paint application process. The exemplary improved superprimer may function as a final coating and may likewise be applied to a substrate without a conversion coating or pretreatment process.

An exemplary superprimer in accordance with the instant invention includes a composition capable of coating a substrate and curing to provide a hydrophobic film inhibiting corrosion, the composition comprising: (a) a bis-silane; and (b) a water soluble or dispersible polymer. Moreover, the invention includes the aforementioned superprimer composition, further comprising at least one of an emulsifier, a surfactant, a film builder, a thickener, a toughening agent, an ultraviolet absorber, and an ultraviolet reflector. Moreover, the invention includes the aforementioned superprimer composition, further comprising a leachable inhibitor. Moreover, the invention includes the aforementioned superprimer composition, wherein the leachable inhibitor includes at least one of a salt of trivalent cerium (Ce), a salt of trivalent lanthanum (Le), a salt of yttrium (Y), a molybdate, a phosphate, a phosphonate, a phosphomolybdate, a vanadate, a borate, an amine, a glycolate, a sulfenamide, and a tungstate. Moreover, the invention includes the aforementioned superprimer composition, wherein the bis-silane comprises between about 0.5 percent to about 50 weight percent by weight of the composition, and the water soluble or dispersible polymer comprises between 10 percent to about 80 weight percent by weight of the composition. Moreover, the invention includes the aforementioned superprimer composition, wherein the bis-silane comprises a mixture of silanes comprising at least one partially hydrolyzed bis-silane. Moreover, the invention includes the aforementioned superprimer composition, wherein the bis-silane comprises a mixture of bis-silanes. Moreover, the invention includes the aforementioned superprimer composition, further comprising a crosslinking agent for at least one of the resin and the silane. Moreover, the invention includes the aforementioned superprimer composition, further comprising nanoparticles. Moreover, the invention includes the aforementioned superprimer composition, further comprising at least one of oxidic particles and non-oxidic particles comprising between about 1 to about 95 weight percent of the composition. Moreover, the invention includes the aforementioned superprimer composition, wherein the composition includes at least one of zinc dust, carbon black, silica, and iron oxide.

The instant invention includes a method of a coating inhibiting the permeability of a fluid comprising the steps of: (a) mixing a bis-silane and a soluble or dispersible polymer to comprise a resultant mixture; (b) applying the resultant mixture to a substrate; and (c) curing the resultant mixture on the substrate to create a corrosion barrier. Moreover, the invention includes the aforementioned method, wherein the mixing step further includes mixing at least a partially hydrolyzed bis-silane with a water soluble or dispersible polymer. Moreover, the invention includes the aforementioned method, wherein the mixing step further includes mixing multiple silanes, including a bis-silane, with the soluble or dispersible polymer.

An exemplary superprimer in accordance with the instant invention includes a liquid coating composition, adapted to be applied to a substrate to form a coating, comprising between about 30-95 weight percent zinc dust, between about 5-22 weight percent organic binder, between about 0.2-4 weight percent silane. Moreover, the invention includes the aforementioned coating composition, further comprising a curing agent from about 0.1 to about 4 weight percent of the liquid coating composition.

The instant invention includes a method of forming a liquid coating composition comprising: (a) mixing zinc dust, a solvent, and a resin to form a first part; (b) mixing a silane and a curing agent to form a second part; and (c) mixing the first part and the second part to provide a liquid coating composition comprising between about 15-80 weight percent zinc dust, between about 5-22 weight percent water soluble resin, between about 0.5-50 weight percent silane, between about 1-4 weight percent curing agent, and between about 5-40 weight percent solvent. The aforementioned method may also include the act of mixing the first part and the second part under high shear conditions.

The instant invention includes a method of forming a coating composition comprising: (a) mixing zinc dust, a solvent, and a resin to form a first part; and, (b) mixing a silane, the first part, and a curing agent to provide a liquid coating composition comprising between about 15-80 weight percent zinc dust, between about 5-22 weight percent water soluble resin, between about 0.5-50 weight percent silane, between about 1-4 weight percent curing agent, and between about 5-40 weight percent solvent. The aforementioned method may also include the act of mixing the silane, the first part, and the curing agent under high shear conditions.

The instant invention includes a method of forming a coating composition comprising: (a) mixing a non-aqueous solvent and a resin to form a first part; and (b) mixing a silane and the first part to provide a liquid coating composition comprising between about 5-60 weight percent water soluble resin, between about 0.5-50 weight percent silane, and between about 5-40 weight percent solvent. The aforementioned method may also include the act of mixing the silane, the first part, and the curing agent under high shear conditions.

The instant invention includes a method of forming a coating composition comprising: (a) mixing zinc dust, non-aqueous solvent, and a resin to form a water based first part; and (b) mixing the first part with a silane to provide a liquid composition comprising between about 15-80 weight percent zinc dust, between about 5-22 weight percent water soluble resin, between about 0.5-50 weight percent silane, and between about 5-40 weight percent solvent.

The instant invention includes a method of forming a coating composition comprising mixing zinc dust, a resin, and a silane substantially simultaneously to comprise a water based liquid composition comprising between about 30-75 weight percent zinc dust, between about 5-22 weight percent water soluble resin, between about 0.5-50 weight percent silane, between about 1-4 weight percent curing agent, and between about 5-40 weight percent solvent, where the coating composition is adapted to be applied to a substrate to form a coating. The aforementioned method may further comprising the step of adding a corrosion inhibitor to the composition, wherein the coating composition comprises between about 1-50 weight percent corrosion inhibitor, and wherein at least one of the mixing steps occurs under high shear conditions.

An exemplary superprimer in accordance with the instant invention includes a composition capable of coating a substrate and curing to provide a hydrophobic film inhibiting corrosion, the composition comprising: (a) a mixture of silanes; (b) a dispersible or soluble resin; and (c) an aqueous or non-aqueous solvent. Moreover, the invention includes the aforementioned superprimer composition, wherein the mixture of silanes includes at least one of a bis-sulfur silane, a bis-benzene silane, a bis-alkane silane, a bis-alkene silane, and a bis-amino silane. Moreover, the invention includes the aforementioned superprimer composition, wherein the bis-amino silane includes bis-trimethoxysilylpropylamine, bis-trimethoxysilylpropyldiamine; the bis-sulfur silane includes at least one of bis-(triethylsilyipropyl) disulfide and bis[3-(triethoxysilyl)propyl]disulfide; the bis-benzene silane includes 1,4-bis(trimethoxysilylethyl)benzene; and the bis-alkane silane includes bis-(triethoxysilyl)ethane and bis-triethoxysilyloctane. Moreover, the invention includes the aforementioned superprimer composition, wherein the silane includes a mixture of bis-silanes; the dispersible or soluble resin includes at least one of an epoxy resin, polyurethane resin, an amino resin, a polyisocyanate resin, a polyester resin, a polyalkyd resin, and an acrylic resin; and the aqueous or non-aqueous solvent includes water, acetone, ketones, alcohols, and alcohol derivatives. Moreover, the invention includes the aforementioned superprimer composition, wherein the epoxy resin includes a novalac or a diglycidyl ether of bisphenol A; the polyurethane resin includes a polyether urea component; and the amino resin includes an aliphatic amine. Moreover, the invention includes the aforementioned superprimer composition, wherein the bis-silane comprises between about 0.5 percent by weight to about 50 percent by weight of the composition; and the dispersible of soluble resin comprises between about 5 percent by weight to about 90 percent by weight of the composition.

An exemplary superprimer in accordance with the instant invention includes the aforementioned superprimer composition, further comprising at least one of zinc dust, carbon black, potassium silicate platelets, titanium dioxide, trimethysilyloxy modified silica, silica, talc, clays, iron oxide, and precipitated silica. Moreover, the invention includes the aforementioned superprimer composition, wherein the zinc dust and/or the carbon black comprises between about 1 percent by weight to about 90 percent by weight of the composition. Moreover, the invention includes the aforementioned superprimer composition, further comprising at least one of a curing agent, an anti-settling agent; a defoaming agent, a wetting agent, a crosslinker, a corrosion inhibitor, a coalescing agent, an emulsifier, and an inorganic color pigment. Moreover, the invention includes the aforementioned superprimer composition, wherein the crosslinker comprises between about 0.1 percent by weight to about 5 percent by weight of the composition. Moreover, the invention includes the aforementioned superprimer composition, wherein the crosslinker includes at least one of an isocyanurate, an amine, dibutyltin dilaurate, and an imine. Moreover, the invention includes the aforementioned superprimer composition, wherein the curing agent comprises between about 0.1 percent by weight to about 5 percent by weight of the composition. Moreover, the invention includes the aforementioned superprimer composition, wherein the curing agent includes at least one of a polyisocyanate and an amine adduct. Moreover, the invention includes the aforementioned superprimer composition, wherein the anti-settling agent comprises between about 0.1 percent by weight to about 5 percent by weight of the composition. Moreover, the invention includes the aforementioned superprimer composition, wherein the corrosion inhibitor comprises between about 0.01 percent by weight to about 25 percent by weight of the composition. Moreover, the invention includes the aforementioned superprimer composition, wherein the corrosion inhibitor includes at least one of zinc phosphate, zinc molybdate, calcium-zinc molybdate, cerium vanadium oxide, calcium-zinc phosphosilicate, cerium acetate, sodium metavanadate, and calcium zinc phosphomolybdate. Moreover, the invention includes the aforementioned superprimer composition, wherein the coalescing agent comprises between about 0.1 percent by weight to about 5 percent by weight of the composition. Moreover, the invention includes the aforementioned superprimer composition, wherein the coalescing agent includes a coalescing agent for a latex. Moreover, the invention includes the aforementioned superprimer composition, further comprising a latex. Moreover, the invention includes the aforementioned superprimer composition, wherein the latex includes an acrylate latex. Moreover, the invention includes the aforementioned superprimer composition, wherein the inorganic color pigment includes iron oxide, cobalt, cobalt complexes, titania, metallic nanoparticles, and metallic flakes.

The instant invention includes a method of formulating a liquid coating, the method comprising mixing a silane mixture with a dispersed or soluble resin to form a liquid coating composition. Moreover, the invention includes the aforementioned method, wherein the silane mixture includes a bis-silane mixture. Moreover, the invention includes the aforementioned method, wherein the silane includes at least one of a bis-sulfur silane, a bis-benzene silane, a bis-alkane silane, a bis-alkene silane, and a bis-amino silane. Moreover, the invention includes the aforementioned method, wherein the silane includes a first silane mixture comprising a vinyltriacetoxysilane and a bis-trimethoxysilylpropylamine silane in a 5:1 weight ratio; and, the silane includes a second silane component comprising at least one of a bis-[triethoxysilylpropyl]tetrasulfide silane and tetraethoxysilane. Moreover, the invention includes the aforementioned method, further comprising diluting the first silane mixture with a aqueous or non-aqueous solvent to create a first silane component; and, mixing the first silane component with the dispersed or soluble resin to form a liquid coating composition. Moreover, the invention includes the aforementioned method, wherein the act of mixing the silane mixture and the disbursed or soluble resin is carried out under high shear conditions. Moreover, the invention includes the aforementioned method, wherein the silane mixture comprises between about 0.5 to about 75 weight percent of the liquid coating composition; and, the dispersed or soluble resin comprises between about 25 to about 95 weight percent of the liquid coating composition. Moreover, the invention includes the aforementioned method, further comprising mixing at least one of carbon black and zinc dust with at least one of the silane mixture and the dispersed or soluble resin. Moreover, the invention includes the aforementioned method, wherein the zinc dust comprises between about 5 to about 50 weight percent of the liquid coating composition. Moreover, the invention includes the aforementioned method, wherein the dispersed or soluble resin includes at least one of an epoxy, an acrylic, a polyurethane, and an acrylate copolymer.

An exemplary method of formulating a liquid coating in accordance with the instant invention includes method, further comprising mixing a crosslinker with at least one of the silane mixture and the dispersed or soluble resin. Moreover, the invention includes the aforementioned method, wherein the crosslinker comprises between about 0.01 to about 5 weight percent of the liquid coating composition. Moreover, the invention includes the aforementioned method, further comprising mixing an aqueous solvent with at least one of the silane mixture and the dispersed or soluble resin. Moreover, the invention includes the aforementioned method, wherein the aqueous solvent comprises between about 10 to about 50 weight percent of the liquid coating composition. Moreover, the invention includes the aforementioned method, further comprising mixing a non-aqueous solvent with at least one of the silane mixture and the dispersed or soluble resin. Moreover, the invention includes the aforementioned method, wherein the non-aqueous solvent comprises between about 10 to about 50 weight percent of the liquid coating composition. Moreover, the invention includes the aforementioned method, further comprising mixing an additive with at least one of the silane mixture and the dispersed or soluble resin, the additive comprising at least one of a curing agent, a thickening agent, a corrosion inhibitor, and a wetting agent. Moreover, the invention includes the aforementioned method, wherein the additive comprises between about 0.5 to about 50 weight percent of the liquid coating. Moreover, the invention includes the aforementioned method, wherein the curing agent includes an aliphatic amine. Moreover, the invention includes the aforementioned method, wherein the non-aqueous solvent includes at least one of acetone, a ketone, and an alcohol. Moreover, the invention includes the aforementioned method, wherein the liquid coating further comprises a latex.

An exemplary superprimer in accordance with the instant invention includes a silane containing coating comprising: (a) zinc dust, comprising between about 70 to about 90 weight percent of a resulting coating; (b) a dispersible resin comprising between about 10 to about 30 weight percent of the resulting coating; and (c) a silane comprising between about 0.5 to about 20 weight percent of the resulting coating.

An exemplary superprimer in accordance with the instant invention includes a silane containing coating comprising: (a) carbon black, comprising between about 40 to about 80 weight percent of a resulting coating; (b) a dispersible resin comprising between about 10 to about 30 weight percent of the resulting coating; and (c) a silane comprising between about 0.5 to about 50 weight percent of the resulting coating.

### BRIEF DESCRIPTION OF THE DRAWINGS

FIG. 1 is a pictorial representation of an exemplary aluminum alloy panel coated with an exemplary superprimer formulation after 14 days of salt spray testing;

FIG. 2 is a graphical representation of Electrochemical Impedance Spectroscopy (EIS) data for an exemplary superprimer and for a commercially available primer; FIGS. 3 and 4 pictorially represent exemplary panels coated with the zinc-rich paint and coated with the zinc-rich superprimer, respectively, after 336 hours of salt spray testing

FIG. 3 is a pictorial representation of exemplary panels coated with a commercially available zinc-rich paint after 336 hours of salt spray testing;

FIG. 4 is a pictorial representation of exemplary panels coated with an exemplary zinc-rich superprimer formulation after 336 hours of salt spray testing;

FIG. 5 is a pictorial representation of exemplary panels coated with an exemplary zinc-rich superprimer formulation after 200 hours of salt spray testing;

FIG. 6 is a pictorial representation of exemplary panels coated with a commercially available chromate primer after 200 hours of salt spray testing;

FIG. 7 is a graphical representation of Electrochemical Impedance Spectroscopy (EIS) data for the commercially available zinc rich primer using data taken between 2 hours and six weeks of immersion in a salt solution;

FIG. 8 is a graphical representation of Electrochemical Impedance Spectroscopy (EIS) data for the zinc rich superprimer of Experiment 2 taken at selective increments over a period of six weeks while the panels were immersed in a salt solution;

FIG. 9 is a graphical representation of Electrochemical Impedance Spectroscopy (EIS) modulus data for Experiment 3 on a controlled set of panels immersed in a salt solution;

FIG. 10 is a graphical representation of Electrochemical Impedance Spectroscopy (EIS) phase angle data for Experiment 3 on a controlled set of panels immersed in a salt solution;

FIG. 11 is a graphical representation of Electrochemical Impedance Spectroscopy (EIS) modulus data for Experiment 3 on a set of panels having a first exemplary superprimer formulation applied thereto and immersed in a salt solution;

FIG. 12 is a graphical representation of Electrochemical Impedance Spectroscopy (EIS) phase angle data for Experiment 3 on a set of panels having the first exemplary superprimer formulation applied thereto and immersed in a salt solution;

FIG. 13 is a graphical representation of Electrochemical Impedance Spectroscopy (EIS) modulus data for Experiment 3 on a set of panels having a commercially available zinc rich primer applied thereto and immersed in a salt solution;

FIG. 14 is a graphical representation of Electrochemical Impedance Spectroscopy (EIS) phase angle data for Experiment 3 on a set of panels having the commercially available zinc rich primer applied thereto and immersed in a salt solution;

FIG. 15 is a graphical representation of Electrochemical Impedance Spectroscopy (EIS) modulus data for Experiment 8 on a set of panels having a first exemplary superprimer formulation applied thereto and immersed in a salt solution;

FIG. 16 is a graphical representation of Electrochemical Impedance Spectroscopy (EIS) phase angle data for Experiment 8 on a set of panels having the first exemplary superprimer formulation applied thereto and immersed in a salt solution;

FIG. 17 is a graphical representation of Electrochemical Impedance Spectroscopy (EIS) modulus data for Experiment 8 on a set of panels having a second exemplary superprimer formulation applied thereto and immersed in a salt solution;

FIG. 18 is a graphical representation of Electrochemical Impedance Spectroscopy (EIS) phase angle data for Experiment 8 on a set of panels having the second exemplary superprimer formulation applied thereto and immersed in a salt solution;

FIG. 19 is a graphical representation of Electrochemical Impedance Spectroscopy (EIS) modulus data for Experiment 8 on a set of panels having a third exemplary superprimer formulation applied thereto and immersed in a salt solution;

FIG. 20 is a graphical representation of Electrochemical Impedance Spectroscopy (EIS) phase angle data for Experiment 8 on a set of panels having the third exemplary superprimer formulation applied thereto and immersed in a salt solution;

FIG. 21 a

FIG. 22 is a

FIG. 23 a graphical representation of Electrochemical Impedance Spectroscopy (EIS) modulus data for Experiment 10 on a set of panels having a first exemplary superprimer formulation applied thereto and immersed in a salt solution;

FIG. 24 is a graphical representation of Electrochemical Impedance Spectroscopy (EIS) modulus data for Experiment 10 on a set of panels having a commercially available zinc rich paint applied thereto and immersed in a salt solution;

FIG. 25 is a graphical representation of Electrochemical Impedance Spectroscopy (EIS) data for Experiment 10 comparing the commercially available zinc rich paint to the first exemplary superprimer formulation;

FIG. 26 a graphical representation of Electrochemical Impedance Spectroscopy (EIS) modulus data for Experiment 10 on a set of panels having a second exemplary superprimer formulation applied thereto and immersed in a salt solution;

FIG. 27 is a graphical representation of Electrochemical Impedance Spectroscopy (EIS) modulus data for Experiment 10 on a set of panels having a second exemplary superprimer formulation applied thereto and immersed in a salt solution;

FIG. 28 is a graphical representation of Electrochemical Impedance Spectroscopy (EIS) data for Experiment 10 comparing the commercially available zinc rich paint to the second and third exemplary superprimer formulations;

FIG. 29 is a pictorial representation of a panel coated with the commercially available zinc rich paint after 168 hours of immersion in a salt solution;

FIG. 30 is a pictorial representation of a panel coated with the first exemplary superprimer formulation of Experiment 10 after 168 hours of immersion in a salt solution;

FIG. 31 is a listing of the exemplary formulations of Experiment 11;

FIG. 32 is a graphical representation of Electrochemical Impedance Spectroscopy (EIS) modulus data for Experiment 11 on a controlled set of panels having no primer applied thereto and immersed in a salt solution;

FIG. 33 is a graphical representation of Electrochemical Impedance Spectroscopy (EIS) phase angle data for Experiment 11 on a controlled set of panels having no primer applied thereto and immersed in a salt solution;

FIG. 34 is a graphical representation of Electrochemical Impedance Spectroscopy (EIS) modulus data for Experiment 11 on a set of panels having a first exemplary superprimer formulation applied thereto and immersed in a salt solution;

FIG. 35 is a graphical representation of Electrochemical Impedance Spectroscopy (EIS) phase angle data for Experiment 11 on a set of panels having a first exemplary superprimer formulation applied thereto and immersed in a salt solution;

FIG. 36 is a graphical representation of Electrochemical Impedance Spectroscopy (EIS) modulus data for Experiment 11 on a set of panels having a second exemplary superprimer formulation applied thereto and immersed in a salt solution;

FIG. 37 is a graphical representation of Electrochemical Impedance Spectroscopy (EIS) phase angle data for Experiment 11 on a set of panels having a second exemplary superprimer formulation applied thereto and immersed in a salt solution;

FIG. 38 is a graphical representation of Electrochemical Impedance Spectroscopy (EIS) modulus data for Experiment 11 on a set of panels having a third exemplary superprimer formulation applied thereto and immersed in a salt solution;

FIG. 39 is a graphical representation of Electrochemical Impedance Spectroscopy (EIS) phase angle data for Experiment 11 on a set of panels having a third exemplary superprimer formulation applied thereto and immersed in a salt solution;

FIG. 40 is a graphical representation of Electrochemical Impedance Spectroscopy (EIS) modulus data for Experiment 11 on a set of panels having a fourth exemplary superprimer formulation applied thereto and immersed in a salt solution;

FIG. 41 is a graphical representation of Electrochemical Impedance Spectroscopy (EIS) phase angle data for Experiment 11 on a set of panels having a fourth exemplary superprimer formulation applied thereto and immersed in a salt solution;

FIG. 42 is a graphical representation of Electrochemical Impedance Spectroscopy (EIS) modulus data for Experiment II on a set of panels having a fifth exemplary superprimer formulation applied thereto and immersed in a salt solution;

FIG. 43 is a graphical representation of Electrochemical Impedance Spectroscopy (EIS) phase angle data for Experiment 11 on a set of panels having a fifth exemplary superprimer formulation applied thereto and immersed in a salt solution;

FIG. 44 is a graphical representation of Electrochemical Impedance Spectroscopy (EIS) modulus data for Experiment 11 on a set of panels having a sixth exemplary superprimer formulation applied thereto and immersed in a salt solution;

FIG. 45 is a graphical representation of Electrochemical Impedance Spectroscopy (EIS) phase angle data for Experiment 11 on a set of panels having a sixth exemplary superprimer formulation applied thereto and immersed in a salt solution;

FIG. 46 is a graphical representation of Electrochemical Impedance Spectroscopy (EIS) modulus data for Experiment 11 on a set of panels having a seventh exemplary superprimer formulation applied thereto and immersed in a salt solution;

FIG. 47 is a graphical representation of Electrochemical Impedance Spectroscopy (EIS) phase angle data for Experiment 11 on a set of panels having a seventh exemplary superprimer formulation applied thereto and immersed in a salt solution;

FIG. 48 is a graphical representation of Electrochemical Impedance Spectroscopy (EIS) modulus data for Experiment 11 on a set of panels having a eighth exemplary superprimer formulation applied thereto and immersed in a salt solution;

FIG. 49 is a graphical representation of Electrochemical Impedance Spectroscopy (EIS) phase angle data for Experiment 11 on a set of panels having a eighth exemplary superprimer formulation applied thereto and immersed in a salt solution;

FIG. 50 is a graphical representation of Electrochemical Impedance Spectroscopy (EIS) modulus data for Experiment 11 on a set of panels having a ninth exemplary superprimer formulation applied thereto and immersed in a salt solution;

FIG. 51 is a graphical representation of Electrochemical Impedance Spectroscopy (EIS) phase angle data for Experiment 11 on a set of panels having a ninth exemplary superprimer formulation applied thereto and immersed in a salt solution;

FIG. 52 is a listing of the exemplary formulations of Experiment 12;

FIG. 53 is a graphical representation of Electrochemical Impedance Spectroscopy (EIS) modulus data for Experiment 12 on a set of panels having a first exemplary superprimer formulation applied thereto and immersed in a salt solution;

FIG. 54 is a graphical representation of Electrochemical Impedance Spectroscopy (EIS) phase angle data for Experiment 12 on a set of panels having a first exemplary superprimer formulation applied thereto and immersed in a salt solution;

FIG. 55 is a graphical representation of Electrochemical Impedance Spectroscopy (EIS) modulus data for Experiment 12 on a set of panels having a second exemplary superprimer formulation applied thereto and immersed in a salt solution;

FIG. 56 is a graphical representation of Electrochemical Impedance Spectroscopy (EIS) phase angle data for Experiment 12 on a set of panels having a second exemplary superprimer formulation applied thereto and immersed in a salt solution;

FIG. 57 is a graphical representation of Electrochemical Impedance Spectroscopy (EIS) modulus data for Experiment 12 on a set of panels having a third exemplary superprimer formulation applied thereto and immersed in a salt solution;

FIG. 58 is a graphical representation of Electrochemical Impedance Spectroscopy (EIS) phase angle data for Experiment 12 on a set of panels having a third exemplary superprimer formulation applied thereto and immersed in a salt solution;

FIG. 59 is a graphical representation of Electrochemical Impedance Spectroscopy (EIS) modulus data for Experiment 12 on a set of panels having a fourth exemplary superprimer formulation applied thereto and immersed in a salt solution;

FIG. 60 is a graphical representation of Electrochemical Impedance Spectroscopy (EIS) phase angle data for Experiment 12 on a set of panels having a fourth exemplary superprimer formulation applied thereto and immersed in a salt solution;

FIG. 61 is a graphical representation of Electrochemical Impedance Spectroscopy (EIS) modulus data for Experiment 12 on a set of panels having a fifth exemplary superprimer formulation applied thereto and immersed in a salt solution;

FIG. 62 is a graphical representation of Electrochemical Impedance Spectroscopy (EIS) phase angle data for Experiment 12 on a set of panels having a fifth exemplary superprimer formulation applied thereto and immersed in a salt solution;

FIG. 63 is a graphical representation of Electrochemical Impedance Spectroscopy (EIS) modulus data for Experiment 12 on a set of panels having a sixth exemplary superprimer formulation applied thereto and immersed in a salt solution;

FIG. 64 is a graphical representation of Electrochemical Impedance Spectroscopy (EIS) phase angle data for Experiment 12 on a set of panels having a sixth exemplary superprimer formulation applied thereto and immersed in a salt solution;

FIG. 65 is a graphical representation of Electrochemical Impedance Spectroscopy (EIS) modulus data for Experiment 12 on a set of panels having a seventh exemplary superprimer formulation applied thereto and immersed in a salt solution;

FIG. 66 is a graphical representation of Electrochemical Impedance Spectroscopy (EIS) phase angle data for Experiment 12 on a set of panels having a seventh exemplary superprimer formulation applied thereto and immersed in a salt solution;

FIG. 67 is a graphical representation of Electrochemical Impedance Spectroscopy (EIS) modulus data for Experiment 12 on a set of panels having a eighth exemplary superprimer formulation applied thereto and immersed in a salt solution;

FIG. 68 is a graphical representation of Electrochemical Impedance Spectroscopy (EIS) phase angle data for Experiment 12 on a set of panels having a eighth exemplary superprimer formulation applied thereto and immersed in a salt solution;

FIG. 69 is a pictorial representation of panels coated with the exemplary superprimer formulations of Experiment 12 after being immersed in a salt solution for 200 hours;

FIG. 70 is a graphical representation of Electrochemical Impedance Spectroscopy (EIS) modulus data for Experiment 13 on a group of panels having exemplary superprimer formulations applied thereto and immersed in a salt solution for 14 days;

FIG. 71 is a graphical representation of Electrochemical Impedance Spectroscopy (EIS) phase angle data for Experiment 13 on a group of panels having exemplary superprimer formulations applied thereto and immersed in a salt solution for 14 days;

FIG. 72 is a graphical representation of Electrochemical Impedance Spectroscopy (EIS) modulus data for Experiment 13 on a group of panels having exemplary superprimer formulations applied thereto and immersed in a salt solution for 16 days;

FIG. 73 is a graphical representation of Electrochemical Impedance Spectroscopy (EIS) phase angle data for Experiment 13 on a group of panels having exemplary superprimer formulations applied thereto and immersed in a salt solution for 16 days;

FIG. 74 is a graphical representation of Electrochemical Impedance Spectroscopy (EIS) modulus data for Experiment 13 on a group of panels having exemplary superprimer formulations applied thereto and immersed in a salt solution for 21 days;

FIG. 75 is a graphical representation of Electrochemical Impedance Spectroscopy (EIS) phase angle data for Experiment 13 on a group of panels having exemplary superprimer formulations applied thereto and immersed in a salt solution for 21 days;

FIG. 76 is a graphical representation of Electrochemical Impedance Spectroscopy (EIS) modulus data for Experiment 13 on a group of panels having exemplary superprimer formulations applied thereto and immersed in a salt solution for 24 or 28 days;

FIG. 77 is a graphical representation of Electrochemical Impedance Spectroscopy (EIS) phase angle data for Experiment 13 on a group of panels having exemplary superprimer formulations applied thereto and immersed in a salt solution for 24 or 28 days;

FIG. 78 is a graphical representation of Electrochemical Impedance Spectroscopy (EIS) modulus data for Experiment 13 on a group of panels having exemplary superprimer formulations applied thereto and immersed in a salt solution for 34 days;

FIG. 79 is a graphical representation of Electrochemical Impedance Spectroscopy (EIS) phase angle data for Experiment 13 on a group of panels having exemplary superprimer formulations applied thereto and immersed in a salt solution for 34 days;

FIGS. 80 and 81 are graphical representations of Electrochemical Impedance Spectroscopy (EIS) data of exemplary superprimer formulations of Experiment 14;

FIGS. 82 and 83 are pictorial representations of exemplary coated panels after salt spray testing in Experiment 15;

FIGS. 84 and 85 are graphical representations of Electrochemical Impedance Spectroscopy (EIS) data of exemplary coating formulations of Experiment 15;

FIG. 86 is a graphical representation reflecting water permeability for an exemplary coating formulation of Experiment 17;

FIG. 87 is a graphical representation of Electrochemical Impedance Spectroscopy (EIS) data of an exemplary coating formulation of Experiment 19;

FIGS. 88 and 89 are pictorial representations of exemplary coated panels after corrosion testing in Experiment 19;

FIGS. 90-92 are pictorial representations of exemplary coated panels after corrosion testing in Experiment 20;

FIGS. 93-98 are pictorial representations of exemplary coated panels after corrosion testing in Experiment 21;

FIG. 99 is a graphical representation of impedance versus time for the exemplary coating formulations of Experiment 22;

FIGS. 100-102 are pictorial representations of exemplary coated panels after corrosion testing in Experiment 18;

FIGS. 103 and 104 are pictorial representations of exemplary coated panels after corrosion testing in Experiment 23;

FIG. 105 is a graphical representation of impedance versus time for the exemplary coating formulations of Experiment 24;

FIGS. 106-109 are pictorial representations of exemplary coated panels after corrosion testing in Experiment 24;

FIG. 110 is a graphical representation of impedance versus time for the exemplary coating formulations of Experiment 24;

FIGS. 111 and 112 are graphical representations of Electrochemical Impedance Spectroscopy (EIS) data of exemplary coating formulations of Experiment 24;

FIGS. 113-115 are pictorial representations of exemplary panels after corrosion testing in Experiment 27;

FIG. 116-118 are pictorial representations of exemplary coated panels after corrosion testing in Experiment 29;

FIGS. 119 and 120 are pictorial representations of exemplary panels after corrosion testing in Experiment 30;

FIGS. 121 and 122 are pictorial representations of exemplary coated panels after corrosion testing in Experiment 31; and

FIGS. 123 and 124 are pictorial representations of exemplary coated panels after corrosion testing in Experiment 32.

### DETAILED DESCRIPTION OF THE EXEMPLARY EMBODIMENTS

The exemplary embodiments of the present invention are described and illustrated below to encompass methods of formulating improved superprimers as well as the resulting compositions of matter from such formulations. Moreover, the exemplary embodiments encompass method of applying an improved superprimer to a substrate. Of course, it will be apparent to those of ordinary skill in the art that the exemplary embodiments discussed below are illustrative in nature and may be reconfigured without departing from the scope and spirit of the present invention. However, for clarity and precision, the exemplary embodiments as discussed below may include optional steps, methods, components, and features that one of ordinary skill should recognize as not being a requisite to fall within the scope of the present invention.

The present invention is an improved superprimer that may include one or more organofunctional silane, such as a bis-silane. An exemplary group of bis-silanes shown to be effective in the present invention are:
bis-[triethoxysilyl]methane (XO)₃—Si—CH₂—Si—(OX)₃;
bis-[triethoxysilyl]ethane (XO)₃—Si—(CH₂)₂—Si—(OX)₃;
bis-[triethoxysilyl]octane (XO)₃—Si—(CH₂)₈—Si—(OX)₃;
bis-[triethoxysilylpropyl]amine (XO)₃—Si—(CH₂)₃—NH—(CH₂)₃—Si—(OX)₃;
bis-[triethoxysilylpropyl]ethylenediamine (XO)₃—Si—(CH₂)₃—NH—(CH₂)₂—NH—(CH₂)₃—Si—(OX)₃;
bis-[triethoxysilylpropyl]disulfide (XO)₃—Si—(CH₂)₃—NH—S₂—Si—(OX)₃;
bis-[triethoxysilylpropyl]tetrasulfide (XO)₃—Si—(CH₂)₃—NH—S₄—Si—(OX)₃; and,
bis-[triethoxysilylpropyl]urea (XO)₃—Si—(CH₂)₃—NH—CO—NH—(CH₂)₃—Si—(OX)₃, where:
   X═CH₃ or C₂H₅ (methoxy or ethoxy)

The improved superprimer may also include a low-molecular weight water soluble or dispersible polymer or copolymer as well as higher molecular weight polymers having been end-functionalized so as to become water soluble or dispersible. This polymer or copolymer is generally selected from the classes of: epoxy, polyester, polyurethane or acrylate.

Additional components may be added to the improved superprimer such as, without limitation pigments, leachable inhibitors, and emulsifiers, surfactants, film builders, UV absorbers or reflectors (such as zinc oxide (ZnO) and titanium dioxide (TiO₂)), thickeners, or toughening agents such as end-functionalized silicones. Exemplary pigments include, without limitation, nanoparticles generally having a size on the order of 0.01-500 nm. The particles may be: carbon black, zinc dust, metal oxides that adsorbs silanes such as zinc oxide, aluminum oxide, iron oxide, magnesium oxide and silica; phthalocyanines; sulfides; silicone oils such as xanthene and anthraquinone dyes; vat dyes such as 3-hydroxyindole (indoxyl), 7,8,7,8-dibenzothioindigo, pyranthrone and indanthrene brilliant orange. The pigment may be dispersed into the coating by sol-gel methods or by high-shear blending. Exemplary leachable inhibitors include, without limitation, salt of trivalent cerium (Ce), salt of trivalent lanthanum (Le), salts of yttrium (Y), molybdates, phosphates, phosphonates, phosphomolybdates, vanadates, borates, amines, glycolates, sulfenamides, tungstates, and various mixtures of the above. The concentration of inhibitor present within the improved superprimer will generally be less than 5% of the resultant superprimer, while the concentration of emulsifiers, surfactants, film builders, UV absorbers or reflectors (such as zinc oxide (ZnO) and titanium dioxide (TiO₂)), thickeners, or toughening agents such as end-functionalized silicones within the improved superprimer will generally be less than 3% of the solids.

The result of such a composition is a much thicker and denser film than one produced using a silane alone or a polymer film alone. Since the siloxane network is very hydrophobic, the film will have an extremely low permeability to water. The organofunctional silane film alone would be brittle at high thicknesses, but the presence of the interpenetrated polymer will result in a much more pliable and formable material. One could argue that the polymer acts as a toughener of the organofunctional silane film.

The present invention is also compatible with conventional corrosion inhibition strategies. The function of a conventional inhibitor is to provide corrosion protection from nicks and scratches in the coating. Since the film produced by the present invention is densely cross-linked, a water soluble inhibitor may be added to the coating that leaches out very slowly due to the extreme hydrophobicity of the film. Some exemplary inhibitors that may be utilized in the present invention include: organophosphonates, useful for steel substrates; amines useful for steel and zinc substrates; benzothiazoles, useful on zinc substrates; cobalt ions, useful on zinc substrates; thioglycolates, useful on zinc substrates; tolyltriazole, benzocarboxytriazole and cerium ions, Ce(III), useful on aluminum alloy substrates; tobacco extract, useful on aluminum substrates; benzocarboxytriazole and tolytriazole, useful on aluminum alloy substrates. In other words, the present invention provides flexibility when choosing the inhibitor based on the target substrate. It is also a consideration to choose an inhibitor showing minimal chemical reactivity with either the silane or the resin. The inhibitor may also replace the defect healing capabilities of chromates used in conventional metal primers.

Other additives, such as a UV absorber are built-in if zinc oxide (a UV absorber) is selected as the nanoparticle, as silanes are known to adsorb on zinc oxide. However, nanoparticles of various types (SiO₂, Fe₂O₃, CuO) can be generated by in-situ sol-gel methods from alkoxy compounds. These particles can play a number of roles such as reinforcement, pigmentation and UV protection. The flexibility of the present invention also allows the use of Ti0₂ as the UV scatterer in those cases where ZnO might lead to excessive heating of the coating.

The following experiments are simply intended to further illustrate and explain the present invention. The invention, therefore, should not be limited to any of the details in these experiments.

### Experiment 1

The following exemplary improved superprimer coating solution is made by direct addition of the various components almost simultaneously, followed by high shear mixing. The total weight of the coating solution produced is 100 grams, and those of ordinary skill will readily understand the scalability.

Components: (1) Silanes—Silquest A 1289, a bis-[triethoxysilylproyl]tetrasulfide silane (available from General Electric,); TEOS, tetraethoxysilane (available from Stochem Specialty Chemicals,); and, AV5, 5:1 weight % ratio of a silane mixture containing VTAS (vinyltriacetoxysilane, available from Gelest,) and A 1170 (bis-trimethoxysilylpropylamine, available from General Electric,).

(2) Resin—EPI-REZ 3540-WY-55, a 55% solid dispersion of epoxy resin in water and 2-propoxyethanol (available from Resolution Performance Products, www.resins.com).

Formulation and Preparation: A 1170 and VTAS are mixed in a 5:1 volume ratio, referred to below as AV5. 10 grams of AV5 is added 90 grams of deionized water adjusted to a pH of approximately 3.0 using acetic acid to provide a 10% diluted solution of AV5. Preparation of the improved superprimer formulation includes adding 9 grams of the diluted AV5 solution, 10.5 grams of A-1289, and 0.5 grams of TEOS to 80 grams of EPI-REZ 3540-WY-55 resin. The components are gently initially mixed, followed by high shear mixing at 2000 rpm for 10 minutes.

Substrates: A-2024 T3 aluminum alloy panels were cleaned in a 7% KOH solution at 60-70° C. for 3 minutes and rinsed in deionized water and dried before being coated.

Application and Cure: Coatings of the improved superprimer were applied to several aluminum alloy panels, after a 30 minute incubation following the high shear mixing, by “drawn-down bar” technique consistent with normal paint/coating procedures. A # 28 bar was used, however, the costing may be applied using a different bar # depending upon the desired application. The coated aluminum alloy panels were cured at 50° C. for 30 minutes, followed by one week at room temperature. A controlled group of aluminum alloy panels was coated with a commercially available chromate primer. It is to be understood that the commercially available primer was applied to the aluminum alloy panels in an analogous fashion as discussed above for the application of the improved superprimer.

Testing: A first group of aluminum alloy panels coated with the improved superprimer was scribed with an “X” and was subjected to salt spray for 14 days in accordance with ASTM B117. This first group of panels was compared against a first controlled group of aluminum alloy panels coated with the commercially available primer containing chromates. These controlled panels were likewise scribed with an “X” and subjected to salt spray for 14 days in accordance with ASTM B117.

A second group of aluminum alloy panels was also coated with the improved superprimer and scribed with an “X” and immersed in a 3.5 percent (by weight) NaCl solution for two months. This second group of panels was compared against a second controlled group of aluminum alloy panels coated with the commercially available primer containing chromates. Electrochemical impedance spectroscopy (EIS) testing was done in a 3.5 percent (by weight) NaCl solution with a saturated calomel electrode (SCE) and a graphite counter electrode for both groups of panels.

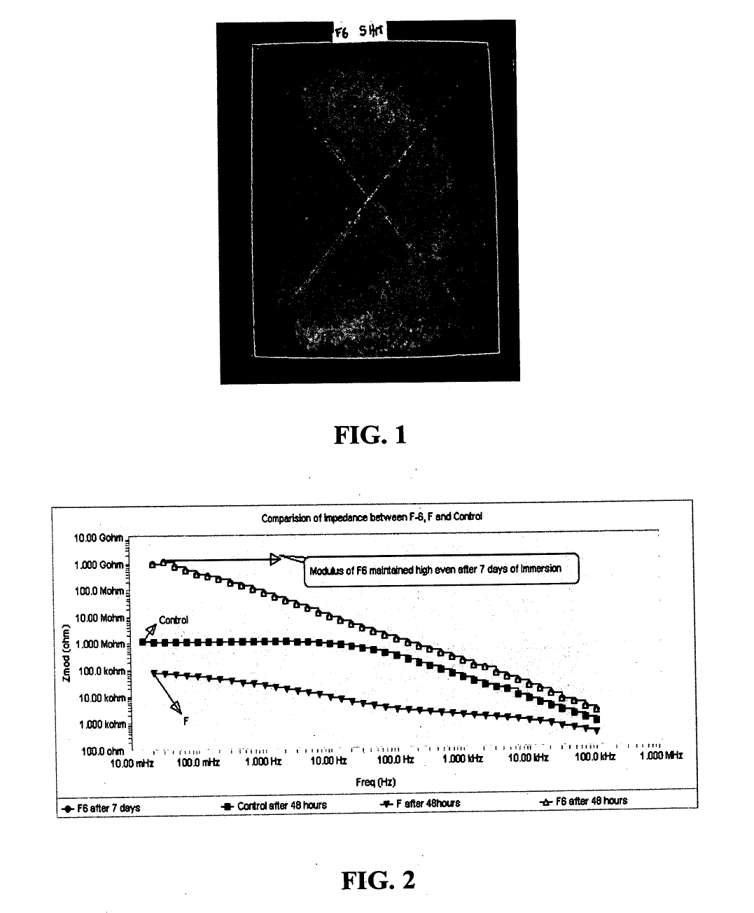

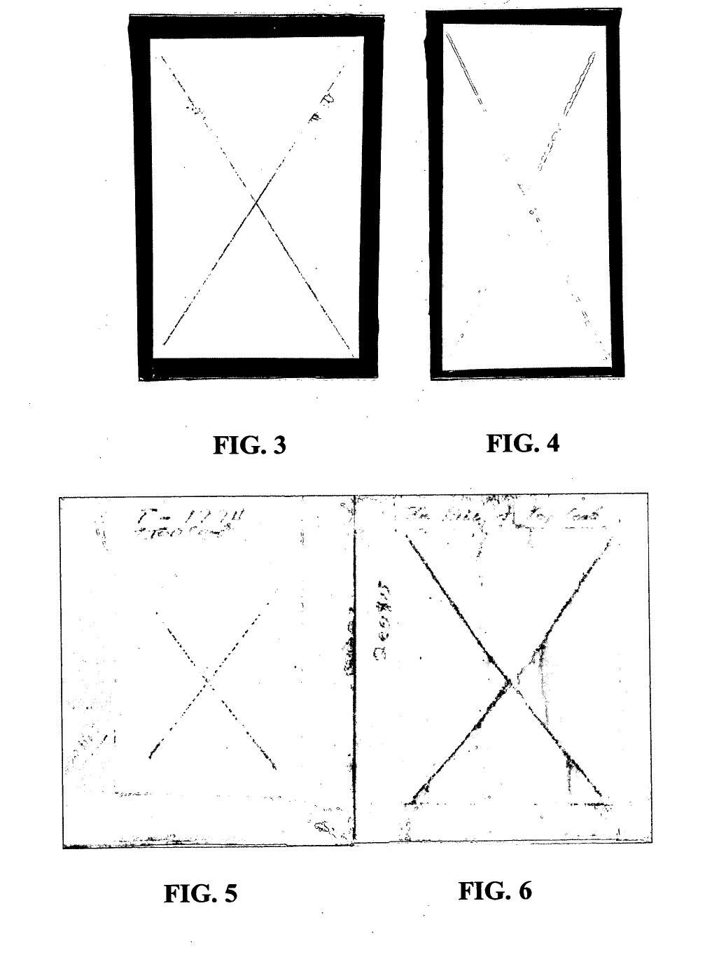

Results: FIG. 1 shows pictorially an exemplary aluminum alloy panel coated with the exemplary superprimer after 14 days of salt spray testing. FIG. 2 provides Electrochemical Impedance Spectroscopy (EIS) testing data for the exemplary superprimer versus the commercially available primer. Table 1 provides a qualitative summary of the ASTM B117 salt spray testing results after 336 hours of testing. FIGS. 3 and 4 pictorially represent exemplary panels coated with the zinc-rich paint and coated with the zinc-rich superprimer, respectively, after 336 hours of salt spray testing.

TABLE 1

| | Control | Superprimer |
|---|---|---|
| Salt spray | No corrosion in the scribe | Corrosion in scribe |
| | after 2 weeks | after 2 weeks |
| Salt immersion | Sustained for 1 month | Sustained for 2 months |
| Contact angle | 69.5° | 78.38° |
| EIS | 6 ohm for 1 week | 9 ohm for 2 weeks |
| Hardness | F | F |
| Adhesion to | 5B | 5B |
| Topcoat | | |
| Paint Adhesion | 5B | 5B |

Discussion: Referencing FIG. 1, it is apparent that the scribed X in the exemplary aluminum alloy panel coated with the improved superprimer shows minimal corrosion. More importantly, no corrosion is apparent where the superprimer coating has not been scribed.

Referencing FIG. 2, it is apparent from the EIS data that the impedance of superprimer film (F6) is better than both the control (Control). The modulus of the improved superprimer formulation exceeded the modulus of the control. It should be noted that the superprimer modulus remained at that high value for one week without any drop in the value, indicating that water penetration continued to be very low.

Referring to FIGS. 3 and 4, it is apparent that the performance of the AA2024 T3 panel coated with superprimer (FIG. 4) is equal in comparison to a AA2024 T3 panel coated with the commercially available chromate primer after 2 months of salt immersion.

Referring to Table 1, the improved superprimer formulation did show corrosion in the scribe after two weeks, however, the contact angle of the improved superprimer film indicates a more hydrophobic film than the commercially available chromate primer. In addition, the hardness values, the adhesion values, and the paint adhesion values of both coatings were roughly equal. It should be noted that a value of 5B is the best value according to an ASTM tape adhesion test.

### Experiment 2

All coating solutions are made by direct addition of the various components almost simultaneously and immediate high shear mixing. The total weight of the coating solutions produced is 100 grams, and those of ordinary skill will readily understand the scalability.

Components: (1) Silanes—TEOS, tetraethoxysilane (available from Stochem Specialty Chemicals,); AV5, 5:1 weight % ratio of a silane mixture containing VTAS (vinyltriacetoxysilane, available from Gelest,) and A 1170 (bis-trimethoxysilylpropylamine, available from General Electric,).

(2) Resin—EPI-REZ 3540-WY-55, a 55% solid dispersion of epoxy resin in water and 2-propoxyethanol (available from Resolution Performance Products,).

(3) Particles—Superfine zinc dust (grade 5) (available from U.S. Zinc, www.uszinc.com).

Formulation and Preparation: A 1170 and VTAS are mixed in a 5:1 volume ratio, referred to below as AV5. 10 grams of AV5 is added 90 grams of deionized water adjusted to a pH of approximately 3.0 using acetic acid to provide 10% diluted solution of AV5. Preparation of the improved superprimer formulation includes adding 5.7 grams of the diluted AV5 solution and 0.3 grams of TEOS to 24 grams of EPI-REZ 3540-WY-55 resin, referred to as WSP-1. WSP-1 is high shear mixed for 10 minutes at 2100 rpm. Thereafter, 70 grams of zinc dust is incrementally added to the WSP-1 an after the entire addition of zinc dust is complete, the mixture is high shear mixed for 20 minutes at 3000 rpm.

Substrates: Corten steel panels were cleaned in a 7% KOH solution at 60-70° C. for less than 3 minutes and rinsed in deionized water and dried before being coated.

Application and Cure: Coatings of the improved superprimer were applied to a first set of steel panels, after a 30 minute incubation following the high shear mixing, by “drawn-down bar” technique consistent with normal paint/coating procedures. A # 28 bar was used, but most of the coatings displayed a low viscosity that might utilize a lower bar # for optimum application. The coated steel panels were cured at 50° C. for 30 minutes, followed by one week at room temperature. A controlled group of steel panels was coated with a commercially available chromate primer. It is to be understood that the commercially available primer was applied to the steel panels in an analogous fashion as discussed above for the application of the improved superprimer. All steel panels were thereafter coated with a commercially available polyamide coating.

Testing: The first group of steel panels coated with the improved superprimer was scribed with an “X” and each was subjected to salt spray for 200 hours. This first group of panels was compared against the controlled group of steel panels likewise scribed with an “X” and subjected to salt spray for 200 hours.

The second group of steel panel coated with the improved superprimer was scribed with an “X” and each immersed in a 3.5 percent (by weight) NaCl solution for six weeks. Electrochemical impedance spectroscopy (EIS) testing was done in a 3.5 percent (by weight) NaCl solution with a saturated calomel electrode (SCE) and a graphite counter electrode.

Results: FIGS. 5 and 6 show pictorial data derived after 200 hours of salt spray testing on the first set of steel panels (FIG. 5) and the steel panels coated with the commercially available zinc rich primer (FIG. 6).

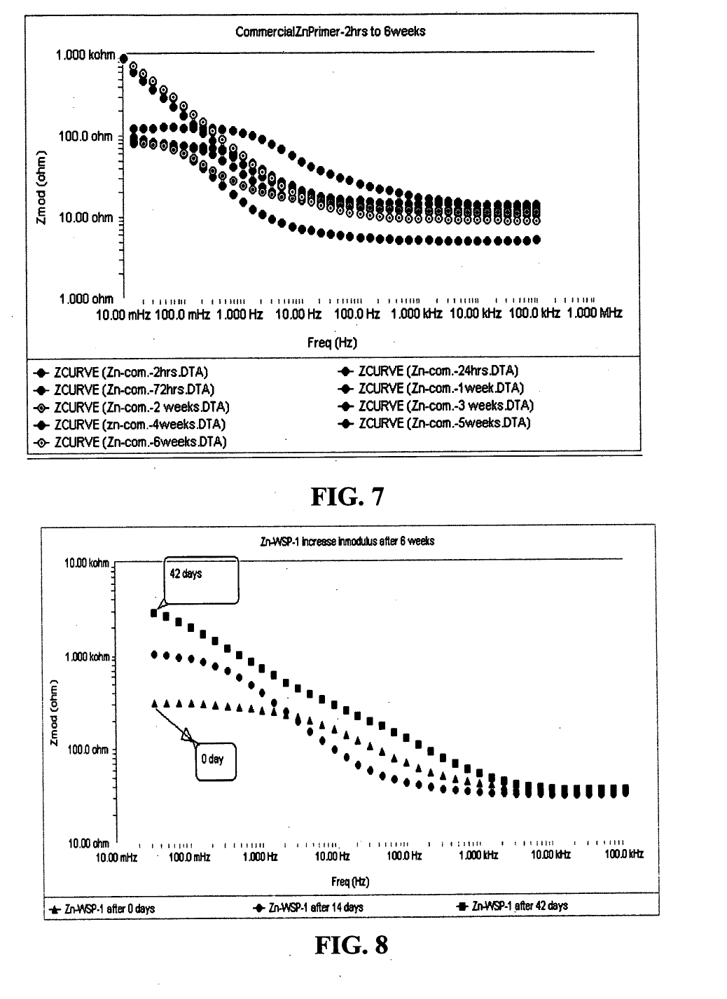

FIGS. 7 and 8 show EIS data derived from the immersion of the steel panels in the 3.5 percent NaCl solution for six weeks.

Discussion: Referencing FIGS. 5 and 6, it is apparent that the scribed X in each exemplary steel panel shows corrosion. More importantly, significant corrosion is apparent in the scribed areas for the commercially available zinc rich primer (FIG. 6), while the corrosion of the panel coated with the improved superprimer (FIG. 5) shows substantially less corrosion. This objectively indicates that the corrosion inhibiting performance of the improved superprimer exceeds the performance of a commercially available zinc rich primer topcoat after 200 hours of testing in salt spray.

Referencing FIGS. 7 and 8, the EIS data displays consistent trends between the performance of the improved superprimer formulation and the commercially available zinc-rich primer. The conductive nature of the improved superprimer formulation results in lower EIS impedance values. Generally, the impedance values will increase with the duration of exposure of the panels to the electrolyte.

### Experiment 3

All coating solutions are made by direct addition of the various components almost simultaneously and immediate high shear mixing. Those of ordinary skill will readily understand the scalability of the following experiment.

Components: (1) Silanes—Y-9805, a bis-[triethoxysilylethane] (available from General Electric,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

(3) Additives—Alink-25, a crosslinker (available from General Electric,)

(4) Particles—Superfine zinc dust (grade 5) (available from U.S. Zinc, www.uszinc.com).

Formulation and Preparation: The Superprimer is prepared by a mixture of resins, a non-hydrolyzed silane, a crosslinker, and deionized water. 70 grams of ECOCRYL 9790 is added to an empty container. 20 grams of EPI-REZ WD-510 are added to the container, as well as 30 grams of Y-9805, a non-hydrolyzed silane.

The resulting mixture of silane and resins is diluted with deionized water to arrive at the desired viscosity, and may be determinative in the thickness of the eventual coating applied to the particular substrate. Generally an addition of 30-40 grams of deionized water to the above mixture of resins and silane results in a coating ranging from 15-40 μm. Thinner coatings can be obtained by addition of more water, however, excessive addition of water may result in loss of wettability of the substrate to be coated and may be remedied by the addition of surfactants.

A crosslinker, in the amount of 2.5 grams of Alink-25, is added to the diluted silane and resin mixture. The resulting solution is mixed and 379.2 grams of zinc dust is incorporated and the resulting Superprimer formulation is high shear blended. The mixture is high shear blended for approximately 5-10 minutes at 4500 rpm under high shear conditions using a 100 LC High-Shear Blender, with a micro-assembly attachment.

Substrates and Preparation: Metal panels (hot-dipped galvanized G70 (HDG G70), AA 2024 T3 alloy, AA 7075 T6 alloy, and cold rolled steel), were cleaned and degreased. This process included ultrasonic cleaning in ethanol, followed by immersion in acetone for 5 minutes. It should be noted that the ultrasonic cleaning and immersion in acetone were not performed for the AA 2024 T3 alloy and the AA 7075 T6 alloy. All of the panels were thereafter immersed in an alkaline cleaner for 5 minutes at 55° C. The panels were removed from the alkaline cleaner and rinsed with deionized water and blown dry with compressed air.

Application and Cure: Each of the panels was then coated with the above-referenced superprimer formulation. In this experiment, the superprimer was applied to each of the panels by brushing, however, it is to be understood that the superprimer may be applied using other techniques such as, without limitation, draw down or spraying. The coated panels were cured at 70° C. for 3 hours. Two sets of controlled samples were also utilized, where the first controlled set was uncoated, and the second controlled set was coated with a commercially available zinc-rich primer.

Testing: Electrochemical impedance spectroscopy (EIS) testing was done in a 3.5% (by weight) NaCl solution with a saturated calomel electrode (SCE) and a graphite counter electrode.

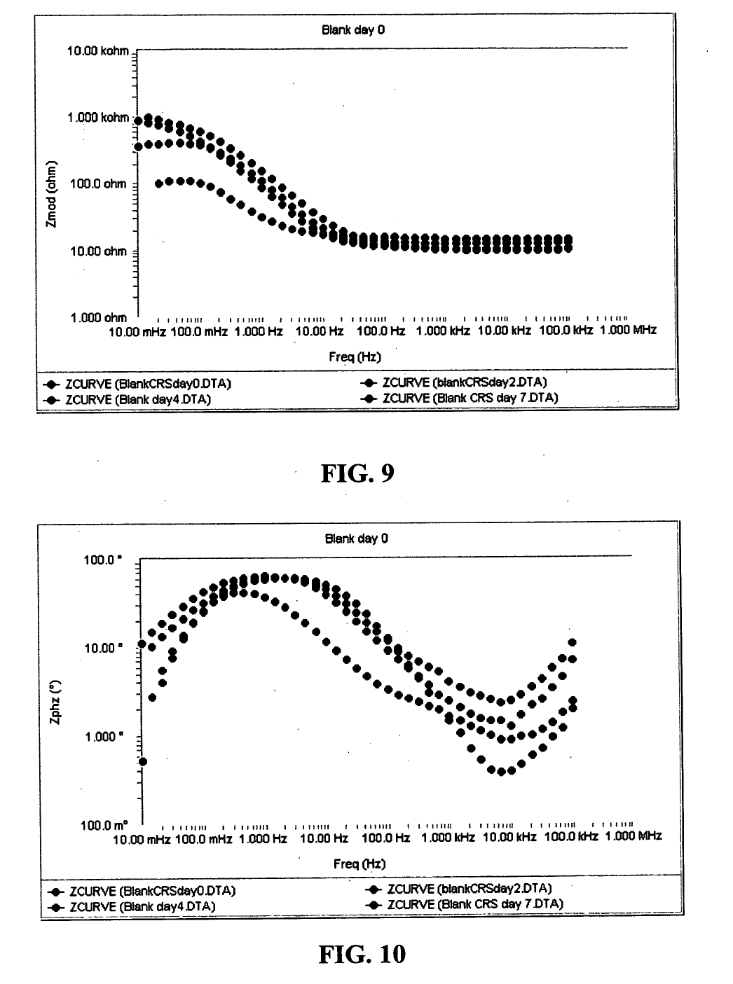

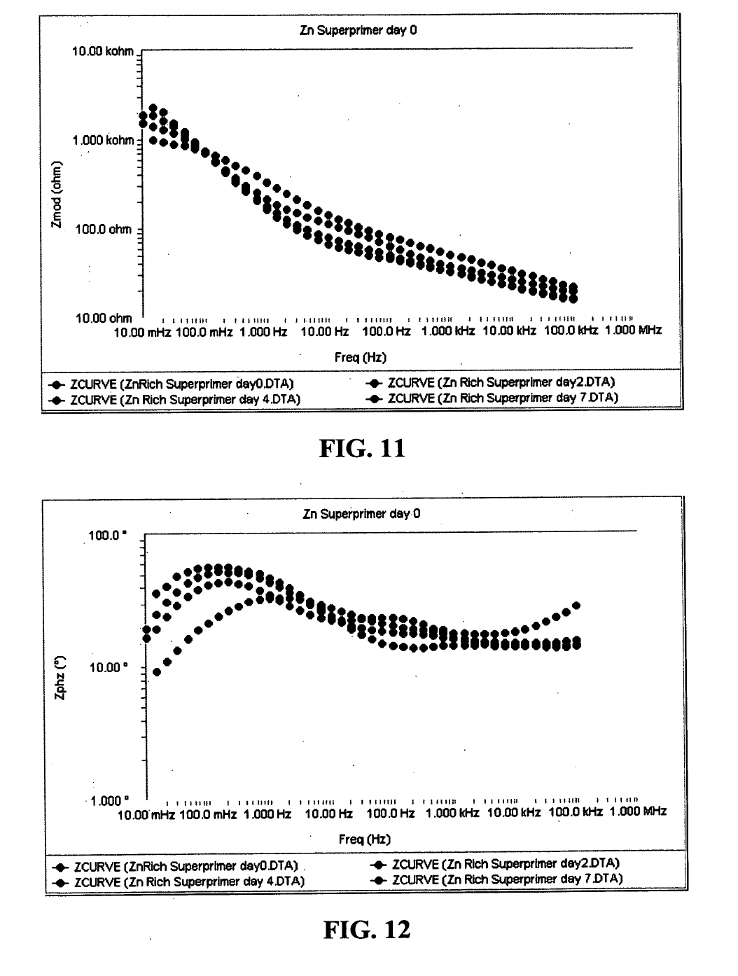

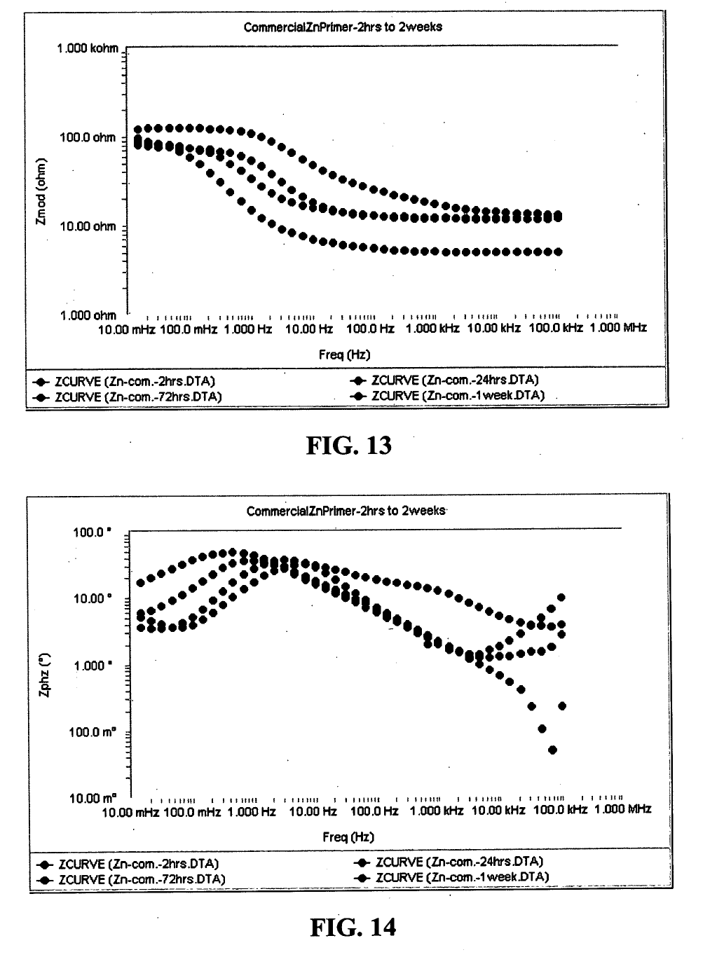

Results: FIGS. 9-14 reflect the data generated by the EIS testing. FIGS. 9 and 10 correspond to EIS testing data performed upon the first set of controlled panels having no primer applied thereto. FIGS. 11 and 12 correspond to EIS testing data performed upon the set of panels having the superprimer applied thereto. FIGS. 13 and 14 correspond to EIS testing data performed upon the second set of controlled panels having a commercially available zinc-rich primer (commercially available formulation described above) applied thereto. Four data sets are displayed on FIGS. 9-14, with each corresponding to test results conducted initially, two days after immersion in the NaCl solution, four days after immersion in the NaCl solution, and seven days after immersion in the NaCl solution. FIGS. 12 and 13 corresponding to test results conducted two hours after application of the primer, one day after immersion in the NaCl solution, three days after immersion in the NaCl solution, and seven days after immersion in the NaCl solution.

Discussion: It can be seen from the EIS data that the superprimer coating formulation behaves well in comparison to the commercially available zinc-rich primer, which each clearly provide some degree of corrosion protection as evidenced by the first set of controlled samples having no primer. The EIS data clearly shows that the addition of zinc dust particles to the improved superprimer brings down the modulus of impedance at low frequencies. This suggests that the improved superprimer coating has been transformed from a purely capacitative coating into a conductive coating. The absence of a time constant indicates that there is no appreciable delamination and the improved superprimer coating successfully protects the cold rolled steel substrate. With the passage of time, the modulus increases slightly at low frequencies. This increase in the modulus is attributed to the corrosion of zinc as a sacrificial cathode in the coating with the passage of time, with the corrosion products of the zinc render the coating more impermeable to the electrolyte offering and thereby more corrosion resistant.

The following experiments are simply intended to further illustrate and explain the present invention. The invention, therefore, should not be limited to any of the details in these experiments. For purposes of the present invention, the percent composition of the eventual coatings comprise between about 70-90% zinc dust, between about 10-25% water soluble resin, and between about 1-4% silane(s). Moreover, the percent compositions of the liquid coatings prior to application and diluting by solvent comprise between about 50-80% zinc dust, between about 9-23% water soluble resin, between about 1-4% silane(s), and between about 1-4% curing agent, where dilution by one or more solvents will correspondingly decrease the respective percentages. Overall, it is anticipated that the percent solvent of the composition should be between about 5-40% of the overall liquid coating formulation.

### Experiment 4

The following silane-enhanced zinc-rich coating is based upon a 3-component formulation as recited below. The individual components are mixed together using a commercially available high shear mixer for 10 minutes. The exemplary formulation may be amended to generate a coating having anywhere between 40-95 weight percent zinc and between 0.1-10 weight percent silane. No induction time is required prior to application, however, those of ordinary skill will readily understand that the formulation may be utilized with predetermined induction times.

| | 3-component silane-enhanced zinc-rich formula | |
|---|---|---|
| | | Weight percent |
| Exemplary | Volume | of dry film |
| Formulation #1: | (Liters) | (% wt) |

Part A:

| | | |
|---|---|---|
| DPW 6520 | 13.2 | 18.20 |

Part B:

| | | |
|---|---|---|
| 10% AV5 | 5.5 | 1.03 |

Part C:

| | | |
|---|---|---|
| Zn dust | 4.94 (35.25 kg) | 80.80 |
| Total | 22.64 Liters | |

Where:
(A) DPW 6520 is a diglycidyl ether of bisphenol A (DGEBA) epoxy 53% water dispersion, available from Resolution Performance LLC,;
(B) AV5, 5:1 weight % ratio of a silane mixture containing bis-trimethoxysilylpropylamine (bis-amino silane, Silquest A-1170 ®, available from GE Silicones,) and vinyltriacetoxysilane (VTAS, available from Gelest Inc,). Bis-amino silane and VTAS are mixed with acetone and denatured ethanol to form a 10% AV5 solution at ECOSIL; and
(C) Zn dust is super fine #7 available from US Zinc,.

Formulation and Preparation of Conventional Solvent-borne Zn-rich primer. 165 grams of zinc filler is added to 33.1 mL of Carbozinc part A and thoroughly mixed. To this mixture, 20 mL of Carbozinc part B is added, followed by the addition of 160 grams of n-buoxyethanol to adjust the viscosity of the paint

Formulation and Preparation of Exemplary Formulation #1: 5.5 mL of 10% AV5 (Part B) is added to 13.2 mL of DPW 6520 water dispersion (Part A) and mixed thoroughly. 35.25 grams of zinc dust (Part C) is thereafter added to the above two-component mixture. The final mixture is thoroughly mixed using a high shear mixer.

Substrates: Corten steel panels were sand-blasted and dip-cleaned with a 7% Chemclean (purchased from Chemetall/Oakite Inc) at 60° C., followed by tap water rinsing and blow air drying.

Application and Cure of Conventional Primer: The conventional solvent-borne Zn-rich primer was drawn down onto two sets of Corten steel panels using a #30 draw down bar. The primer was cured at ambient temperature and pressure for 2 hours before topcoating.

Application and Cure of Exemplary Formulation #1: The Exemplary Formulation #1 was drawn down onto two sets of Corten steel panels using a #30 draw down bar. The Exemplary Formulation #1 was cured at ambient temperature and pressure for 2 hours before topcoating.

Topcoat Application: A waterborne epoxy topcoat based upon a 2-component formulation (see below) was drawn-down onto each set of Corten panels using a #30 draw down bar. It is preferred that a 30 minute induction time is allotted prior to application of the epoxy topcoat. The epoxy topcoat was cured at ambient temperature and pressure for 1 day before testing was conducted.

2-component epoxy topcoat formula

Weight part
(grams)

Part 1:

| | |
|---|---|
| EPI-REZ 5522-WY-55 | 282.9 |

Part 2:

| | |
|---|---|
| EPI-KURE 8290-Y-60 | 56.9 |
| & Distilled water | 30.0 |
| Total (Part 1 + Part 2) | 369.8 |

Where:
(1) EPI-REZ 5522-WY-55 is a diglycidyl ether of bisphenol A (DGEBA) epoxy 55% water dispersion, available from Resolution Performance LLC,; and
(2) EPI-KURE 8290-Y-60 is available from Resolution Performance LLC,

Testing: a 500 hr ASTM B117 salt spray test was conducted on multiple of the Corten steel panels coated with the conventional Zn-rich primer and those Corten panels coated with the Exemplary Formulation #1 of the present invention. It should be noted that each panel was cross-scribed before being exposed to the ASTM B117 salt spray test.

ASTM D3359-B cross-hatch testing was conducted on multiple of the Corten panels after 1 day of ambient curing for a dry film adhesion.

ASTM D3363 pencil hardness testing was conducted on multiple of the Corten panels (without topcoat) for hardness.

Deformability or impact resistance testing was conducted on multiple of the Corten panels coated with the Exemplary Formulation #1 in the form of punching and impacting.

Results: Table 2 provides a summary listing of the results of the above-described testing carried out on the Corten steel panels.

TABLE 2

| | Conventional Solvent- | Exemplary |
|---|---|---|
| | borne Zn-rich | Formulation |
| Tests/measurements | primer + topcoat | #1 + topcoat |
| Film thickness (μm) | 90 | 55 |
| ASTM B117 (500 hr) | Passed (No film | Passed (No film |
| | delamination, | delamination, |
| | no blisters) | no blisters) |
| ASTM D3359-B | 5B (without | 5B (without |
| (cross-hatch test) | topcoat) | topcoat) |
| (after 1 day of curing) | | |
| ASTM D3363 | HB (without | HB (without |
| (Pencil hardness) | topcoat) | topcoat) |
| (after 1 day of curing) | | |
| Deformability (punching | N/A | Good |
| and impacting) | | |
| VOC (g/l) | 359 | 22 |

Discussion: The testing results verify that the Exemplary Formulation #1, representing a silane-enhanced zinc-rich primer, performs equally well in comparison to the conventional solvent-borne Zn-rich paint in terms of corrosion protection, adhesion, and deformability properties. It should be noted, however, that the silane-enhanced zinc-rich primer does not contain chromates and its VOC level (22 g/L) is far below the conventional solvent-borne Zn-rich primer (359 g/L).

### Experiment 5

The following silane-enhanced zinc-rich coating is based upon a 3-component formulation as recited below. The individual components are mixed together using a commercially available high shear mixer for 10 minutes. The exemplary formulation may be amended to generate a coating having anywhere between 40-95 weight percent zinc and between 0.1-10 weight percent silane. No induction time is required prior to application, however, those of ordinary skill will readily understand that the formulation may be utilized with predetermined induction times.

| | 3-component silane-enhanced zinc-rich formula | |
|---|---|---|
| Exemplary | Weight part | Weight percent |
| Formulation #2: | (grams) | of dry film |

Part A:

| | | |
|---|---|---|
| EPI-REZ 3540-WY-55 | 13.20 | 18.40 |
| RHEOLATE 216 | 0.62 | |
| Acetone | 12.00 | |

Part B:

| | | |
|---|---|---|
| AV5 | 1.32 | 2.93 |

Part C:

| | | |
|---|---|---|
| Zn dust | 35.25 | 78.40 |
| Total (Part A + | 62.39 | |
| Part B + Part C) | | |

Where:
(A) EPI-REZ 3540-WY-55 is a diglycidyl ether of bisphenol A (DGEBA) epoxy 53% water dispersion, available from Resolution Performance LLC,; and RHEOLATE 216 is a VOC-free, highly efficient polyether urea polyurethane associative thickener, available from;
(B) AV5, 5:1 weight % ratio of a silane mixture containing bis-trimethoxysilylpropylamine (bis-amino silane, Silquest A-1170 ®, available from GE Silicones,) and vinyltriacetoxysilane (VTAS, available from Gelest Inc,). Bis-amino silane and VTAS are mixed at ECOSIL; and
(C) Zn dust is super fine #7 available from US Zinc,.

Formulation and Preparation of Exemplary Formulation #2: 12 grams of acetone is added to 13.20 grams of EPI-REZ 3540-WY-55 and mixed. 0.62 grams of RHEOLATE 216 associative thickener is added to the above mixture and thoroughly mixed, thereby resulting in Part A. Subsequently, 1.32 grams of AV5 (Part B) is added to Part A and mixed thoroughly. 53.25 grams of Zn dust (Part C) is finally added to the mixture of Part A and Part B, and thereafter high shear mixed for approximately 10 minutes.

Substrates: Corten steel panels were sand-blasted and dip-cleaned with a 7% Chemclean (purchased from Chemetall/Oakite Inc) at 60° C., followed by tap water rinsing and blow air drying.

Application and Cure: Exemplary Formulation #2 was spray-applied onto two sets of Corten steel panels with an HVLP air spraying gun. The Exemplary Formulation #2 was thereafter cured at ambient temperature and pressure for 24 hours before topcoating.

ASTM D3359-B cross-hatch testing was conducted on multiple of the Corten panels for dry film adhesion.

ASTM D3363 pencil hardness testing was conducted on multiple of the Corten panels for hardness.

Results: Table 3 provides a summary listing of the results of the above-described testing carried out on the coated Corten steel panels.

TABLE 3

| | Exemplary |
|---|---|
| Tests/measurements | Formulation #2 |
| Film thickness (μm) | 25-50 |
| Film dying time (set to | 3-4 min |
| touch) | |
| ASTM D3359-B | 5B |
| (cross-hatch test) | |
| (after 1 day of curing) | |
| ASTM D3363 | HB |
| (Pencil hardness) | |
| (after 1 day of curing) | |
| Pot life (hrs) | ˜16 hrs |
| VOC (g/l) | 94 |

Discussion: The testing results verify that the Exemplary Formulation #2 provides good coating properties. The VOC level is also low, only 94 g/L, when compared to conventional Zn-rich paints. Other advantages of this Exemplary Formulation #2 include: (1) prolonged pot life (˜16 hrs); and (2) good operation abilities (e.g., easy to spraying, fast drying and good sagging control)

### Experiment 6

The following silane-enhanced zinc-rich coating is based upon a 3-component, water based, formulation as recited below. The individual components are mixed together using a commercially available high shear mixer for 10 minutes. The exemplary formulation may be amended to generate a coating having anywhere between 40-95 weight percent zinc and between 0.1-10 weight percent silane. No induction time is required prior to application, however, those of ordinary skill will readily understand that the formulation may be utilized with predetermined induction times.

| | 2-component silane-enhanced zinc-rich formula | |
|---|---|---|
| Exemplary | Weight part | Weight percent |
| Formulation #3 | (g) | of dry film |

Part A:

| | | |
|---|---|---|
| Zn-dust | 25.00 | 80.00 |
| EPI-REZ WD 510 | 5.00 | 16.00 |
| Acetone | 2.00 | — |
| 2-propoxyethanol | 1.00 | — |
| Texaphor 963 | 0.125 | — |
| Rheolate 216 | 0.125 | — |

Part B:

| | | |
|---|---|---|
| EPI-KURE 3274 | 2.0 | 2.23 |

Part C:

| | | |
|---|---|---|
| 6% wt AV5 aqueous | 10.00 | 1.77 |
| solution | | |
| Total (Part A + Part B) | 45.25 | |

Where:
(A) Zn dust is super fine #7 available from US Zinc,; EPI-REZ WD 510 is a diglycidyl ether of bisphenol A (DGEBA) epoxy resin, available from Resolution Performance LLC,; RHEOLATE 216 is a VOC-free, highly efficient polyether urea polyurethane associative thickener, available from Elementis Specialties Inc.; Texaphor ® 963 is an anti-settling agent, available from Cognis; and
(B) EPI-KURE 3274 curing agent is a aliphatic amine, available from Resolution Performance LLC,; and
(C) AV5 is a 5:1 weight % ratio of a silane mixture containing bis-trimethoxysilylpropylamine (bis-amino silane, Silquest ® A-1170, available from GE Silicones,) and vinyltriacetoxysilane (VTAS, available from Gelest Inc,).

Formulation and Preparation of Exemplary Formulation #3: 3 grams of an acetone and 2-propoxyethanol mixture (2:1 ratio) is added to 5 grams of EPI-REZ WD 510 resin and mixed. 0.125 grams of RHEOLATE 216 associative thickener and 0.125 grams of Texaphor® 963 are added to the above mixture and thoroughly mixed. Zn dust is then added to this mixture, thereby forming Part A. Part B is 2.0 grams of EPI-KURE 3274. Part C is formed by adding 0.6 grams of AV5 to 9.4 grams of DI water, where the resulting mixture is thoroughly mixed. Parts A, B and C are thereafter thoroughly mixed together.

Substrates: Corten steel panels were sand-blasted and dip-cleaned with a 7% Chemclean (purchased from Chemetall/Oakite Inc) at 60° C., followed by tap water rinsing and blow air drying.

Application and Cure: The Exemplary Formulation #3 was spray-applied onto two sets of Corten steel panels with an HVLP air spraying gun. The Exemplary Formulation #3 was cured at ambient temperature and pressure for 24 hrs before testing.

ASTM D3359-B cross-hatch testing was conducted on multiple of the Corten panels for dry film adhesion.

Results: Table 4 provides a summary listing of the results of the above-described testing carried out on the Corten steel panels.

TABLE 4

| | Exemplary |
|---|---|
| Tests/measurements | Formulation #3 |
| Film thickness (μm) | 25-50 |
| Film dying time | 3-4 min |
| (set to touch) | |
| ASTM D3359-B | 5B |
| (cross-hatch test) | |
| (after 1 day of curing) | |
| ASTM D3363 | HB |
| (Pencil hardness) | |
| (after 1 day of curing) | |
| Pot life (hrs) | >8 hrs |
| VOC (g/l) | 30 |

Discussion: The testing results verify that the Exemplary Formulation #3 provides good coating properties. The VOC level is also low, only 30 g/L, when compared to conventional Zn-rich paints. Other advantages of this Exemplary Formulation #3 include good operation abilities (e.g., easy to spraying, prolonged pot life, fast drying and good sagging control) and comparable coating performance

### Experiment 7

All coating solutions are made by direct addition of the various components almost simultaneously and immediate high shear mixing. The exemplary formulation may be changed to generate a coating composition that is not water-based by using organic solvents, whether polar or nonpolar. The total weight of the coating solutions produced is 100 grams, and those of ordinary skill will readily understand the scalability.

Components: (1) Silanes—Silquest A 1289, a bis-[triethoxysilylproyl]tetrasulfide silane (available from General Electric,); TEOS, tetraethoxysilane (available from Stochem Specialty Chemicals,); AV5, 5:1 weight % ratio of a silane mixture containing VTAS (vinyltriacetoxysilane, available from Gelest,) and A 1170 (bis-trimethoxysilylpropylamine, available from General Electric,).

(2) Resin—EPI-REZ 3540-WY-55, a 55% solid dispersion of epoxy resin in water and 2-propoxyethanol (available from Resolution Performance Products, www.resins.com).

(3) Particles—Carbon black, carbon nanoparticles (available from Cabot, http://w1.cabot-corp.com).

Formulation and Preparation: A 1170 and VTAS are mixed in a 5:1 volume ratio, referred to below as AV5. 10 grams of AV5 is added 90 grams of deionized water adjusted to a pH of approximately 3.0 using acetic acid to provide 10% diluted solution of AV5. Preparation of the improved superprimer formulation includes adding 9 grams of the diluted AV5 solution, 10.5 grams of A-1289, 0.5 grams of TEOS, 3 grams of Carbon black to 77 grams of EPI-REZ 3540-WY-55 resin. The resulting mixture is high shear mixed for 10 minutes at 2100 rpm.

Substrates: Aluminum 2024 T3 panels were cleaned in a 7% KOH solution at 60-70° C. for less than three minutes and rinsed in deionized water and dried before being coated.

Application and Cure: Coatings of the improved superprimer were applied to a first set of steel panels, after a 30 minute incubation following the high shear mixing, by “drawn-down bar” technique consistent with normal paint/coating procedures. A # 28 bar was used, but most of the coatings displayed a low viscosity that might utilize a lower bar # for optimum application. The coated aluminum panels were cured at 50° C. for 30 minutes, followed by one week at room temperature.

Testing: No substantive testing was performed on this formulation.

### Experiment 8

All coating solutions are made by direct addition of the various components almost simultaneously and immediate high shear mixing. Those of ordinary skill will readily understand the scalability of the following experiment.

Components: (1) Silanes—Y-9805, a bis-[triethoxysilylethane] (available from General Electric,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

(3) Additives—Alink-25, a crosslinker (available from General Electric,)

(4) Particles—Carbon black, carbon nanoparticles (available from Cabot, http://w1.cabot-corp.com).

Formulation and Preparation: The Superprimer is prepared by a mixture of resins, a non-hydrolyzed silane, a crosslinker, and deionized water. 70 grams of ECOCRYL 9790 is added to an empty container. 20 grams of EPI-REZ WD-510 are added to the container, as well as 30 grams of Y-9805, a non-hydrolyzed silane.

The resulting mixture of silane and resins is diluted with deionized water to arrive at the desired viscosity, and may be determinative in the thickness of the eventual coating applied to the particular substrate. Generally an addition of 40 grams of deionized water to the above mixture of resins and silane results in a coating ranging from 15-40 μm. Thinner coatings can be obtained by addition of more water, however, excessive addition of water may result in loss of wettability of the substrate to be coated and may be remedied by the addition of surfactants. In addition, a crosslinker, in the amount of 2.5 grams of Alink-25, is added to the diluted silane and resin mixture to arrive at a resulting solution.

A first exemplary formulation in accordance with this experiment does not include the addition or carbon black particles and the resulting solution is high shear blended. The mixture is high shear blended for approximately 5-10 minutes at 4000 using a 100 LC High-Shear Blender, with a micro-assembly attachment.

A second exemplary formulation in accordance with this experiment includes incorporating 0.33 grams of carbon black to the resulting solution and the first resulting superprimer formulation is high shear blended. The mixture is high shear blended for approximately 5-10 minutes at 4500 rpm using a 100 LC High-Shear Blender, with a micro-assembly attachment.

A third exemplary formulation in accordance with this experiment includes incorporating 2.22 grams of carbon black to the resulting solution and the first resulting superprimer formulation is high shear blended. The mixture is high shear blended for approximately 5-10 minutes at 4500 rpm using a 100 LC High-Shear Blender, with a micro-assembly attachment.

Substrates and Preparation: Aluminum panels (A-6111), were cleaned and degreased. This process included ultrasonic cleaning in ethanol, followed by immersion in an alkaline cleaner for 5 minutes at 65° C. The panels were removed from the alkaline cleaner and rinsed with deionized water and blown dry with compressed air.

Application and Cure: Each of the panels was then coated with either the first, second, or third above-referenced superprimer formulation. In this experiment, the superprimer formulations were applied to each of the panels by brushing, however, it is to be understood that the superprimer may be applied using other techniques such as, without limitation, draw down or spraying. The coated panels were cured at 70° C. for 2 hours, and then cured at room temperature for two weeks.

Testing: Electrochemical impedance spectroscopy (EIS) testing was done in a 3.5% (by weight) NaCl solution with a saturated calomel electrode (SCE) and a graphite counter electrode on a first set of the panels. The data was collected at constant OCP and the panels were subjected to an electrolyte typically for one hour. Two scans were run for each sample.

Flexibility testing was conducted on the second set of panels one week after the primer was cured. In this manner, each panel was bend in a U-shape, with the convex side of the panel being visually observed for the development of cracks. Thereafter, the panels were bent back to their original shape with visual inspection of the panels determining if cracks within the superprimer had developed.

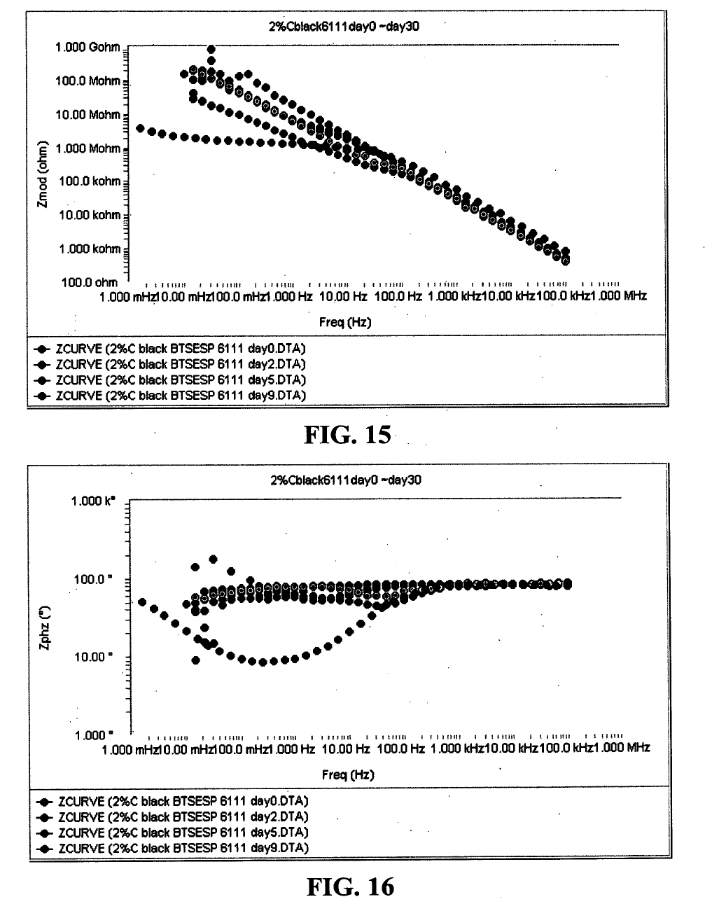

Results: FIGS. 15-20 reflect the data generated by the EIS testing. FIGS. 15 and 16 correspond to EIS testing data performed upon panels having the first exemplary superprimer formulation applied thereto. Four data sets are displayed on FIGS. 15 and 16, with each corresponding to test results conducted initially, two days after immersion in the NaCl solution, five days after immersion in the NaCl solution, and nine days after immersion in the NaCl solution.

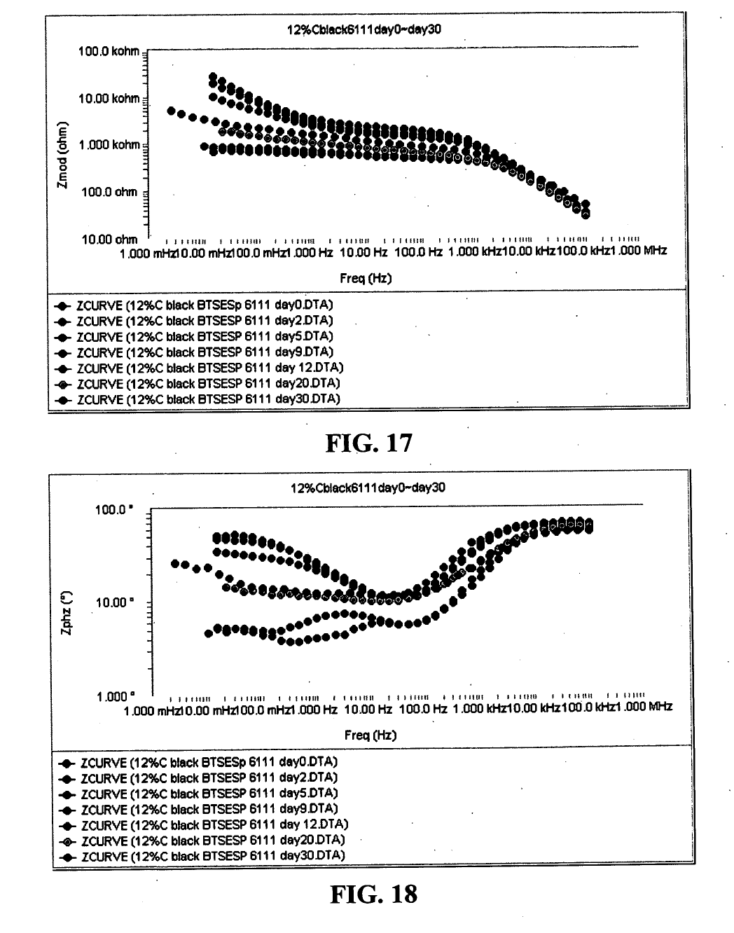

FIGS. 17 and 18 correspond to EIS testing data performed upon panels having the second exemplary superprimer formulation applied thereto. Seven data sets are displayed on FIGS. 17 and 18, with each corresponding to test results conducted initially, two days after immersion in the NaCl solution, five days after immersion in the NaCl solution, nine days after immersion in the NaCl solution, twelve days after immersion in the NaCl solution, twenty days after immersion in the NaCl solution, and thirty days after immersion in the NaCl solution.

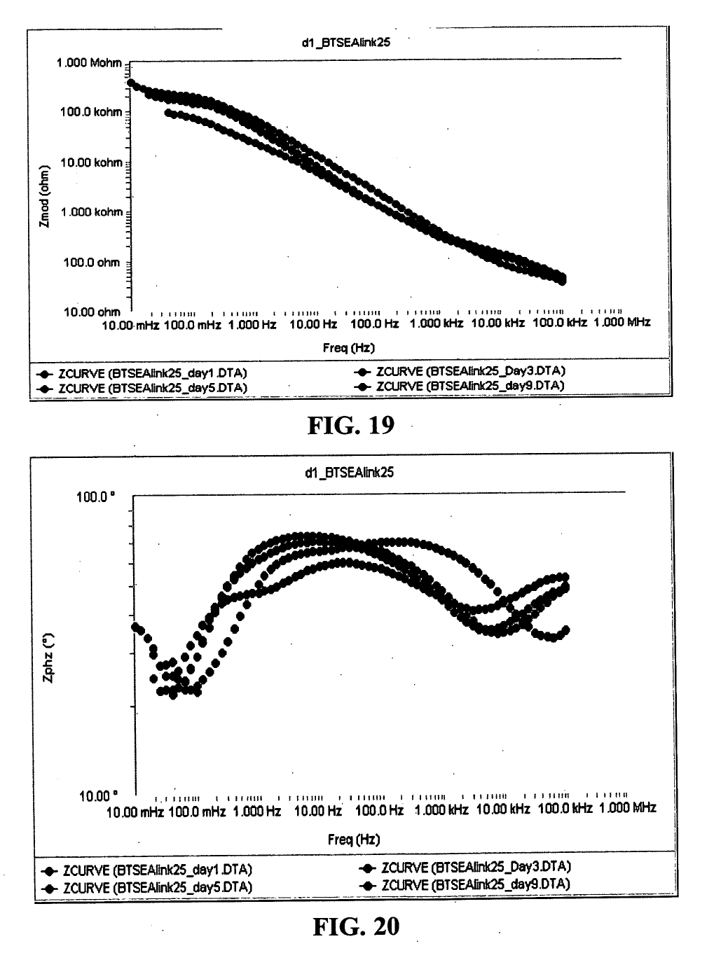

FIGS. 19 and 20 correspond to EIS testing data performed upon panels having the third exemplary superprimer formulation applied thereto. Four data sets are displayed on FIGS. 19 and 20, with each corresponding to test results conducted initially, two days after immersion in the NaCl solution, five days after immersion in the NaCl solution, and nine days after immersion in the NaCl solution.

In order to test the flexibility of each coating, the samples were bent at roughly 180° into a U-shaped orientation, with the coating located on the convex surface. Afterwards, the samples were examined with a magnification device and it was discovered that none of the samples developed cracks on the convex surfaces. The panels were then bent at roughly 360° into a U-shaped orientation and again examined for cracks within the concave surface. No cracks were detected within the coating as a result of this second bend.

Discussion: Visual detection of the superprimer formulations was more apparent with the addition to carbon black. More specifically, even with 2% of carbon black additions (the second exemplary superprimer formulation), the visual appearance of the coating can be altered from a transparent shiny coating to a visually detectable black coating.

It is clear, using the data represented in FIGS. 15-20, that the addition of 2% carbon black to the superprimer increases the modulus at lower frequencies, as compared to the formulation omitting carbon black (the first exemplary superprimer formulation). However, when the loading of carbon black is increased to 12% carbon black the modulus drops most likely because of the conductive nature of the carbon black and the increased likelihood that carbon particles are in contact with one another. In contrast, when the addition of carbon black is limited to 2%, most carbon black particles are not in contact with one another.

The above results clearly show that the addition of neutral nanoparticles, such as carbon black, to the superprimer coating can be used to modify the properties of the superprimer from an extremely resistive coating to a very conductive coating. This provides an excellent tool for using non-oxidic nanoparticles to tailor the properties of the coating to suite end use specifications without any compromise of the flexibility of the superprimer/coating or the corrosion resistance properties of the superprimer/coating.

### Experiment 9

All coating solutions are made by direct addition of the various components almost simultaneously and immediate high shear mixing. Those of ordinary skill will readily understand the scalability of the following experiment.

Components: (1) Silanes—Silquest® A-1289 Bis-[3-(triethoxysilyl) propyl]tetrasulfide, a bis-sulfur silane (available from General Electric,).

(2) Resin—NEOREZ R-972, a water-based polyurethane resin (available from DSM NeoResins,).

(3) Additives—NEOCRYL CX-100, a crosslinker (available from DSM NeoResins,).

(4) Particles—Carbon black N-330 (available from Cabot Corporation, www.cabot-corp.com).

Formulation and Preparation: The Superprimer was prepared by mixing neat bis-sulfur silane and NEOREZ R-972 in a high shear mixer in a weight ratio of 1:3. Carbon black N-330 was added to the silane and resin mixture in the amount of 2 wt % of the bis-sulfur silane, resin, and carbon black mixture. NEOCRYL CX-100 was added as crosslinker for the polyurethane in an amount of 5 wt % of the NEOREZ R-972 added. High-speed mixing was done at 4000 rpm for 12 minutes in a high shear blender subsequent to the addition of the crosslinker.

Substrates and Preparation: AA 2024-T3 alloy panels were dry scrubbed to remove superficial grease and mill dust. The panels were then subjected to ultrasonic cleaning in ethanol for 8 minutes at room temperature followed by alkaline cleaning in Okemclean alkaline cleaner at 60-65° C. for 3-5 minutes. Finally, the panels were thoroughly rinsed in water and forced air dried.

Application and Cure: The cleaned aluminum panels were coated with the superprimer using a draw-down bar number R 14. The coated panels were cured at room temperature.

Testing & Results: Salt water immersion testing was carried out on coated panels by partially immersing multiple coated panels in 3.5% by weight NaCl solution for a period of 60 days. The panels were scribed across the coated surface and taped on the bare side. The coating and the scribed surface were examined for occurrence of corrosion.

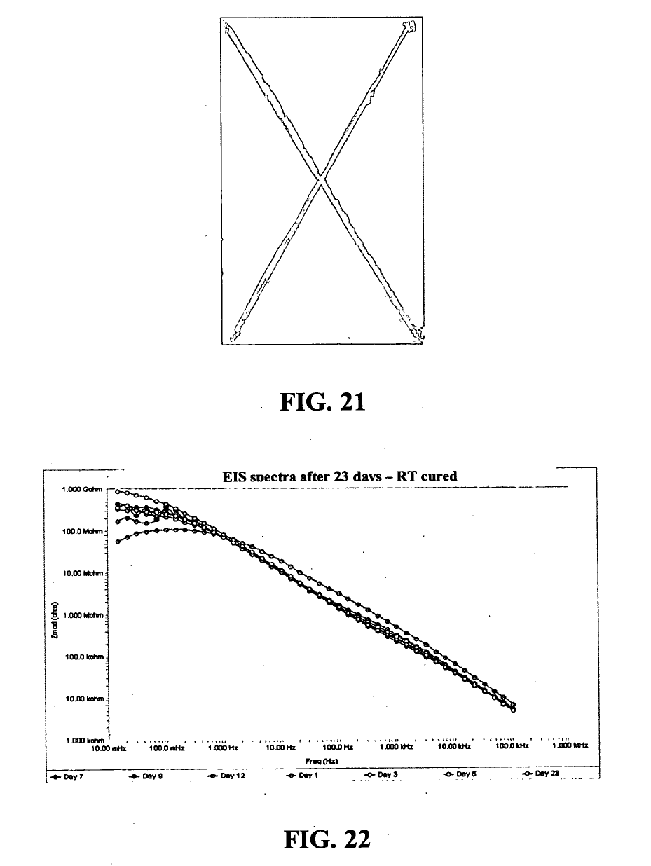

FIG. 21 reflects an exemplary panel subsequent to salt water immersion testing. In the coating cured at room temperature, some corrosion products (white rust) were visible on the scribes, but the remainder of the coated surface was essentially free of any form of corrosion. No delamination or blistering was observed over the entire panel, however, pitting could be observed under magnification.

FIG. 22 is a plot of EIS data of the superprimer coating system cured at room temperature. EIS data were collected over a period of 23 days. The variation of the modulus at low frequency (10 mHz) is the point of interest here. The modulus of impedance of the coating at low frequency i.e., 10 mHz gives the overall resistance or impedance of the coating, which can be correlated to the overall corrosion resistance of the coating. The modulus value at higher frequencies reflects the water intake in the coating.

Certain panels were subjected to a dry tape adhesion test as per the ASTM D3359 test specifications. The test was conducted for the coating in a dry condition (dried at room temperature for two weeks). The adhesion test results were interpreted based on the amount of coating delaminated, however, no delamination was observed in the coating.

Certain panels were subjected to the ASTM D522 mandrel bend test (mandrel diameter 3.2 mm) to determine the resistance to cracking or the flexibility of the coating. There was no visible cracking at the bent part in the coatings. The good flexibility of the coating can be attributed to the very high flexibility of the polyurethane resin which has a glass transition temperature well below room temperature.

Certain panels were also subjected to ASTM D5402 MEK rub test in which they sustained more than 300 double rubs. The thickness of coatings varied from 70 to 120 μm.

Finally, the hardness of the superprimer as per the ASTM 3363 Pencil test was found to be 4B.

Discussion: The superprimer coating is a water-based, chromate-free, low-VOC, silane-based corrosion resistant coating system with high flexibility, good adhesion, and high solvent resistance. No chromate conversion coating is required for this coating system and is environmentally benign.

### Experiment 10

All coating solutions are made by direct addition of the various components almost simultaneously and immediate high shear mixing. The total weight of the coating solutions produced is 100 grams, and those of ordinary skill will readily understand the scalability.

Components for Zinc Rich Paint: (1) Carbozinc 859 (part A, part B and Zn filler, available from Carboline,); and (2) n-butoxyethanol (available from Fisher Scientific).

Components for Zinc Rich Superprimer:

(1) Silanes—A1170-bis-amino silane (bis-trimethoxysilylpropylamine, available from General Electric,); and, A 1289, bis-sulfur silane(bis-[triethoxysilylproyl]tetrasulfide silane, available from General Electric,).

(2) Resin—Diglycidyl ether of bisphenol A (DGEBA) epoxy resin—

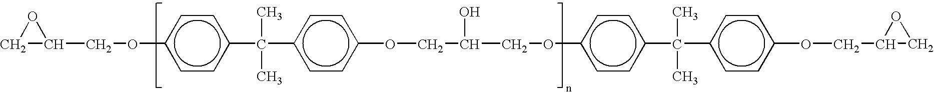

(3) Particles: Superfine zinc dust (grade 5) (available from U.S. Zinc,).

(4) Solvents: n-butoxyethanol (available from Fisher Scientific).

(5) Additives: Hexamethylene Diisocyanate-blocked curing agent Polyisocyanate (available as Desmodur VP LS 2253 from Bayer).

Formulation and Preparation of Zinc Rich Paint: 165 grams of zinc filler is added to 33.1 ml of Carbozinc part A and thoroughly mixed. To this mixture, 20 ml of Carbozinc part B is added, followed by the addition of 160 g of n-butoxyethanol to adjust the viscosity of the paint.

Formulation and Preparation of Zinc Superprimer: 90 grams of zinc dust is added to 10 gram of base formulation #1 and 1 gram of BAS. The mixture was allowed to stand for 30 minutes, followed by high shear mixing for approximately 15 minutes. Base formulation 1 in the exemplary improved superprimer formulation comprises 53.4 weight percent n-butoxyethanol, 36.1 weight percent epoxy primer, and 10.1 weight percent of a 2% hydrolyzed bis-amino silane. BAS comprises a 1:1 mixture of a non-hydrolyzed bis-amino silane with a non-hydrolyzed bis-sulfur silane. The epoxy primer comprises a low molecular weight epoxy resin (75-80 wt %), a polyisocyanate-based curing agent (15-20 wt %), and a tin catalyst (0.5-1 wt %). The 2% hydrolyzed bis-amino silane is prepared using 2 volume percent bis-amino silane, with 2 volume percent of deionized water, and with 96 volume percent ethanol.

Substrates: Cold-Rolled Steel (CRS) panels were cleaned in a 7% KOH solution at 60-70° C. for 3-7 minutes and rinsed in deionized water before being coated.

Application and Cure: The zinc-rich paint was applied to a two sets of CRS panels using a drawdown bar technique, using a #28 bar, consistent with normal paint/coating procedures. The paint was cured at 140° C. for 20 minutes.

Coatings of the exemplary zinc-rich superprimer were applied to two sets of CRS panels using a drawn-down bar technique consistent with normal paint/coating procedures. A # 28 bar was used, but the zinc-rich superprimer displayed a low viscosity that might utilize a lower bar # for optimum application. The coated panels were cured at 50° C. for 30 minutes, followed by one week at room temperature.

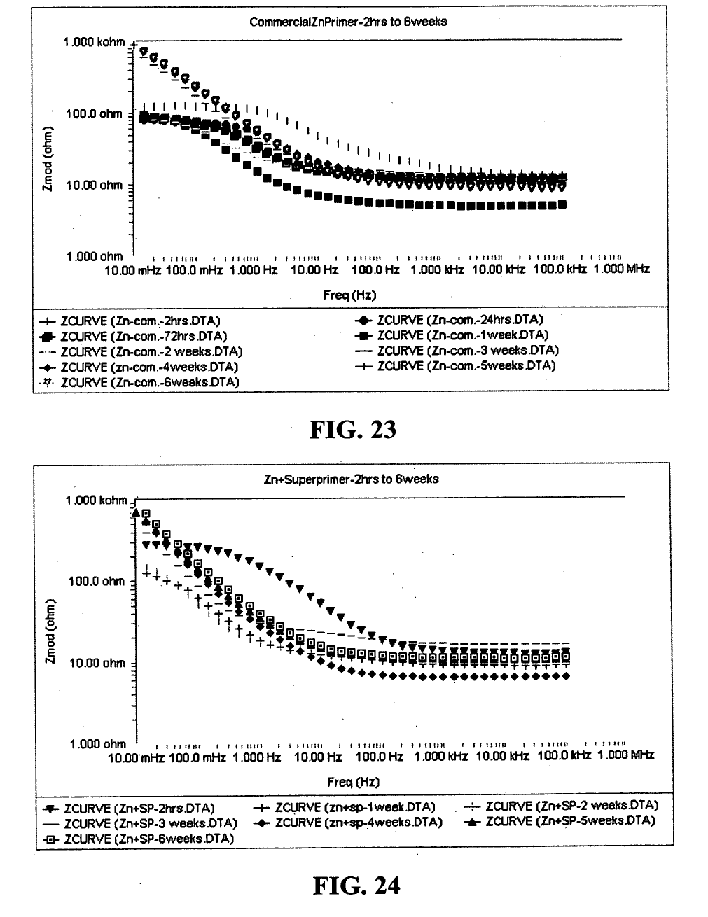

Testing: Electrochemical impedance spectroscopy (EIS) testing was done on the first set of panels coated with the zinc-rich paint and the first set of panels coated with the zinc-rich superprimer in a 3.5% (by weight) NaCl solution with a saturated calomel electrode (SCE) and a graphite counter electrode. FIGS. 23 and 24 compare the EIS data of the zinc-rich paint (FIG. 23) against the zinc-rich superprimer (FIG. 24).

ASTM B117 salt spray testing was conducted on the second set of panels coated with the zinc-rich paint and the second set of panels coated with the zinc-rich superprimer.

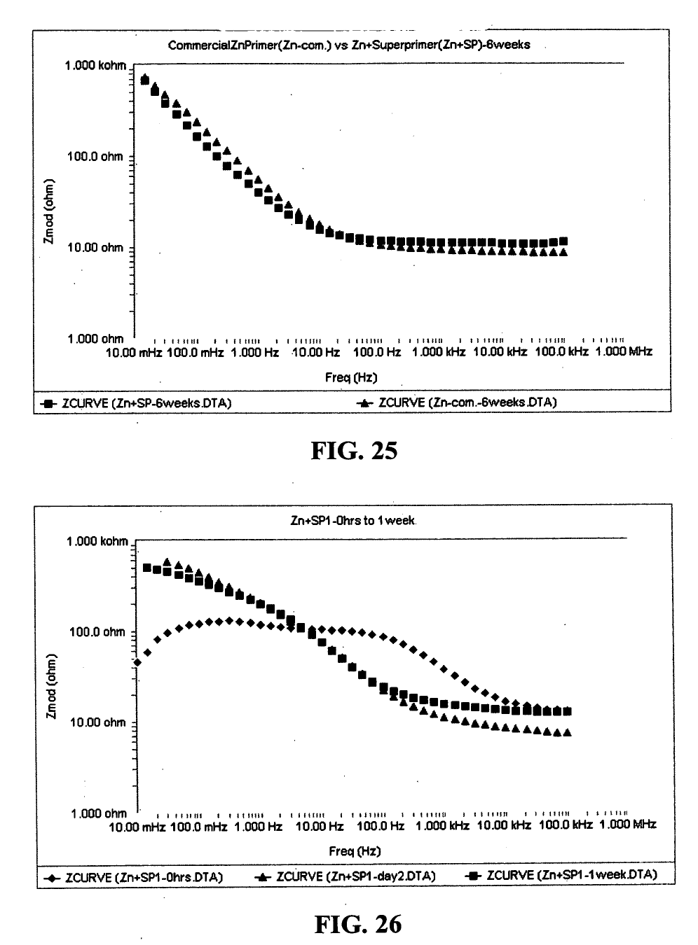

Results: FIGS. 23 and 24 reflect the EIS data of the zinc-rich paint (FIG. 23) versus the zinc-rich superprimer (FIG. 24) at various time delayed intervals. FIG. 25 directly compares the EIS data of the zinc-rich paint against the zinc-rich superprimer six weeks after testing began.

Table 5 provides a qualitative summary of the ASTM B117 salt spray testing results after 168 hours of testing. FIGS. 39 and 30 pictorially represent exemplary panels coated with the zinc-rich paint and coated with the zinc-rich superprimer, respectively, after 168 hours of salt spray testing.

TABLE 5

| | | White rust in | Undermining |
|---|---|---|---|
| | Blisters/Pitting | the scribe | from the scribe |
| Zinc Rich Paint | Growing presence, | Yes | No |
| (Commercial) | covers most of the | | |
| | area | | |
| Zinc Rich | Present in a small | Yes, to a lesser | No |
| Superprimer | area | extent | |

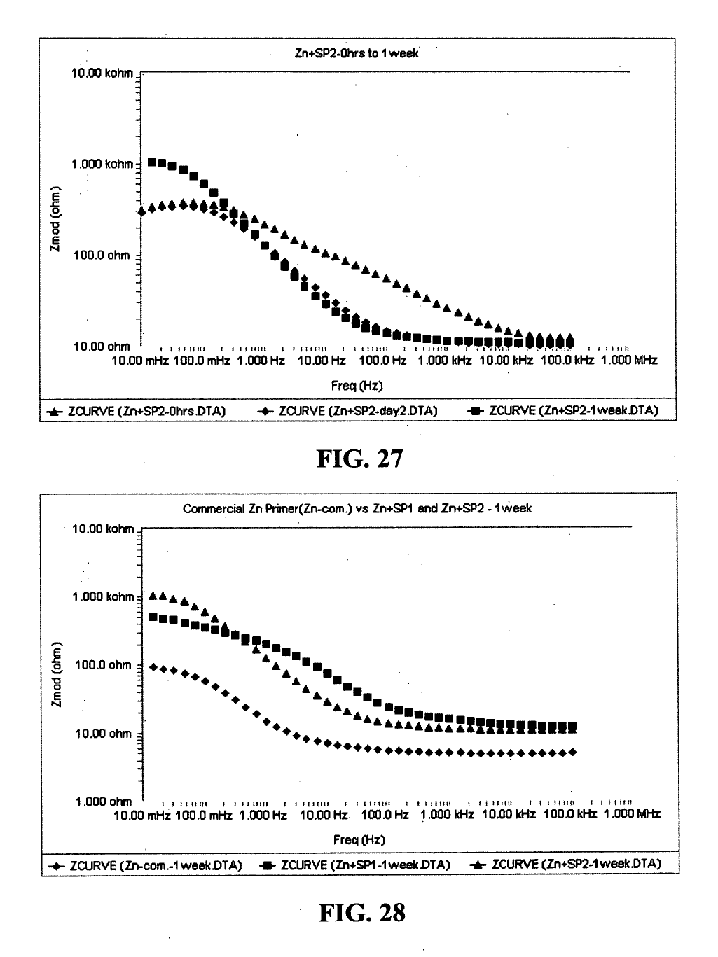

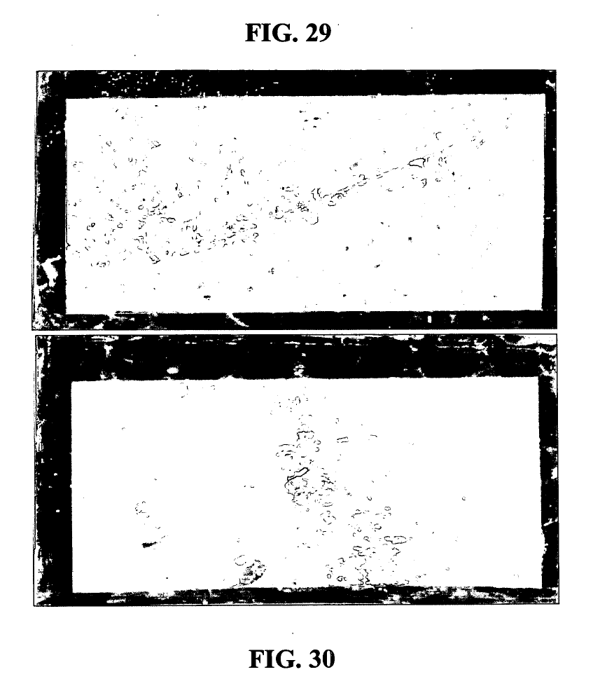

Discussion: It can be seen from the EIS data in FIGS. 23-25 that the zinc-rich superprimer formulations of this experiment behave well in comparison to the commercial zinc-rich paint formulation, but without the use of chromates. In addition to the exemplary formulation discussed above, two other exemplary formulations were applied and tested as shown by EIS plots of FIGS. 26-28. These additional exemplary formulations comprise 90 grams of zinc dust added to 100 grams of n-butoxyethanol and 10 grams of X, where: X in a second exemplary formulation comprises 55.4 weight percent n-butoxyethanol, 33.8 weight percent epoxy primer, and 10.8 weight percent of a 1:1 mixture of a non-hydrolyzed bis-amino silane with a non-hydrolyzed bis-sulfur silane (FIG. 26); and, X in a third exemplary formulation comprises 44.3 weight percent n-butoxyethanol, 27.1 weight percent epoxy primer, 8.6 weight percent of a 1:1 mixture of a non-hydrolyzed bis-amino silane with a non-hydrolyzed bis-sulfur silane; and 20.0 weight percent of a non-hydrolyzed bis-sulfur silane (FIG. 27). FIG. 28 compares the EIS data of the second and third exemplary formulations against the zinc-rich paint after one week's worth of testing. It can be seen that the second and third exemplary formulations performed as well or better than the zinc-rich paint, also without using chromates.

### Experiment 11

All coating solutions are made by direct addition of the various components almost simultaneously and immediate high shear mixing. The total weight of the coating solutions produced is 100 grams, and those of ordinary skill will readily understand the scalability.

Components: (1) Silanes—Silquest A 1289, a bis-[triethoxysilylproyl]tetrasulfide silane (available from General Electric,); Y-9805, a bis-[triethoxysilylethane], available from General Electric,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

Formulation and Preparation: The Superprimer is prepared by a mixture of resins, a non-hydrolyzed silane, and deionized water. 70 grams of ECOCRYL 9790 is added to an empty container. 20 grams of EPI-REZ WD-510 are added to the container, as well as 30 grams of a non-hydrolyzed silane. The non-hydrolyzed silane may comprise either Y-9805, A-1289, or a mixture of these silanes. Mixtures of these silanes, in exemplary form, comprise ratios of 1:1, 2:1, or 1:2. If a mixture of silanes is used, the silanes are mixed separately in a vessel and then added in the recited amount to the mixture of the ECOCRYL 9790 and EPI-REZ WD-510.

The resulting mixture of silanes and resin is diluted with deionized water to arrive at the desired viscosity, and may be determinative in the thickness of the eventual coating applied to the particular substrate. Generally an addition of 30-40 grams of deionized water to the above mixture of resin and silane results in a coating ranging from 15-40 μm. Thinner coatings can be obtained by addition of more water, however, excessive addition of water may result in loss of wettability of the substrate to be coated and may be remedied by the addition of surfactants.

This diluted mixture of silanes and resin is high shear blended for approximately 5-10 minutes at 3500 rpm using a 100 LC High-Shear Blender, with a micro-assembly attachment. The resulting blended mixture has a pot life of approximately 5 hours.

FIG. 31 provides a listing of the exemplary formulations applied to selected metal panels.

Substrates and Preparation: Metal panels (AA 2024 T3 alloy) were cleaned and degreased. This process included ultrasonic cleaning in ethanol at 50° C. for ten minutes, followed by immersion in an alkaline cleaner at 65° C. for 3-5 minutes. The panels were removed from the alkaline cleaner and rinsed with deionized water and blown dry with compressed air.

Selected panels were then coated with the superprimer formulation as recited in FIG. 31. In this experiment, the superprimer was applied to each of the panels by brush, however, it is to be understood that the superprimer may be applied using other techniques such as, without limitation, draw down or spraying.

Application and Cure: Coatings of the improved superprimer were applied to selected panels by brushing and cured at 110° C. for 30 minutes. The resulting superprimer coating was approximately 30-40 μm thick.

Testing: Electrochemical impedance spectroscopy (EIS) testing was done in a 3.5% (by weight) NaCl solution with a saturated calomel electrode (SCE) and a graphite counter electrode. The data was collected at constant OCP and the panels were subjected to an electrolyte typically for one hour.

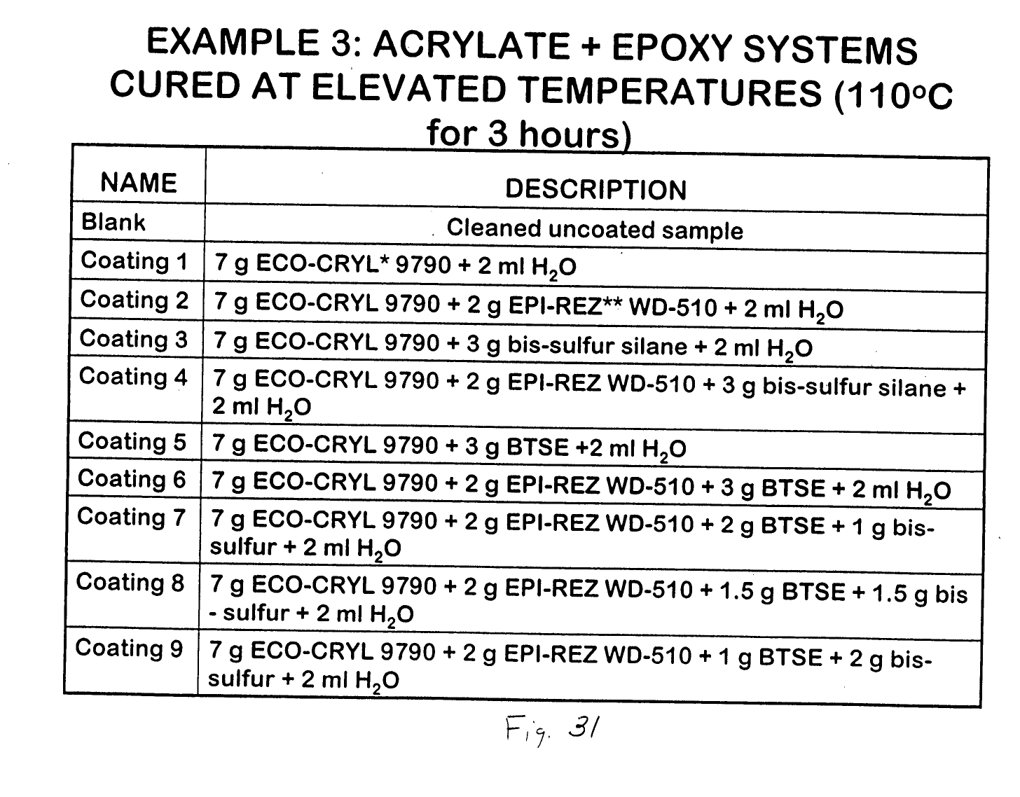

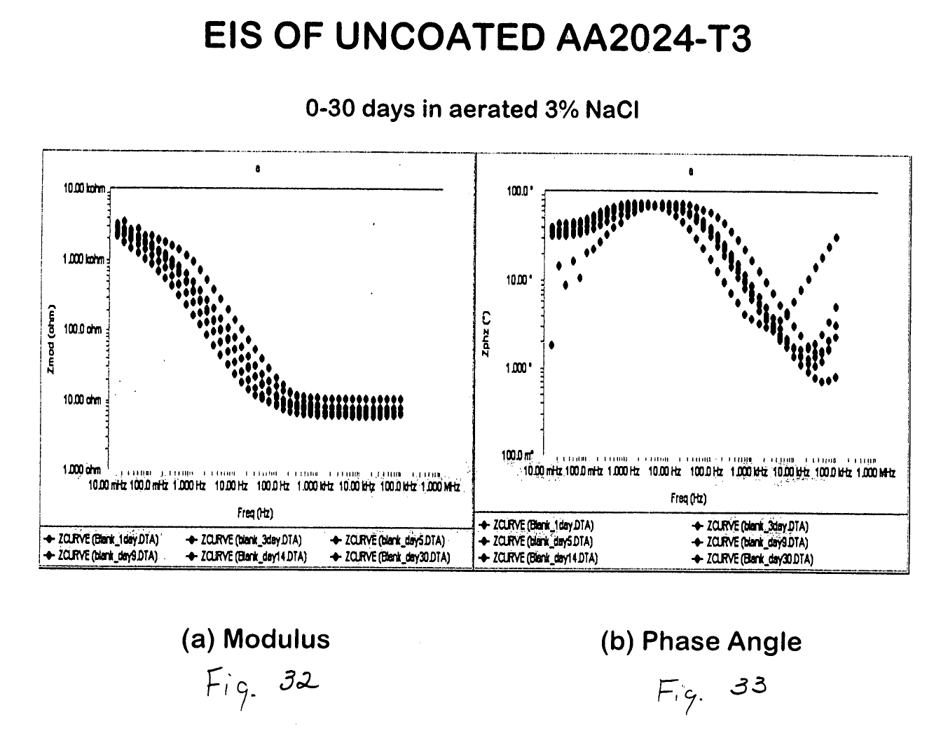

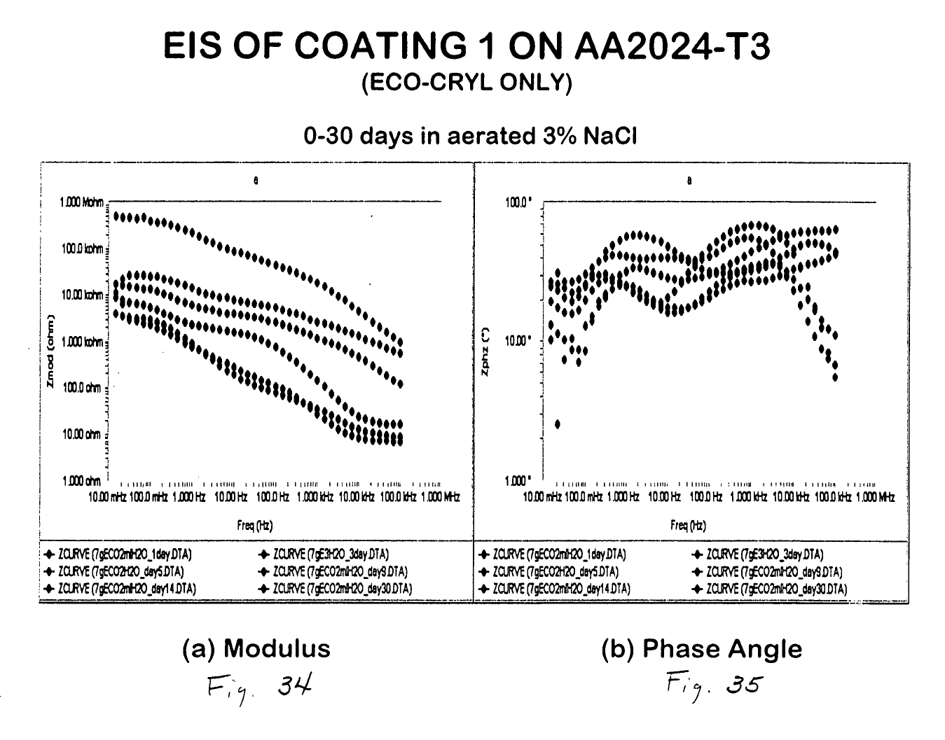

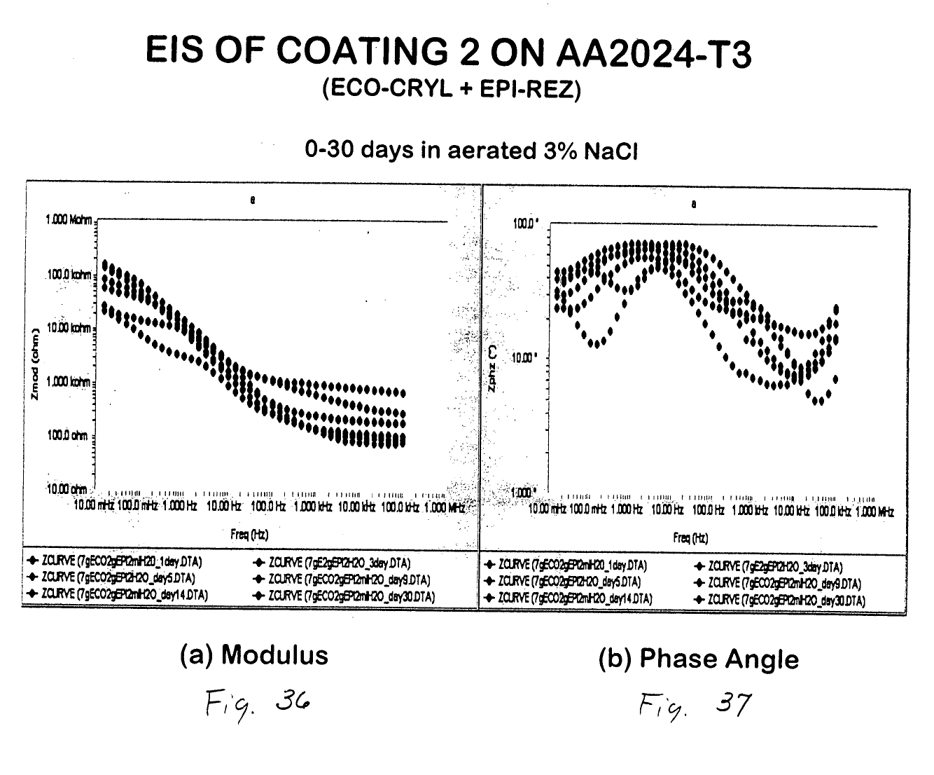

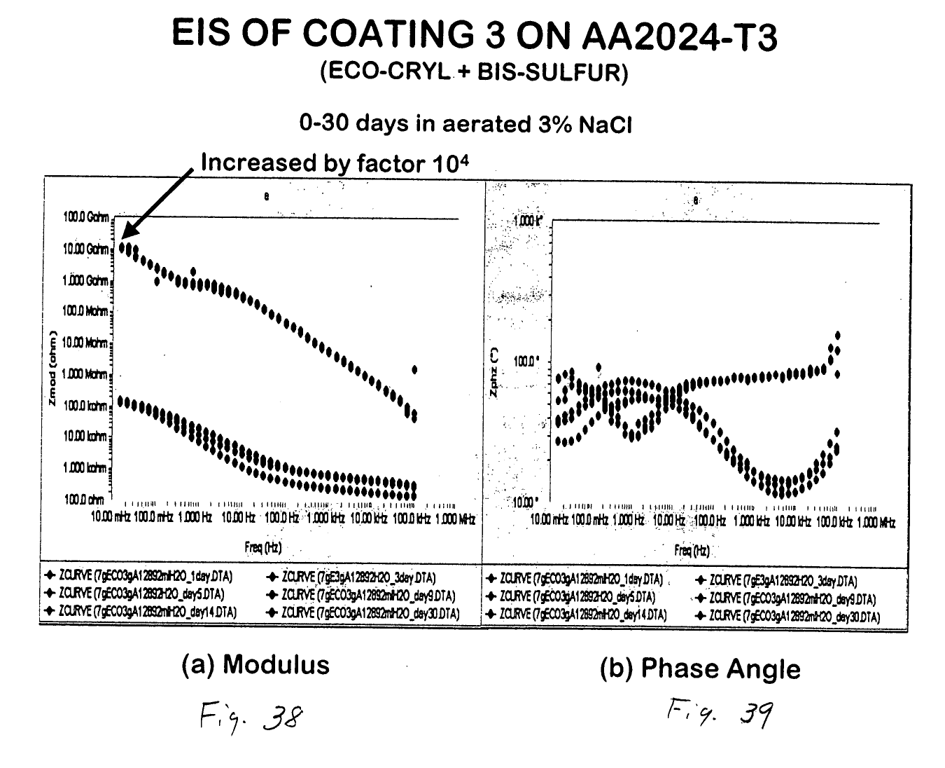

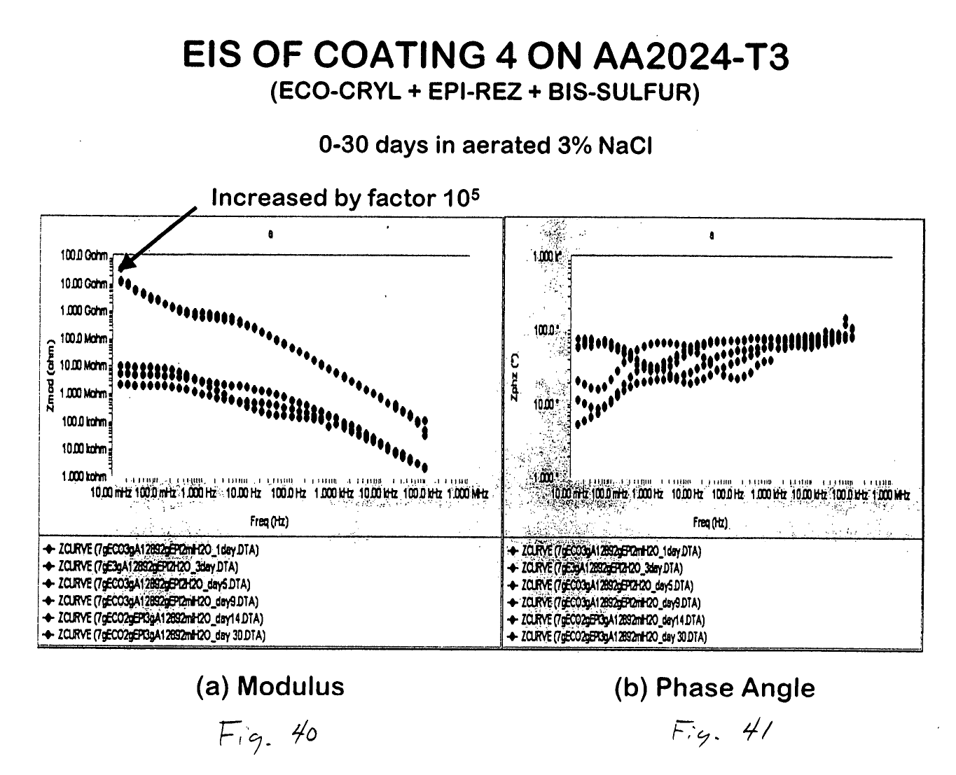

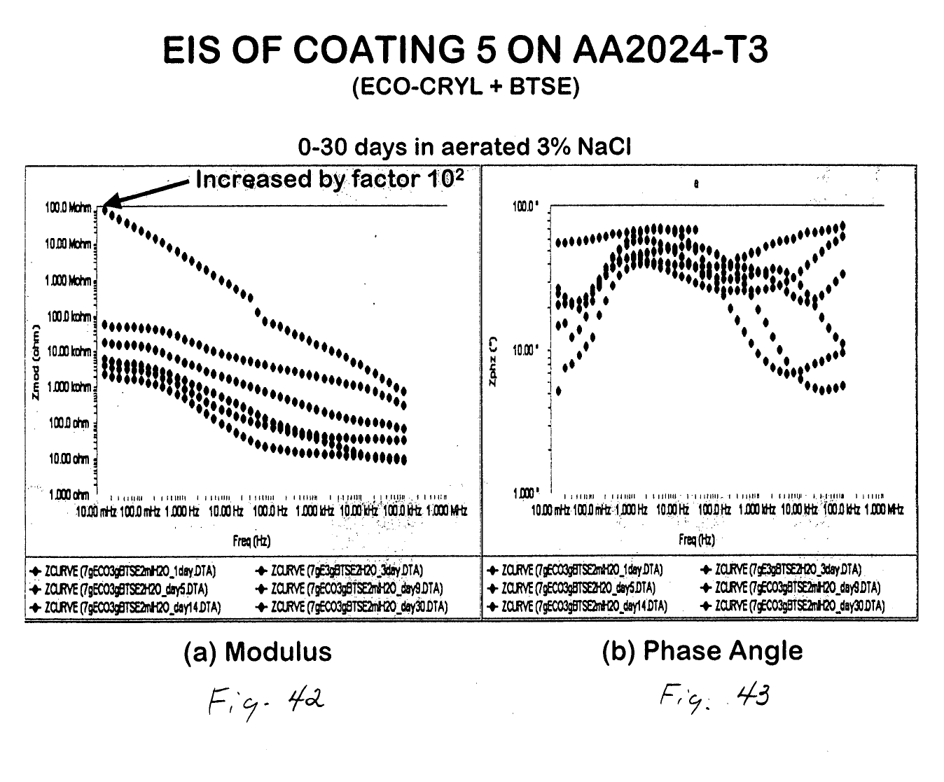

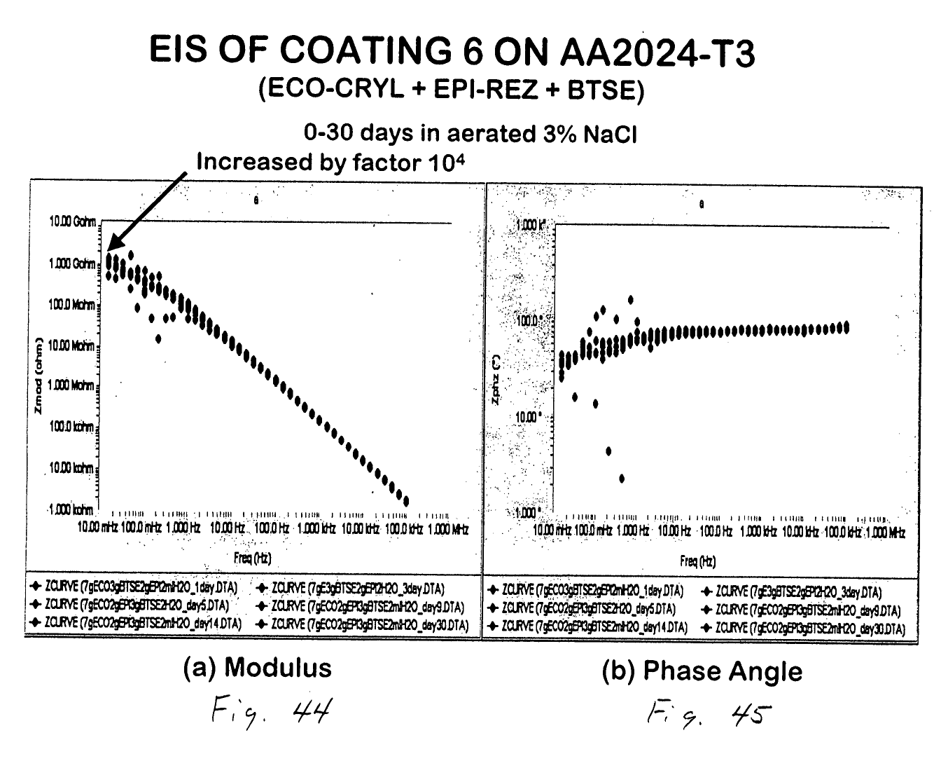

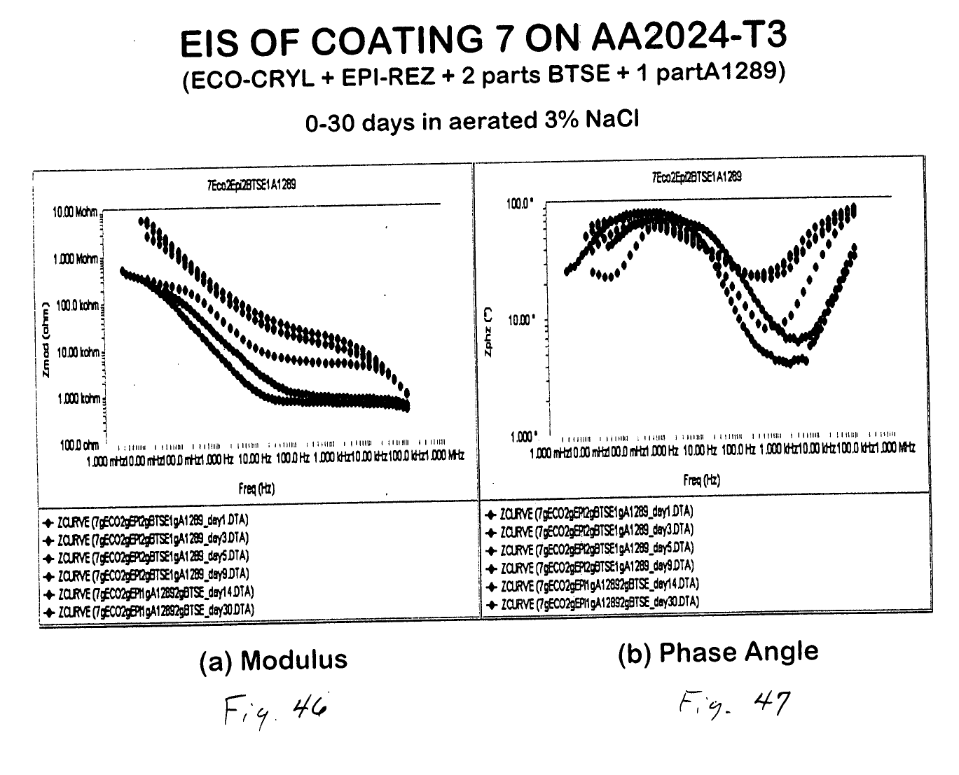

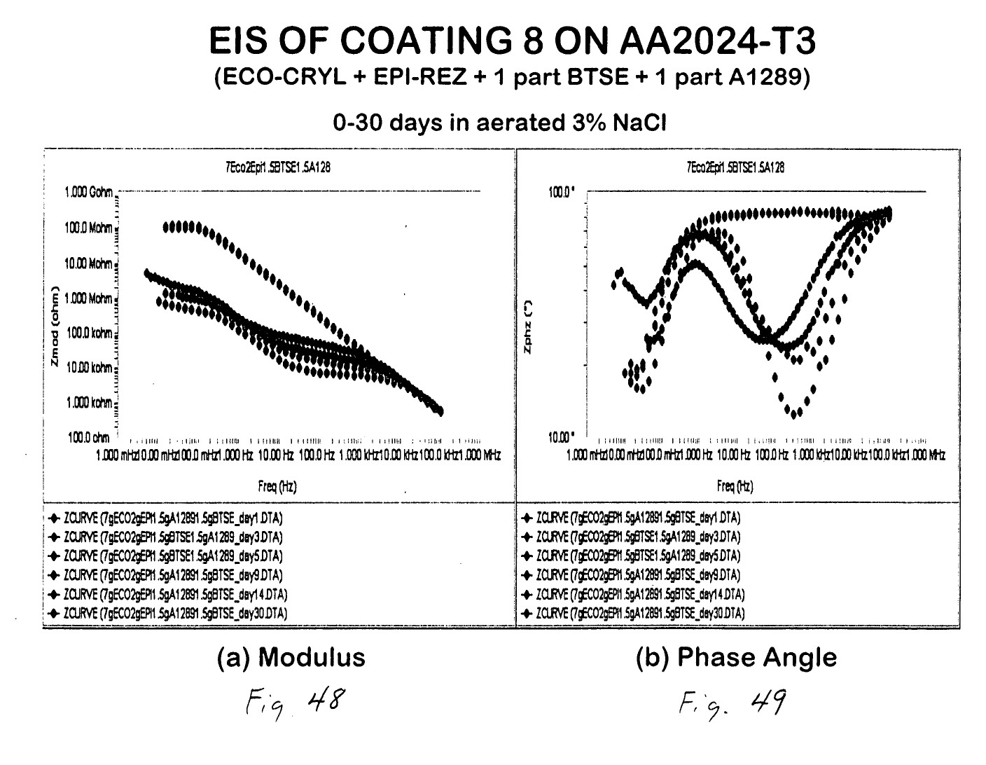

Results: FIGS. 32-51 reflect the data generated by the EIS testing of the exemplary panels listed in FIG. 31, with FIGS. 32 and 33 corresponding to a blank panel and continuing through FIGS. 50 and 51 corresponding to a panel having coating #9 applied thereto.

Discussion: It can be seen by comparing the EIS data of the improved superprimer coating incorporating ECOCRYL 9790 and EPI REZ WD-510 alone without any silane additions and the improved superprimer coatings made by combining silanes with ECOCRYL 9790, ECOCRYL 9790, and EPI REZ WD 510 that the modulus observed for low frequencies is increased by four orders of magnitude at low frequencies. This clearly indicates that the improved superprimer coatings containing silane are altered and performance with regards to corrosion protection greatly enhanced. A modulus greater that 10⁶ ohms is considered to be good corrosion resistance and it is seen that above this value at low frequencies no corrosion is observed.

On comparing the improved superprimer coatings with ECOCRYL 9790 and silanes versus the improved superprimer coatings with silane addition to ECOCRYL 9790 and EPI REZ WD 510, it is observed that the modulus at low frequencies remains more stable and does not drop considerably for the former formulation, while the latter formulation results in a considerable drop in the modulus at low frequencies. These results appear to indicate that the collapse of the former coating formulation is a result of the absence of EPI REZ WD-510.

It may also be observed that the combination of silanes work well and result in a high modulus at low frequencies. In addition, the drop in modulus over a period of 30 days in not considerable.

### Experiment 12

All coating solutions are made by direct addition of the various components almost simultaneously and immediate high shear mixing. The total weight of the coating solutions produced is 100 grams, and those of ordinary skill will readily understand the scalability.

Components: (I) Silanes—Silquest A 1289, a bis-[triethoxysilylproyl]tetrasulfide silane (available from General Electric,); Y-9805, a bis-[triethoxysilylethane], available from General Electric,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

Formulation and Preparation: The Superprimer is prepared by a mixture of resins, a non-hydrolyzed silane, and deionized water. 70 grams of ECOCRYL 9790 is added to an empty container. 20 grams of EPI-REZ WD-510 are added to the container, as well as 30 grams of a non-hydrolyzed silane. The non-hydrolyzed silane may comprise either Y-9805, A-1289, or a mixture of these silanes. Mixtures of these silanes, in exemplary form, comprise ratios of 1:1, 2:1, or 1:2. If a mixture of silanes is used, the silanes are mixed separately in a vessel and then added in the recited amount to the mixture of the ECOCRYL 9790 and EPI-REZ WD-510.

The resulting mixture of silanes and resin is diluted with deionized water to arrive at the desired viscosity, and may be determinative in the thickness of the eventual coating applied to the particular substrate. Generally an addition of 30-40 grams of deionized water to the above mixture of resin and silane results in a coating ranging from 15-40 μm. Thinner coatings can be obtained by addition of more water, however, excessive addition of water may result in loss of wettability of the substrate to be coated and may be remedied by the addition of surfactants.

The diluted silane and resin mixture may include the addition of a cosslinker if a room temperature cure is desired. Exemplary crosslinkers for use in the present formulation include, without limitation, Alink-25, Alink-15 (both available from Gelest, Inc.,) and CX-100 (available from Neo Resins,). These crosslinkers are an isocyanourate, amine and imine based crosslinker respectively. This is an optional step and can be ignored if a high temperature cure of the superprimer is desired. For purposes of this disclosure, high temperature cure generally refers to curing the superprimer at temperatures above 110° C. for a period exceeding three hours.

Other additives such as, without limitation, nano particles including carbon black or zinc dust may be provided to the aforementioned formulation. These additives may be incorporated into the diluted silane and resin mixture during high shear blending or at preliminary stages of blending.

This diluted mixture of silanes, resin, and any additives are high shear blended for approximately 5-10 minutes at 3500 using a 100 LC High-Shear Blender, with a micro-assembly attachment. The resulting blended mixture has a pot life of approximately 5 hours.

FIG. 52 provides a listing of the exemplary formulations applied to selected metal panels.

Substrates and Preparation: Metal panels (AA 2024 T3 alloy) were cleaned and degreased. This process included ultrasonic cleaning in ethanol at 50° C. for ten minutes, followed by immersion in an alkaline cleaner at 65° C. for 3-5 minutes. The panels were removed from the alkaline cleaner and rinsed with deionized water and blown dry with compressed air.

Selected panels were then coated with the superprimer formulation as recited in FIG. 52. In this experiment, the superprimer was applied to each of the panels by brush, however, it is to be understood that the superprimer may be applied using other techniques such as, without limitation, draw down or spraying.

Application and Cure: Coatings of the improved superprimer were applied to selected panels by brushing and cured at 110° C. for 30 minutes. The resulting superprimer coating was approximately 30-40 μm thick, with the first and second samples high temperature cured, while the remaining samples were room temperature cured.

Testing: Electrochemical impedance spectroscopy (EIS) testing was done in a 3.5% (by weight) NaCl solution with a saturated calomel electrode (SCE) and a graphite counter electrode. The data was collected at constant OCP and the panels were subjected to an electrolyte typically for one hour.

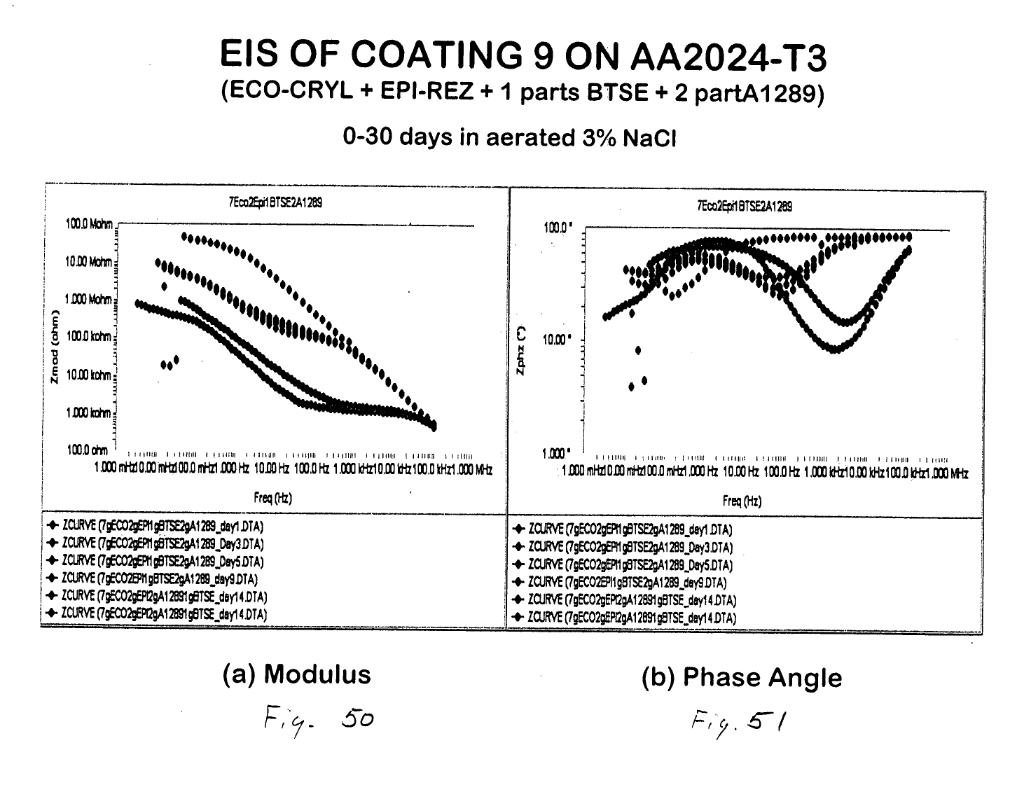

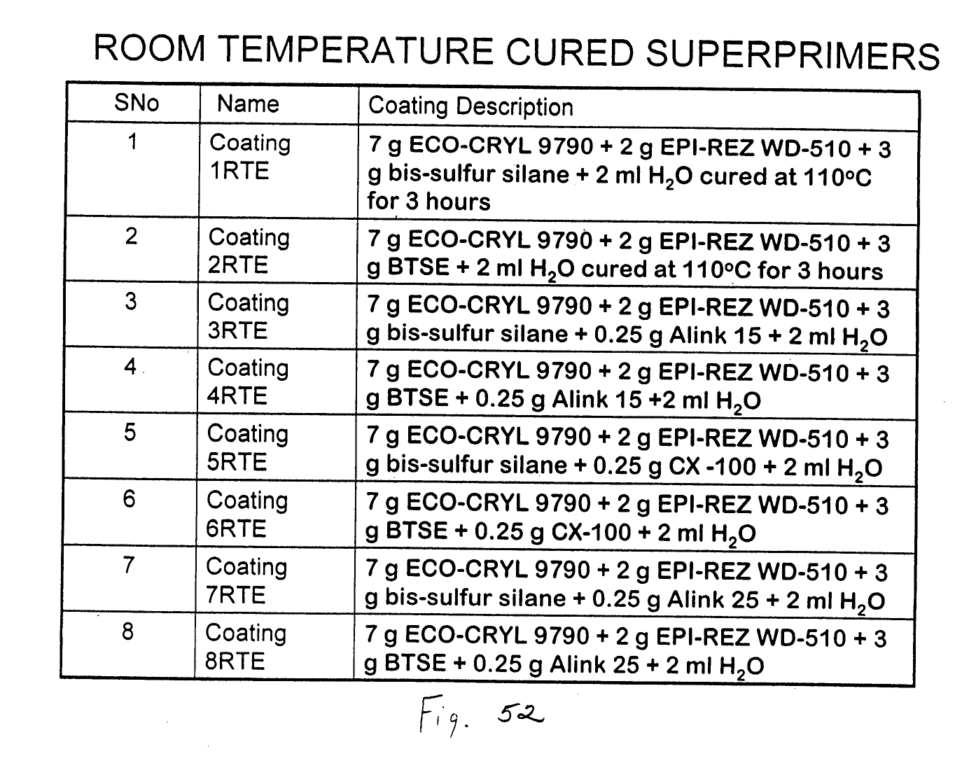

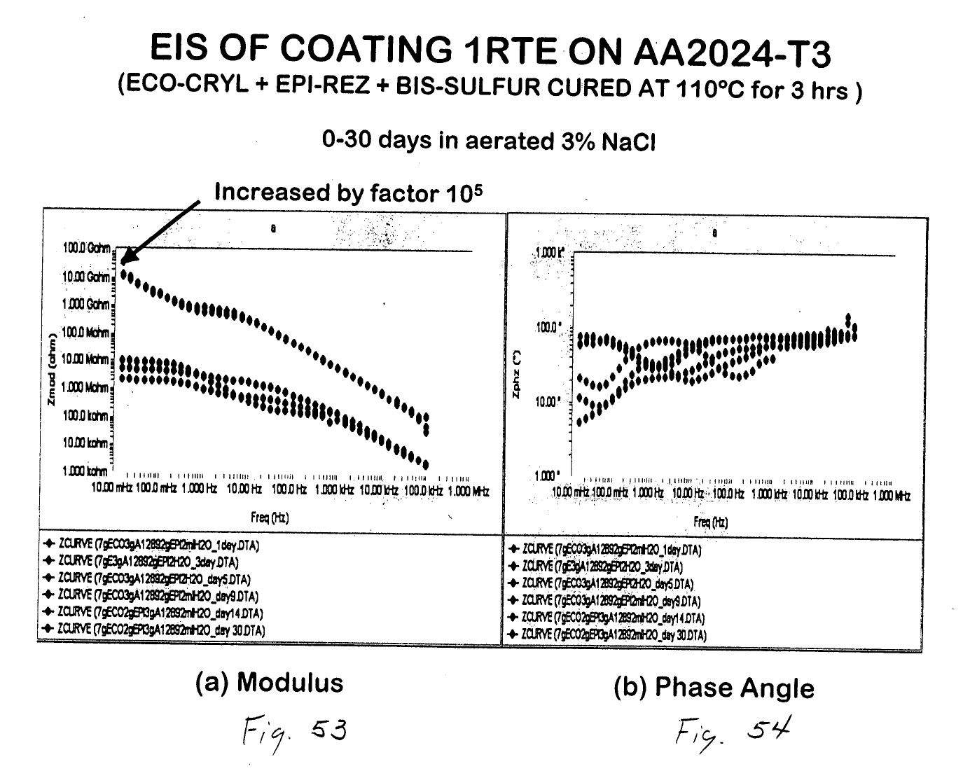

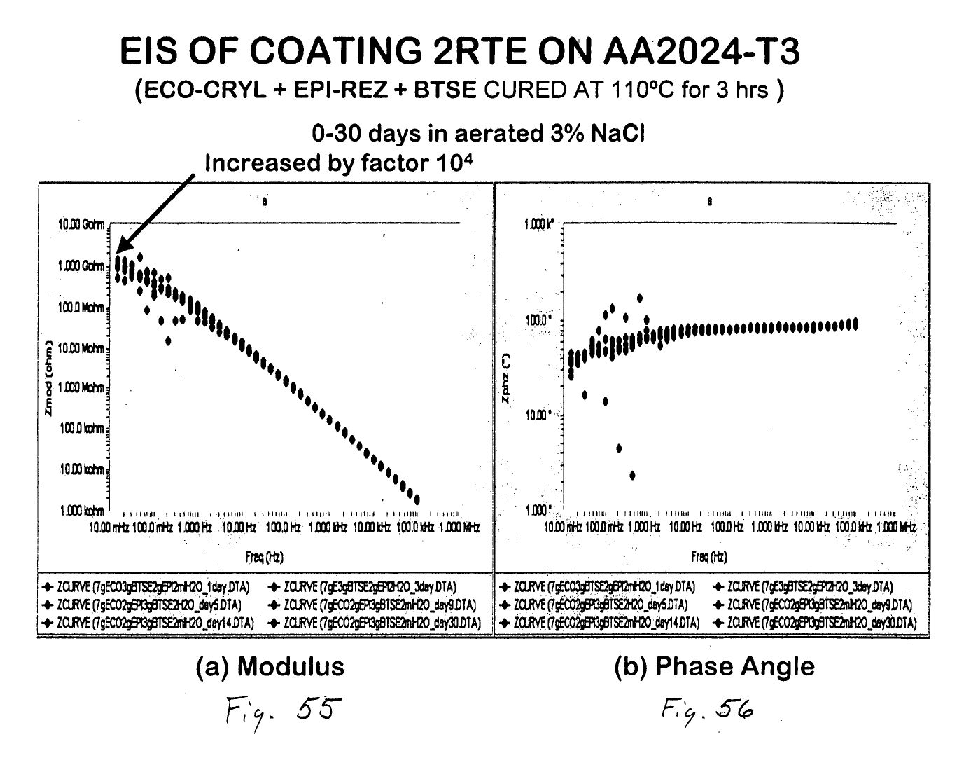

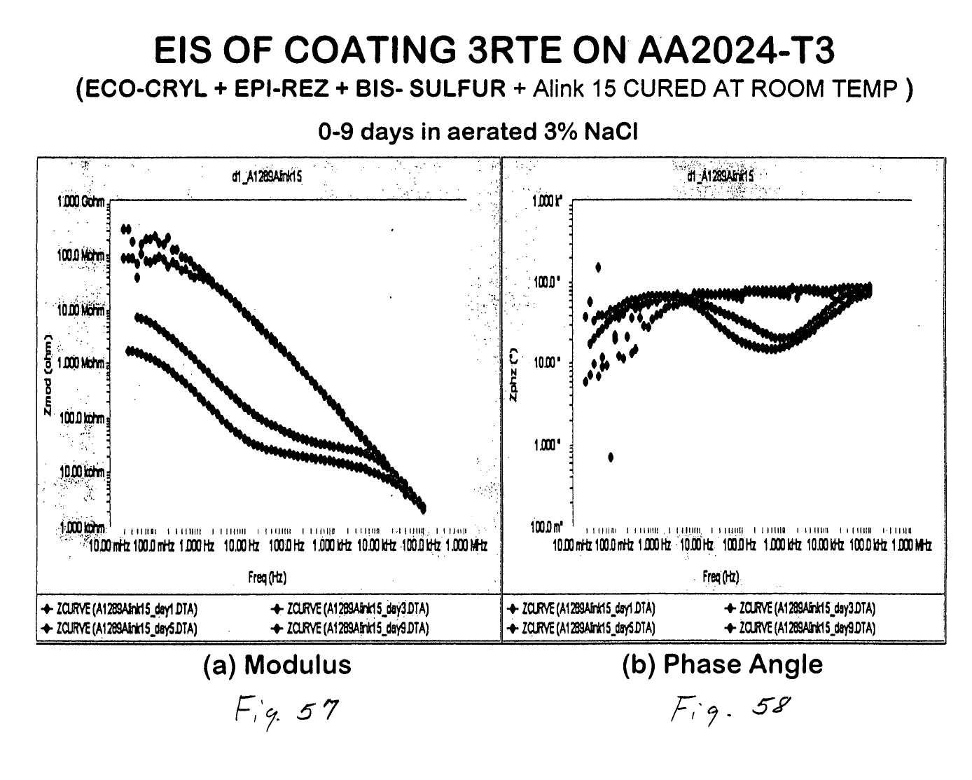

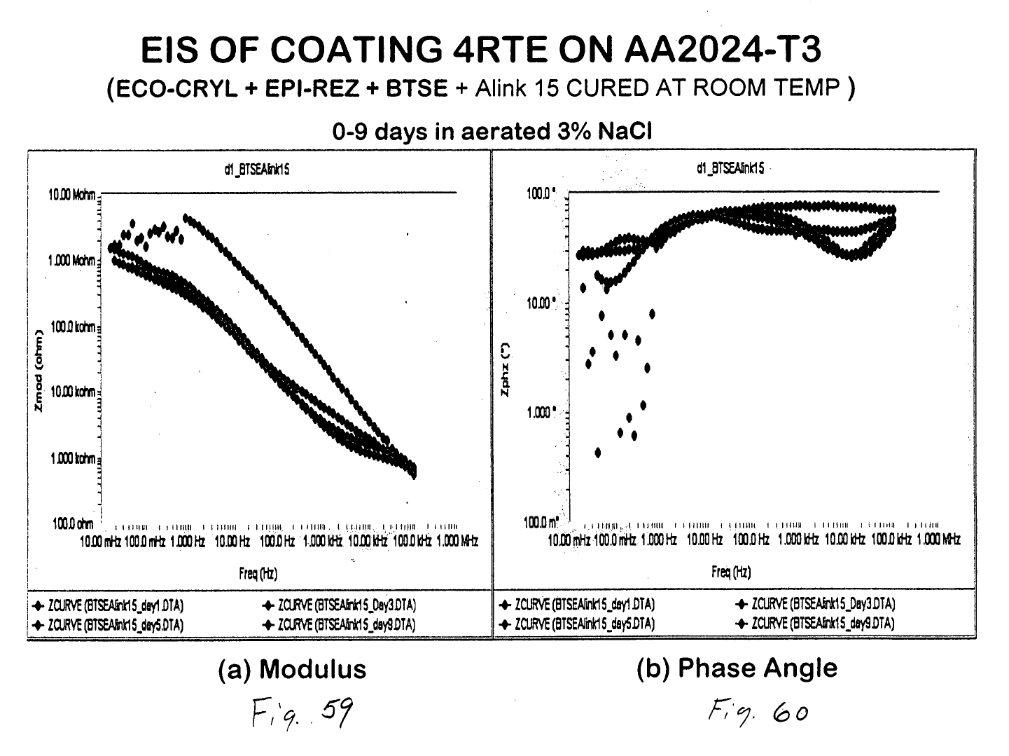

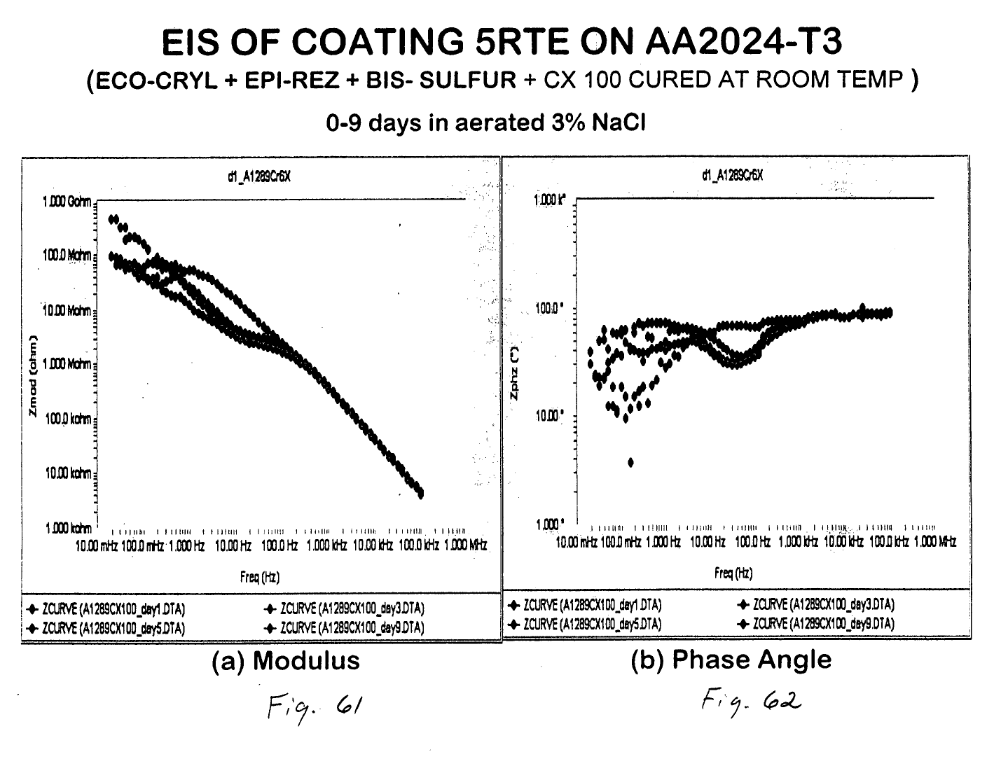

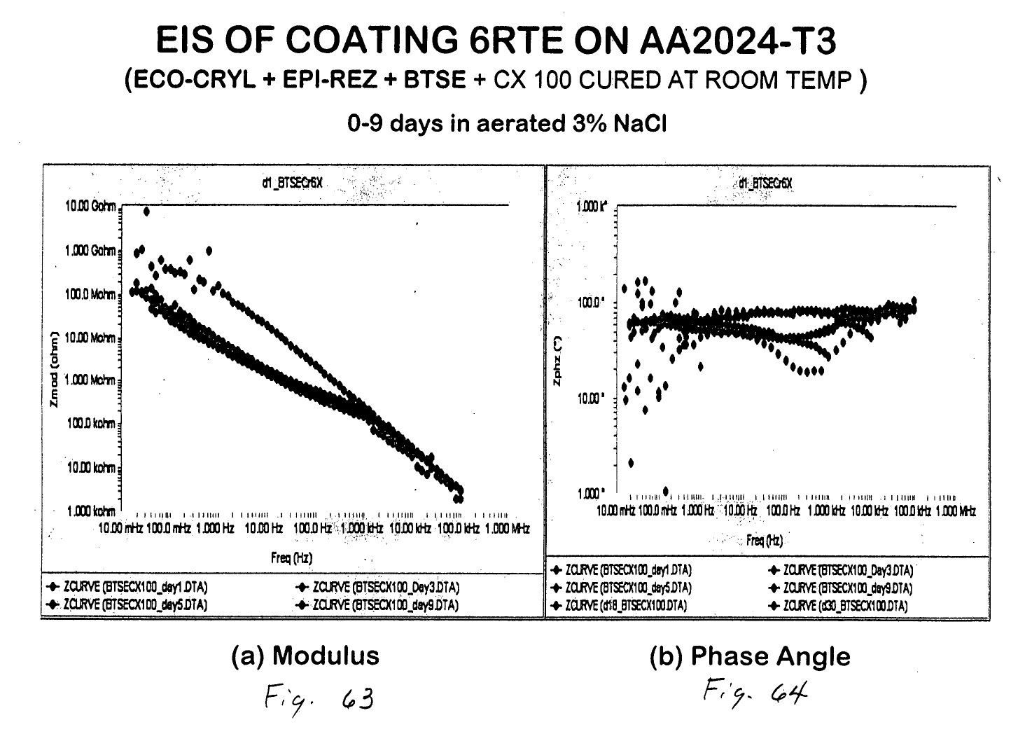

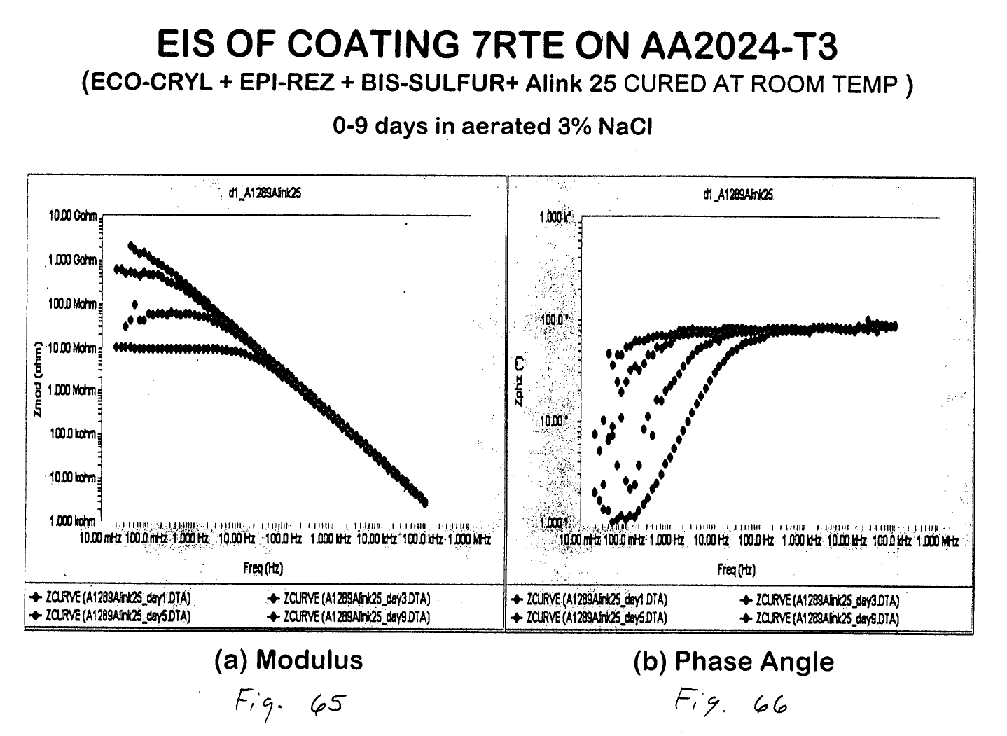

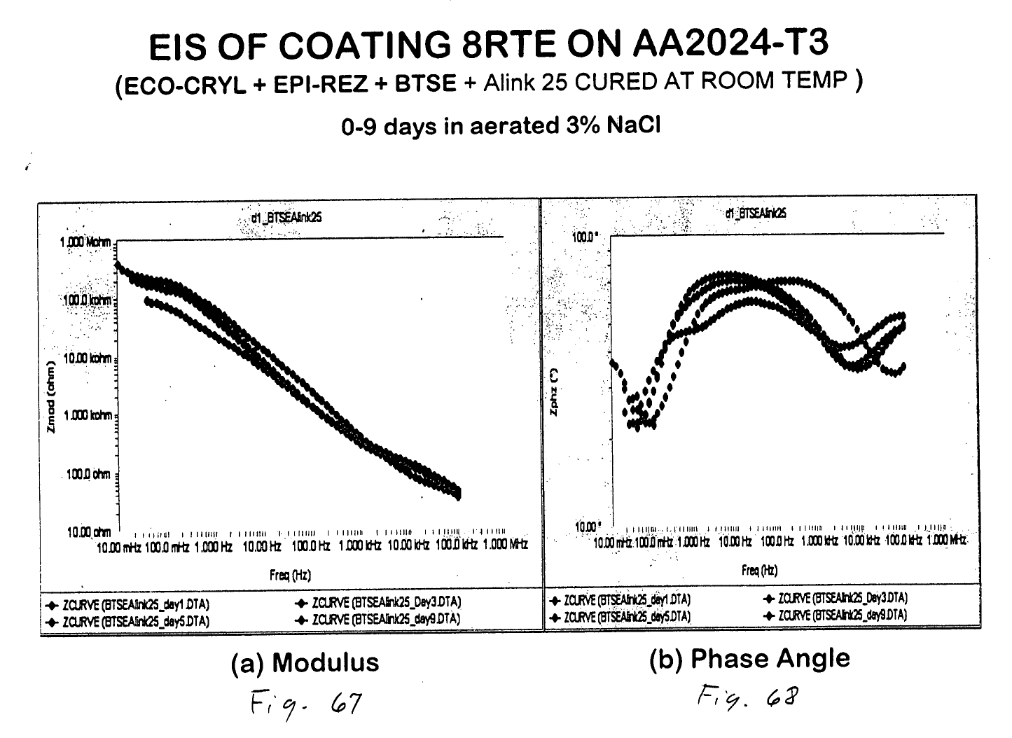

Results: FIGS. 53-68 reflect the data generated by the EIS testing of the exemplary panels listed in FIG. 52, with FIGS. 53 and 54 corresponding to a panel having coating #1 applied thereto and continuing through FIGS. 67 and 68 corresponding to a panel having coating #8 applied thereto. In addition, FIG. 69 includes pictorial data derived after 200 hours of NaCl solution immersion testing on the each of the exemplary coatings listed in FIG. 52.

Discussion: It is clearly seen from the EIS data of the improved superprimer coatings formulated to cure at room temperature performed comparable to coatings formulated to cure at elevated temperatures. Thus, an improved superprimer formulation curing at room temperature may have comparable performance to elevated temperature curing formulations by incorporating crosslinkers like Alink 25, Alink 15 and CX 100.

It can be seen from the pictorial data that there is no substantial evidence of corrosion on any of the panels coated with the improved superprimer coating. This evidence bolsters the proposition that a room temperature cure of an improved superprimer formulation can achieve substantially the same or improved corrosion resistance in comparison to a primer coating cured at elevated temperatures.

### Experiment 13

All coating solutions are made by direct addition of the various components almost simultaneously and immediate high shear mixing. Those of ordinary skill will readily understand the scalability of the following experiment.

Components: (1) Silanes—Y-9805, a bis-[triethoxysilylethane] (available from General Electric,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

(3) Additives—Alink-25, a crosslinker (available from General Electric,).

Formulation and Preparation: The Superprimer is prepared by a mixture of resins, a non-hydrolyzed silane, a crosslinker, and deionized water. 70 grams of ECOCRYL 9790 is added to an empty container. 20 grams of EPI-REZ WD-510 are added to the container, as well as 30 grams of Y-9805, a non-hydrolyzed silane.

The resulting mixture of silane and resins is diluted with deionized water to arrive at the desired viscosity, and may be determinative in the thickness of the eventual coating applied to the particular substrate. Generally an addition of 30-40 grams of deionized water to the above mixture of resins and silane results in a coating ranging from 15-40 μm. Thinner coatings can be obtained by addition of more water, however, excessive addition of water may result in loss of wettability of the substrate to be coated and may be remedied by the addition of surfactants.

A crosslinker, in the amount of 2.5 grams of Alink-25, is added to the diluted silane and resin mixture. The resulting mixture is high shear blended for approximately 5-10 minutes at 4500 rpm using a 100 LC High-Shear Blender, with a micro-assembly attachment.

Substrates and Preparation: Five sets of metal panels {{CRS Cold Rolled Steel}} were cleaned and degreased. The first set was cleaned by scrubbing, ethanol swabs, and acetone swabs. The second set was cleaned by scrubbing, ethanol swabs, and acetone ultrasonic cleaning for 10 minutes. The third set was cleaned by scrubbing, ethanol swabs, acetone ultrasonic cleaning for 10 minutes, and 5 minutes in an alkaline cleaner at 55° C. The fourth set was cleaned by ethanol swabs and acetone swabs. The fifth set was cleaned by ethanol swabs and acetone ultrasonic cleaning for 10 minutes. All of the panels were rinsed with deionized water and blown dry with compressed air.

Application and Cure: A first set of the panels was then coated with the above-referenced superprimer formulation. In this experiment, the superprimer was applied to each of the panels by brushing, however, it is to be understood that the superprimer may be applied using other techniques such as, without limitation, draw down or spraying. The coated panels were cured at 70° C. for 3 hours, and thereafter at room temperature for 2 weeks. A second set of panels were cleaned, but had no superprimer applied thereto.

Testing: Electrochemical impedance spectroscopy (EIS) testing was done in a 3.5% (by weight) NaCl solution with a saturated calomel electrode (SCE) and a graphite counter electrode. The data was collected at constant OCP and the panels were subjected to an electrolyte typically for one hour.

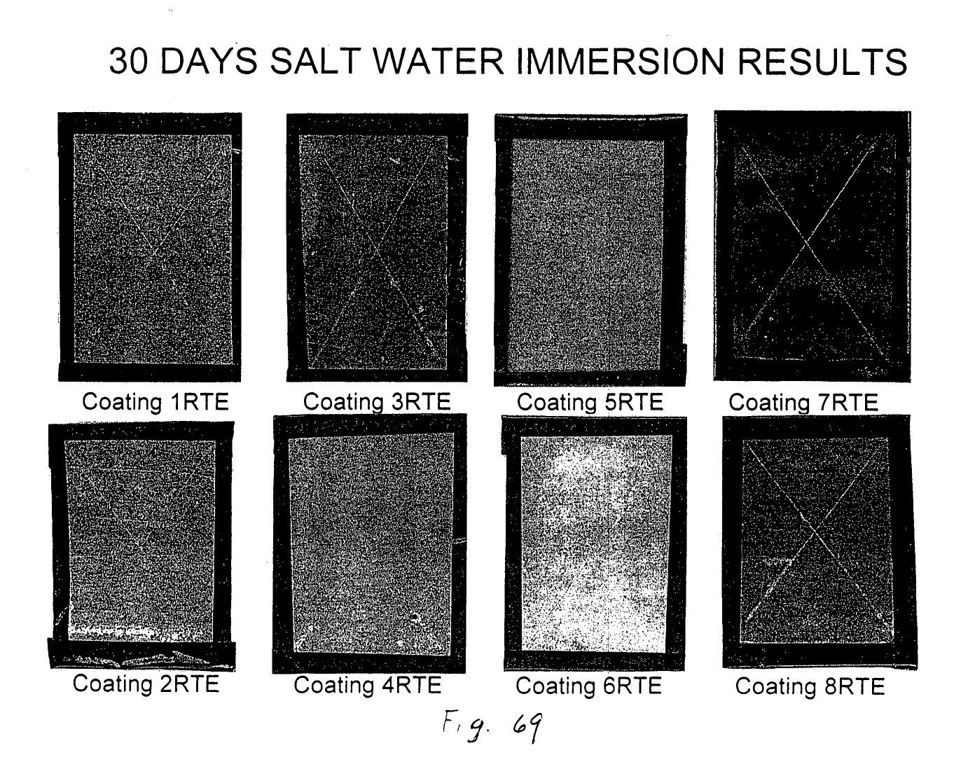

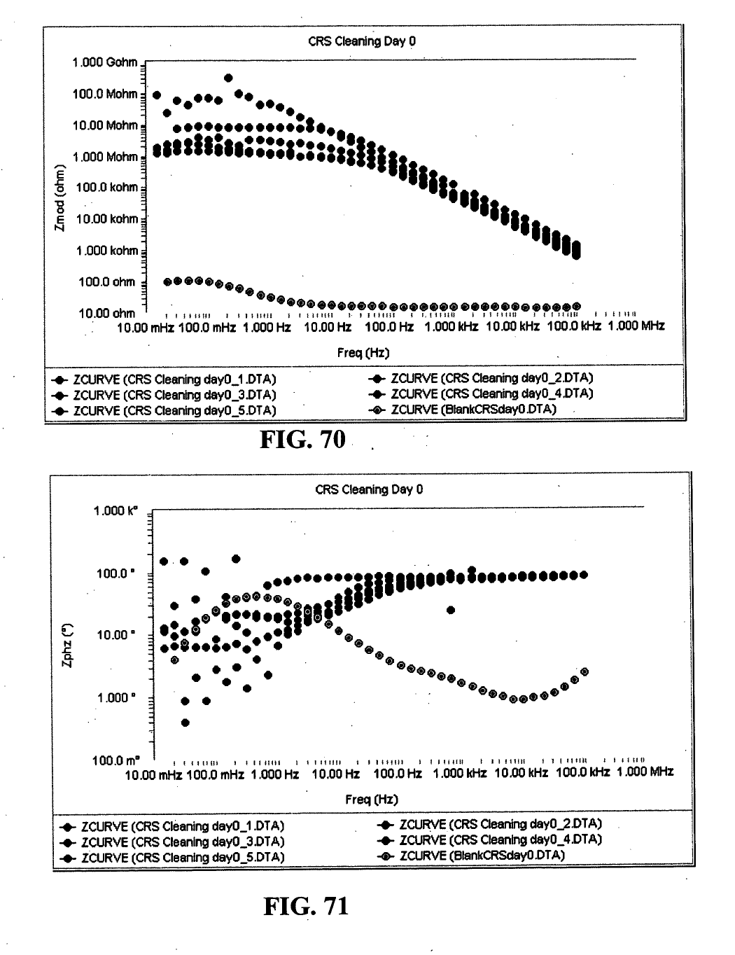

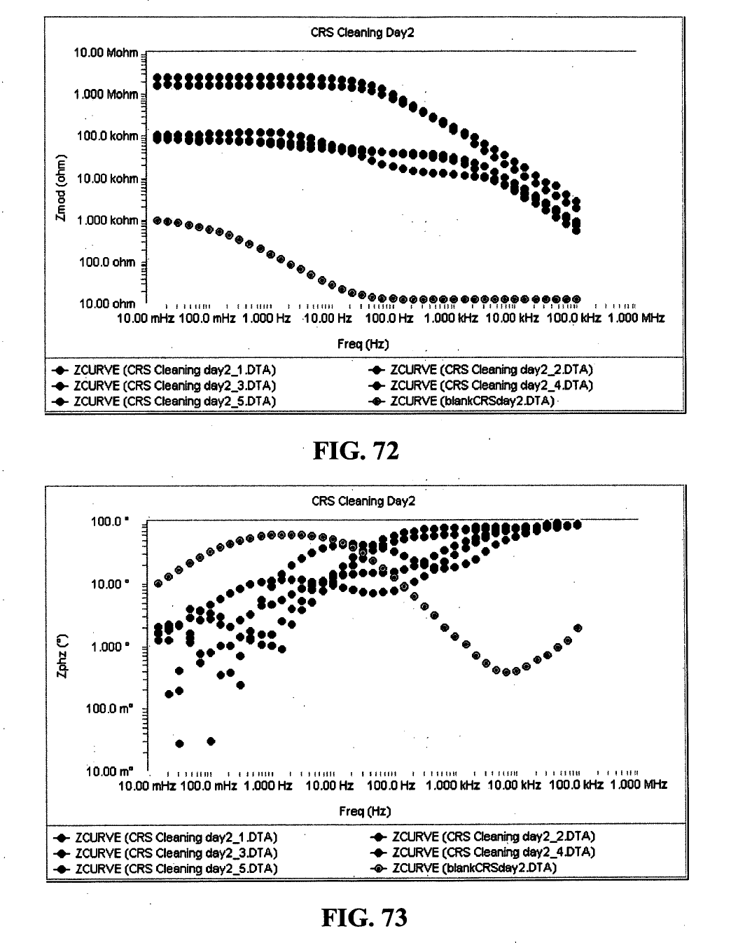

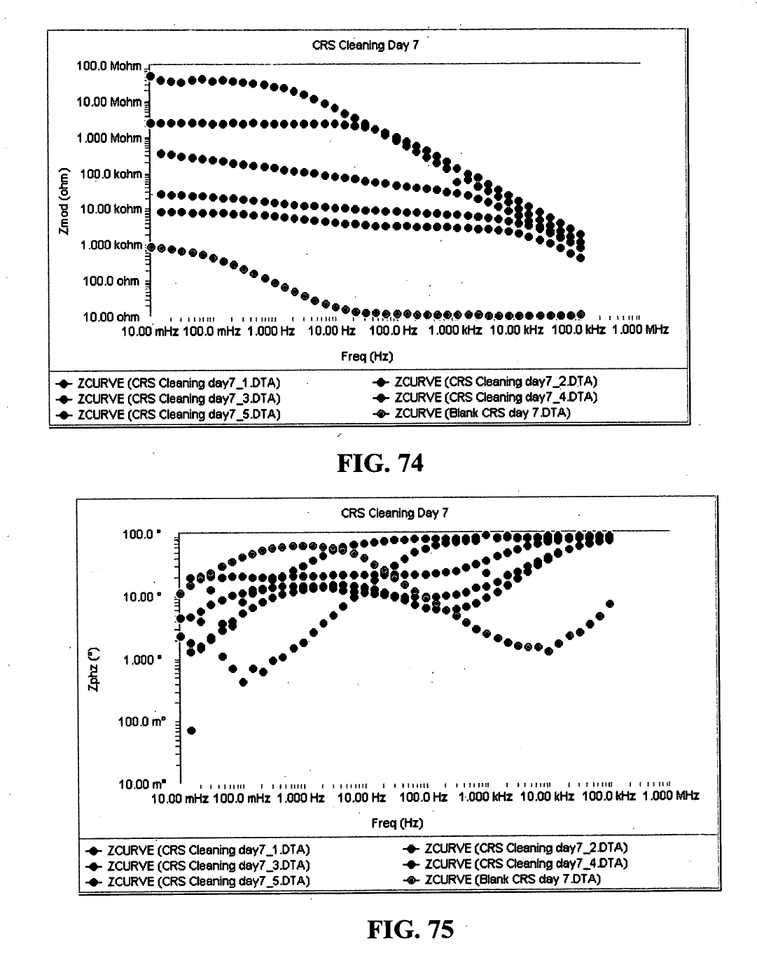

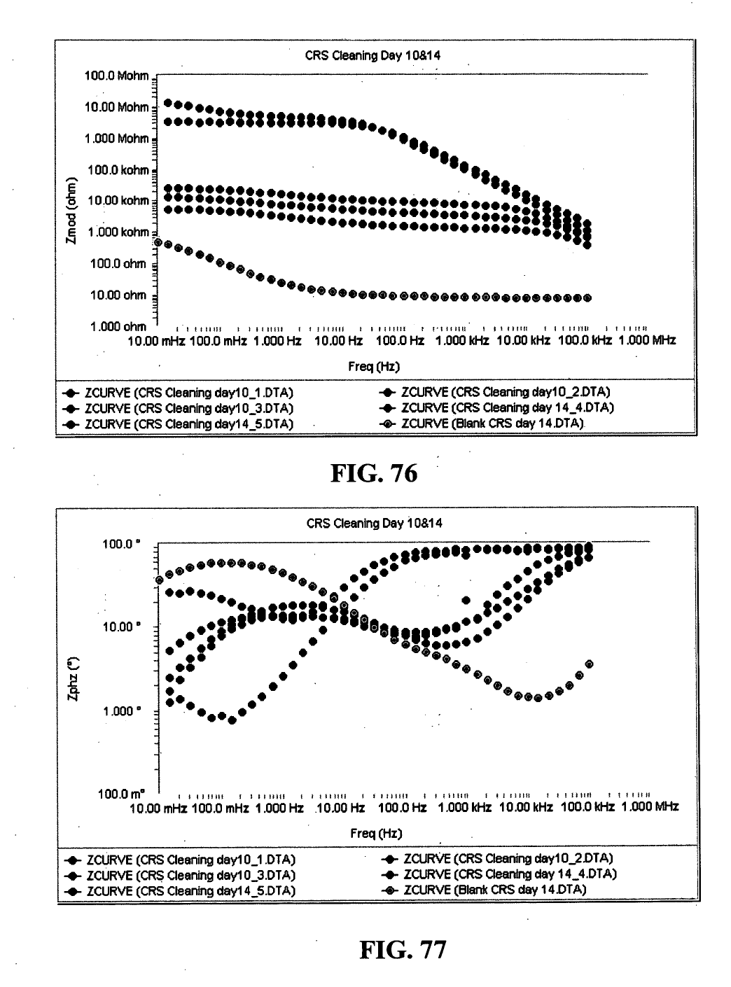

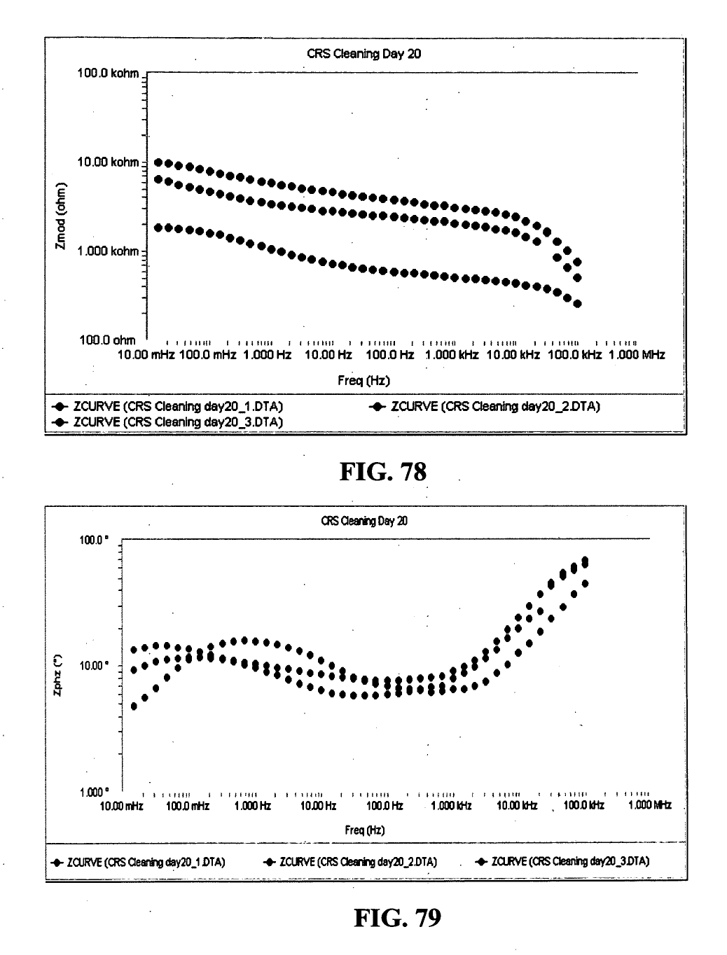

Results: FIGS. 70-79 reflect the data generated by the EIS testing. FIGS. 70 and 71 correspond to EIS testing data performed upon the panels 14 days after application of the superprimer to the first set of panels. FIGS. 72 and 73 correspond to EIS testing data performed upon the panels 16 days after application of the superprimer to the first set of panels. FIGS. 74 and 75 correspond to EIS testing data performed upon the panels 21 days after application of the superprimer to the first set of panels. FIGS. 76 and 77 correspond to EIS testing data performed upon some of the panels 24 or 28 days after application of the superprimer to the first set of panels. FIGS. 78 and 79 correspond to EIS testing data performed upon some of the panels 34 days after application of the superprimer to the first set of panels.

Discussion: It can be seen from the EIS data that there no significant difference in the spectra depending based upon the cleaning techniques utilized. More specifically, these results indicate that the performance of the superprimer may not necessarily depend upon the cleanliness of the substrate to which it is applied. It is important to note that once corrosion of a panel has started, the corrosion will dominate the EIS data and govern the spectra subsequent thereto.

### Experiment 13

All coating solutions are made by direct addition of the various components almost simultaneously and immediate high shear mixing. Those of ordinary skill will readily understand the scalability of the following experiment.

Components: (1) Silanes—Silquest® A-1289 Bis-[3-(triethoxysilyl)propyl]tetrasulfide, a bis-sulfur silane (available from General Electric,).

(2) Resin—NEOREZ R-972, a water-based polyurethane resin (available from DSM NeoResins,); and, EPI-REZ 5003-W-55, a water-based aromatic epoxy resin dispersion (available from Resolution Performance Products,).

(3) Additives—EPIKURE 6870-W-53, a curing agent (available from Hexion Specialty Chemicals,); NEOCRYL CX-100, a crosslinker (available from DSM NeoResins,).

Formulation and Preparation: The first superprimer formulation was prepared by mixing EPIREZ 5003-W-55 and EPIKURE 6870-W-53 in a 4:1 weight ratio in a high shear mixer. NEOREZ R-972 was added in the amount of 10 wt % of the total weight of the EPIREZ 5003-W-55, EPIKURE 6870-W-53, and NEOREZ R-972 formulation. Thereafter, A-1289 (bis-sulfur silane) was added in the amount of 10 wt % of the EPIREZ 5003-W-55, EPIKURE 6870-W-53, NEOREZ R-972, and bis-sulfur silane formulation to impart corrosion protection and water resistance. NEOCRYL CX-100 was added as a crosslinker in the amount of 5 wt % of the NEOREZ R-972. A second superprimer formulation was exactly the same of the first superprimer formulation, with the exception of omitting the A-1289.

Substrates and Preparation: AA 2024-T3 alloy panels were dry scrubbed to remove superficial grease and mill dust. The panels were then subjected to ultrasonic cleaning in ethanol for 8 minutes at room temperature followed by alkaline cleaning in Okemclean alkaline cleaner at 60-65° C. for 3-5 minutes. Finally the panels were thoroughly rinsed in water and forced air dried.

Application and Cure. The cleaned AA 2024-T3 panels were coated with one of the two superprimer formulations using a #14 draw-down bar. The coated panels were cured at room temperature for a period of two weeks.

Testing & Results. Salt water immersion testing was carried out on coated panels by partially immersing multiple coated panels in 3.5% by weight NaCl solution for a period of 40 days. The panels were scribed across the coated surface and taped on the bare side. The coating and the scribed surface were examined for occurrences of corrosion. Some corrosion products (white rust) were visible on the scribes, but the remainder of the coated surface was essentially free of any form of corrosion. No delamination or blistering was observed on the panels.

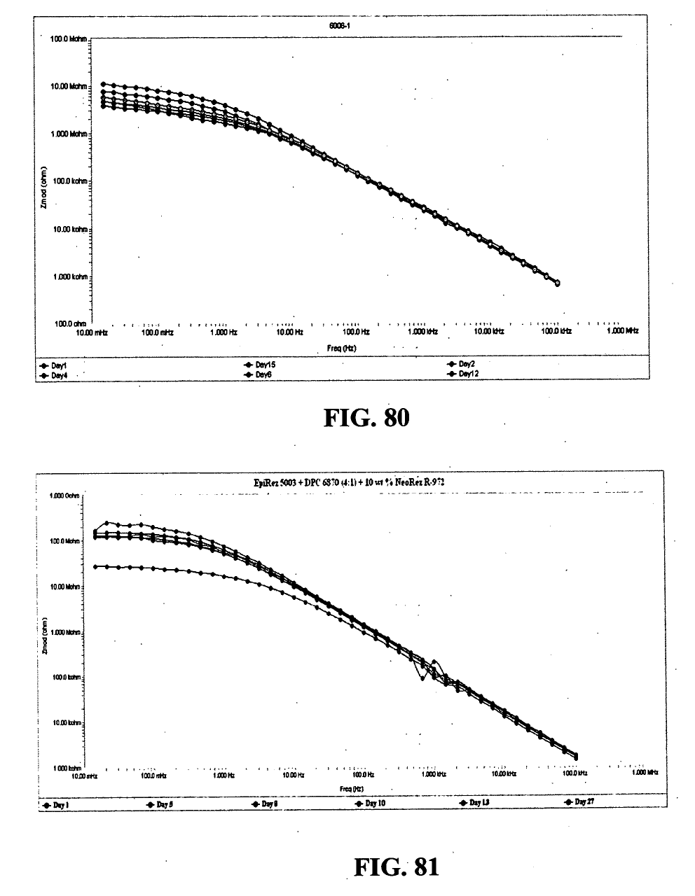

FIGS. 80 and 81 are plots of EIS data of the superprimer coating system cured at room temperature, with FIG. 80 corresponding to the first superprimer formulation, and FIG. 81 corresponding to the second superprimer formulation. EIS data were collected over a period of 27 days. The variation of the modulus at low frequency (10 mHz) is the point of interest here. The modulus of impedance of the coating at low frequency i.e. 10 mHz gives the overall resistance or impedance of the coating, which can be correlated to the overall corrosion resistance of the coating. The modulus value at higher frequencies provides information about the water intake in the coating. A gradual decreasing trend in the modulus value is observed, but even after 27 days the modulus values remain high.

The coatings were also subjected to ASTM D5402 MEK rub test. The coatings sustained more than 100 double rubs at room temperature curing.

Discussion: The coating system is low-VOC, chromate free, HAP-free water based system with excellent corrosion resistance and barrier properties for AA 2024-T3 alloy. It is highly flexible with high hardness. It does not require the use of chromate conversion coating. It is a environmentally benign coating with good adhesion, improved chemical and solvent resistance and is cured at room temperature.

### Experiment 15

All coating solutions are made by direct addition of the various components almost simultaneously and immediate high shear mixing. Those of ordinary skill will readily understand the scalability of the following experiment.

Components: (1) Silanes—AV5, 5:1 weight % ratio of a silane mixture containing VTAS (vinyltriacetoxysilane, available from Gelest,) and A 1170 (bis-trimethoxysilylpropylamine, available from General Electric,); Silquest® A-1289 Bis-[3-(triethoxysilyl) propyl]tetrasulfide, a bis-sulfur silane (available from General Electric,).

(2) Resin—EPI-REZ 5003-W-55, a water-based aromatic epoxy resin dispersion (available from Resolution Performance Products,);.

(3) Additives—EPIKURE 6870-W-53, a curing agent (available from Hexion Specialty Chemicals,).

Formulation and Preparation: The first superprimer formulation was prepared by mixing EPIREZ 5003-W-55 and EPIKURE 6870-W-53 in a 4:1 weight ratio in a high shear mixer. 5 weight % AV5 hydrolyzed solution (95 weight % water or other polar solvent) was added to the EPIREZ and EPIKURE mixture in the amount of 20 weight % of the aggregate EPIREZ 5003-W-55 and EPIKURE 6870-W-53. A second superprimer formulation was exactly the same of the first superprimer formulation, with the exception of omitting the 5% AV5.

Substrates and Preparation: AA 2024-T3 alloy panels were dry scrubbed to remove superficial grease and mill dust. The panels were then subjected to ultrasonic cleaning in ethanol for 8 minutes at room temperature followed by alkaline cleaning in Okemclean alkaline cleaner at 60-65° C. for 3-5 minutes. Finally, the panels were thoroughly rinsed in water and forced air dried.

Application and Cure: The cleaned AA 2024-T3 panels were coated with one of the two superprimer formulations using a #14 draw-down bar. The coated panels were cured at 70° C. for 1 hour.

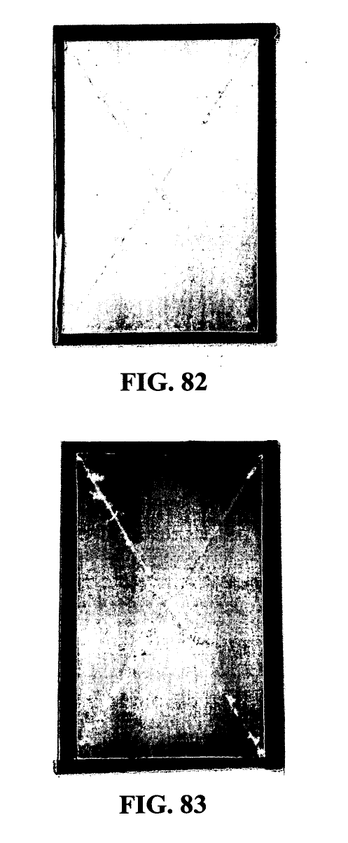

Testing & Results: Salt water immersion testing was carried out on the coated panels by partially immersing multiple coated panels in 3.5% by weight NaCl solution for a period of 60 days. FIGS. 82 and 83 are panels scribed across the coated surface and taped on the bare side, with FIG. 82 corresponding to the first superprimer formulation and FIG. 83 corresponding to the second superprimer formulation. The coating and the scribed surface were examined for occurrences of corrosion. Some corrosion products (white rust) were visible on the scribes, but the remainder of the coated surface was essentially free of any form of corrosion. No delamination or blistering was observed on the panels.

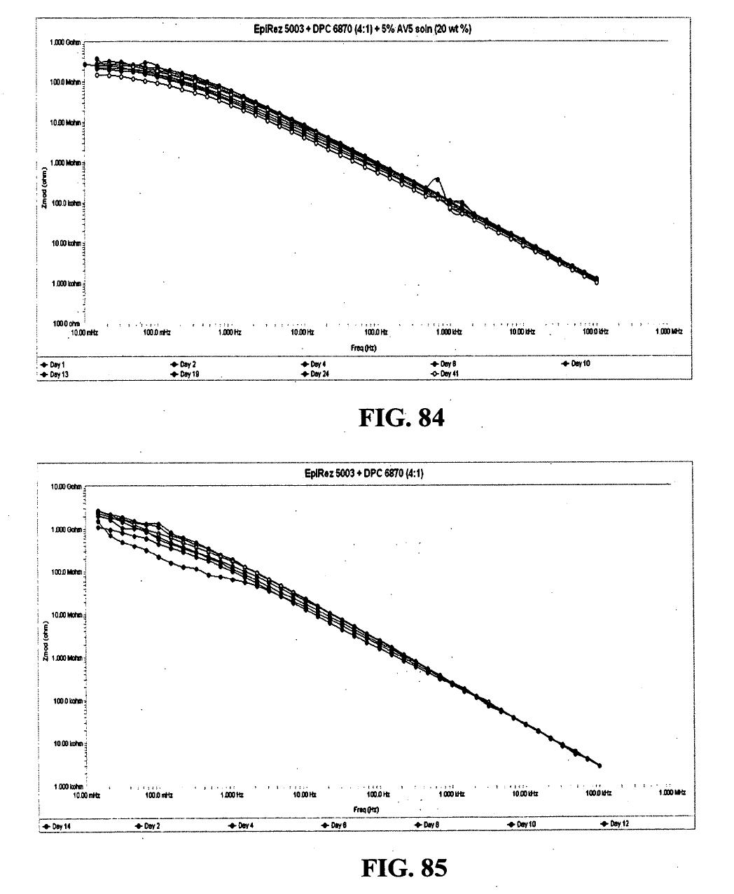

FIGS. 84 and 85 are plots of EIS data of the superprimer coating system, with FIG. 84 corresponding to the first superprimer formulation and FIG. 85 corresponding to the second superprimer formulation. EIS data were collected over a period of 41 days. The variation of the modulus at low frequency (10 mHz) is the point of interest here. The modulus of impedance of the coating at low frequency i.e. 10 mHz gives the overall resistance or impedance of the coating which can be correlated to the overall corrosion resistance of the coating. The modulus value at higher frequencies provides information regarding the water intake in the coating. A gradual decreasing trend in the modulus value is observed, but even after 41 days the modulus values remain high.

Discussion: The novel superprimer coating is a water based, low VOC, chromate free, HAP free, silane-based coating system with excellent corrosion resistance for aluminum alloys. The coatings have improved chemical resistance, solvent resistance and water resistance because of the higher crosslinking density due to high functionality of the novolac resin. It is may be better suited for high temperature applications and could be applied to various substrates such as cold rolled steel and hot dip galvanized steel.

### Experiment 16

All coating solutions are made by direct addition of the various components almost simultaneously and immediate high shear mixing. Those of ordinary skill will readily understand the scalability of the following experiment.

Components: (1) Silanes—bis-(triethoxysilypropyl)ethane, BTSE silane (available from General Electric,); bis-(triethylsilylpropyl)tetrasulfide, bis-sulfur silane (available from General Electric,).

(2) Resin—ECOCRYL 9790, a 42% by weight anionic water dispersion of acrylate copolymer in water (available from Shell Chemical LP,); EPI-REZ WD-510, a bisphenol epoxy resin (available from Resolution Performance Products,).

(3) Additives—(3) Additives—Silquest® A-Link™ 15 Silane, a crosslinking agent (available from General Electric,); Silquest® A-Link™ 25 Silane, a crosslinking agent (available from General Electric,).

Formulation and Preparation: Forty-five formulations of the Superprimer were prepared in accordance with the data listed the following five charts:

TABLE 6

| | ECOCRYL | EPI-REZ | BTSE | |
|---|---|---|---|---|
| Formulation | 9790 | WD-510 | silane | Crosslinker |
| Number | (grams) | (grams) | (grams) | (grams) |
| 1A | 3 | 1 | 1.5 | Silquest ® A- |
| | | | | Link ™ 15 Silane |
| 2A | 3 | 2 | 3 | Silquest ® A- |
| | | | | Link ™ 25 Silane |
| 3A | 3 | 3 | 4.5 | Combination of |
| | | | | 15 and 25 in a |
| | | | | 1:1 ratio |
| 4A | 5 | 1 | 3 | Combination of |
| | | | | 15 and 25 in a |
| | | | | 1:1 ratio |
| 5A | 5 | 2 | 4.5 | Silquest ® A- |
| | | | | Link ™ 15 Silane |
| 6A | 5 | 3 | 1.5 | Silquest ® A- |
| | | | | Link ™ 25 Silane |
| 7A | 7 | 1 | 4.5 | Silquest ® A- |
| | | | | Link ™ 25 Silane |
| 8A | 7 | 2 | 1.5 | Combination of |
| | | | | 15 and 25 in a |
| | | | | 1:1 ratio |
| 9A | 7 | 3 | 3 | Silquest ® A- |
| | | | | Link ™ 15 Silane |

TABLE 7

| | ECOCRYL | EPI-REZ | bis-sulfur | |
|---|---|---|---|---|
| Formulation | 9790 | WD-510 | silane | Crosslinker |
| Number | (grams) | (grams) | (grams) | (grams) |
| 1B | 3 | 1 | 1.5 | Silquest ® A- |
| | | | | Link ™ 15 Silane |
| 2B | 3 | 2 | 3 | Silquest ® A- |
| | | | | Link ™ 25 Silane |
| 3B | 3 | 3 | 4.5 | Combination of |
| | | | | 15 and 25 in a |
| | | | | 1:1 ratio |
| 4B | 5 | 1 | 3 | Combination of |
| | | | | 15 and 25 in a |
| | | | | 1:1 ratio |
| 5B | 5 | 2 | 4.5 | Silquest ® A- |
| | | | | Link ™ 15 Silane |
| 6B | 5 | 3 | 1.5 | Silquest ® A- |
| | | | | Link ™ 25 Silane |
| 7B | 7 | 1 | 4.5 | Silquest ® A- |
| | | | | Link ™ 25 Silane |
| 8B | 7 | 2 | 1.5 | Combination of |
| | | | | 15 and 25 in a |
| | | | | 1:1 ratio |
| 9B | 7 | 3 | 3 | Silquest ® A- |
| | | | | Link ™ 15 Silane |

TABLE 8

| | | | 2:1 BTSE | |
|---|---|---|---|---|
| | | | silane to | |
| | ECOCRYL | EPI-REZ | bis-sulfur | |
| Formulation | 9790 | WD-510 | silane | Crosslinker |
| Number | (grams) | (grams) | (grams) | (grams) |
| 1C | 3 | 1 | 1.5 | Silquest ® A- |
| | | | | Link ™ 15 Silane |
| 2C | 3 | 2 | 3 | Silquest ® A- |
| | | | | Link ™ 25 Silane |
| 3C | 3 | 3 | 4.5 | Combination of |
| | | | | 15 and 25 in a |
| | | | | 1:1 ratio |
| 4C | 5 | 1 | 3 | Combination of |
| | | | | 15 and 25 in a |
| | | | | 1:1 ratio |
| 5C | 5 | 2 | 4.5 | Silquest ® A- |
| | | | | Link ™ 15 Silane |
| 6C | 5 | 3 | 1.5 | Silquest ® A- |
| | | | | Link ™ 25 Silane |
| 7C | 7 | 1 | 4.5 | Silquest ® A- |
| | | | | Link ™ 25 Silane |
| 8C | 7 | 2 | 1.5 | Combination of |
| | | | | 15 and 25 in a |
| | | | | 1:1 ratio |
| 9C | 7 | 3 | 3 | Silquest ® A- |
| | | | | Link ™ 15 Silane |

TABLE 9

| | | | 1:2 BTSE | |
|---|---|---|---|---|
| | | | silane to | |
| | ECOCRYL | EPI-REZ | bis-sulfur | |
| Formulation | 9790 | WD-510 | silane | Crosslinker |
| Number | (grams) | (grams) | (grams) | (grams) |
| 1D | 3 | 1 | 1.5 | Silquest ® A- |
| | | | | Link ™ 15 Silane |
| 2D | 3 | 2 | 3 | Silquest ® A- |
| | | | | Link ™ 25 Silane |
| 3D | 3 | 3 | 4.5 | Combination of |
| | | | | 15 and 25 in a |
| | | | | 1:1 ratio |
| 4D | 5 | 1 | 3 | Combination of |
| | | | | 15 and 25 in a |
| | | | | 1:1 ratio |
| 5D | 5 | 2 | 4.5 | Silquest ® A- |
| | | | | Link ™ 15 Silane |
| 6D | 5 | 3 | 1.5 | Silquest ® A- |
| | | | | Link ™ 25 Silane |
| 7D | 7 | 1 | 4.5 | Silquest ® A- |
| | | | | Link ™ 25 Silane |
| 8D | 7 | 2 | 1.5 | Combination of |
| | | | | 15 and 25 in a |
| | | | | 1:1 ratio |
| 9D | 7 | 3 | 3 | Silquest ® A- |
| | | | | Link ™ 15 Silane |

TABLE 10

| | | | 1:1 BTSE | |
|---|---|---|---|---|
| | | | silane to | |
| | ECOCRYL | EPI-REZ | bis-sulfur | |
| Formulation | 9790 | WD-510 | silane | Crosslinker |
| Number | (grams) | (grams) | (grams) | (grams) |
| 1E | 3 | 1 | 1.5 | Silquest ® A- |
| | | | | Link ™ 15 Silane |
| 2E | 3 | 2 | 3 | Silquest ® A- |
| | | | | Link ™ 25 Silane |
| 3E | 3 | 3 | 4.5 | Combination of |
| | | | | 15 and 25 in a |
| | | | | 1:1 ratio |
| 4E | 5 | 1 | 3 | Combination of |
| | | | | 15 and 25 in a |
| | | | | 1:1 ratio |
| 5E | 5 | 2 | 4.5 | Silquest ® A- |
| | | | | Link ™ 15 Silane |
| 6E | 5 | 3 | 1.5 | Silquest ® A- |
| | | | | Link ™ 25 Silane |
| 7E | 7 | 1 | 4.5 | Silquest ® A- |
| | | | | Link ™ 25 Silane |
| 8E | 7 | 2 | 1.5 | Combination of |
| | | | | 15 and 25 in a |
| | | | | 1:1 ratio |
| 9E | 7 | 3 | 3 | Silquest ® A- |
| | | | | Link ™ 15 Silane |

The resins and silanes from the charts were mixed together with deionized water, where the deionized water comprised 33% by weight of the mixture of the resins. To this mixture of resins, water, and silanes are added the crosslinkers comprising 2.5% by weight of the resins, water, and silanes mixture. The final mixture was mixed using a high shear blender at 3000 rpm for 3 minutes.

Substrates and Preparation: AA 2024-T3 alloy panels were dry scrubbed to remove superficial grease and mill dust. The panels were then subjected to ultrasonic cleaning in ethanol for 8 minutes at room temperature followed by alkaline cleaning in Okemclean alkaline cleaner at 60-65° C. for 3-5 minutes. Finally the panels were thoroughly rinsed in water and forced air dried.

Application and Cure: Two sets of cleaned AA 2024-T3 panels were coated with the superprimer formulations using a #28 draw-down bar. The coated panels were cured at ambient conditions for 14 days. The second set of panels was coated with a PRC DeSoto Desothane HS obtained from Wright Patterson Air Force Base in Dayton, Ohio.

Testing & Results: Electrochemical Impedance Spectroscopy (EIS) was used to evaluate the corrosion behavior of the coating systems on AA 2024-T3 panels in a 3.5% by weight NaCl solution. The EIS measurements were conducted using an SR 810 frequency response analyzer connected to a Gamry CMS 100 potentiostat. The measured range of frequency was from 10⁵ to 10⁻² Hz, with an alternating circuit (AC) voltage amplitude of ±10 mV. A commercial Saturated Calomel Electrode (SCE) was used as the reference electrode coupled with a graphite counter electrode. The surface area exposed to the electrolyte was 5.16 cm² during the measurements. Ten times the logarithm of the value of modulus of impedance at 10⁻² Hz on the day 30 was used for determining the efficacy with which a coating protects the metal substrate against corrosion. The higher the modulus the better is the resistance to corrosion (8). These results for the superprimer formulations are shown in Tables I through V in Column A.

Superprimer-coated, and superprimer-coated with topcoat, panels were scribed and immersed in the a 3.5% by weight NaCl aqueous solution for 30 days. The scribe simulates a damaged area in the coating. For a formulation, both topcoated and just primer-coated panels were visually examined and rated on a scale of 50. The values were then added on the basis of the extent of corrosion in the scribe, evidence and extent of blistering Evaluation was made on the basis of delamination, and presence and extent of pit formation. A higher score meant a better capability of a coating to prevent corrosion of the substrate and scribe overall. These results for the superprimer formulations are shown in Tables I through V in Column B.

The static deionized (DI) water contact angle was measured before and after exposure to 3.5 wt-% NaCl aqueous solution for 30 days. A drop of DI water was dropped on the coated samples and the contact angle was measured. The contact angle is a measure of the hydrophobicity of the coating. A hydrophobic coating results in a higher contact angle, which implies that it can more efficiently keep the water and electrolyte from permeating to the metal-primer interface. This in turn results in a better corrosion resistance. As such the percentage change due to 30 days of exposure to electrolyte was recorded for each of the coatings. These results for the superprimer formulations are shown in Tables I through V in Column C.

The superprimer-coated, and superprimer-coated with topcoat, panels were scribed using a tungsten carbide scribing tool. These samples were then immersed in DI water for 24 hours and left to dry in ambient room temperature conditions for 4 hours. The tape adhesion test was carried out on these specimens in accordance with the ASTM D 3359 standards. The extent of delamination was graded on a scale of 100 and used a response to the variations of the parameters at the set 3 levels. These results for the superprimer formulations are shown in Tables I through V in Column D.

The MEK double rub test was conducted by rubbing a primer-coated sample with cheesecloth dipped in methyl ethyl ketone in accordance with the ASTM D 4572 standards. The MEK double rub number gives an indication of the extent of cure of a coating and is also an indication of the extent of crosslink density in the coating. These results for the superprimer formulations are shown in Tables I through V in Column E.

The chemical resistance test was performed on all the primer-coated panels. The chemical resistance to 6N HCl and 6N NaOH was examined by putting a drop of each of the solutions on the panels and examining the area of the coating exposed to the chemical after 24 hours. The panels were rated on a scale of 50 with a high score for better resistance to each of the basic and acidic environments. The sum of the two was the overall score for that particular formulation/coating. The results for the superprimer formulations are shown in Tables I through V in Column F.

TABLE I
Results for various corrosion performance evaluation
tests conducted on the formulations of Table 6

| Sample | Column | Column | Column | Column | Column | Column |
|---|---|---|---|---|---|---|
| Number | A | B | C | D | E | F |
| 1A | 77.78 | 83.75 | 13.55 | 70 | 96 | 100 |
| 2A | 76.02 | 88.75 | 14.25 | 100 | 25 | 100 |
| 3A | 50.00 | 83.75 | 22.06 | 100 | 20 | 50 |
| 4A | 69.54 | 83.75 | 10.56 | 50 | 10 | 25 |
| 5A | 63.01 | 67.50 | 37.96 | 60 | 37 | 100 |
| 6A | 76.99 | 82.50 | 37.59 | 97 | 34 | 100 |
| 7A | 60.00 | 73.75 | 47.50 | 85 | 40 | 100 |
| 8A | 83.01 | 86.25 | 19.32 | 90 | 67 | 100 |
| 9A | 84.77 | 81.25 | 23.55 | 95 | 89 | 100 |

TABLE II
Results for various corrosion performance evaluation
tests conducted on the formulations of Table 7

| Sample | Column | Column | Column | Column | Column | Column |
|---|---|---|---|---|---|---|
| Number | A | B | C | D | E | F |
| 1B | 68.45 | 88.75 | 9.30 | 100 | 13 | 75 |
| 2B | 63.01 | 89.38 | 14.66 | 87 | 23 | 100 |
| 3B | 45.44 | 80.63 | −10.49 | 80 | 10 | 75 |
| 4B | 74.77 | 91.88 | 8.57 | 60 | 63 | 50 |
| 5B | 86.02 | 92.50 | 10.62 | 70 | 44 | 100 |
| 6B | 89.03 | 92.50 | 11.75 | 100 | 197 | 100 |
| 7B | 96.02 | 93.13 | 10.50 | 97 | 72 | 100 |
| 8B | 83.01 | 86.25 | 10.19 | 98 | 119 | 100 |
| 9B | 73.01 | 80.63 | 13.52 | 95 | 195 | 100 |

TABLE III
Results for various corrosion performance evaluation
tests conducted on the formulations of Table 8

| Sample | Column | Column | Column | Column | Column | Column |
|---|---|---|---|---|---|---|
| Number | A | B | C | D | E | F |
| 1C | 73.62 | 77.50 | 12.75 | 55 | 34 | 100 |
| 2C | 40.00 | 58.75 | −1.40 | 60 | 17 | 0 |
| 3C | 40.00 | 61.88 | −1.53 | 100 | 7 | 0 |
| 4C | 38.54 | 68.13 | 9.51 | 60 | 184 | 0 |
| 5C | 39.54 | 56.25 | 17.63 | 70 | 23 | 0 |
| 6C | 66.02 | 83.13 | 22.30 | 95 | 70 | 100 |
| 7C | 26.99 | 48.75 | 56.38 | 80 | 57 | 0 |
| 8C | 31.76 | 68.75 | 33.70 | 97 | 58 | 100 |
| 9C | 93.01 | 82.50 | 14.87 | 98 | 43 | 100 |

TABLE IV
Results for various corrosion performance evaluation
tests conducted on the formulations of Table 9

| Sample | Column | Column | Column | Column | Column | Column |
|---|---|---|---|---|---|---|
| Number | A | B | C | D | E | F |
| 1D | 48.13 | 71.25 | 8.29 | 80 | 97 | 100 |
| 2D | 57.78 | 81.88 | 5.67 | 60 | 19 | 75 |
| 3D | 54.77 | 81.25 | 32.40 | 90 | 5 | 0 |
| 4D | 73.01 | 86.25 | 2.96 | 50 | 181 | 25 |
| 5D | 60.00 | 88.13 | 10.23 | 60 | 23 | 0 |
| 6D | 56.53 | 88.75 | 18.73 | 100 | 69 | 100 |
| 7D | 28.45 | 81.88 | 60.73 | 80 | 46 | 0 |
| 8D | 53.98 | 81.25 | 11.52 | 80 | 52 | 100 |
| 9D | 49.03 | 80.00 | 4.35 | 40 | 76 | 75 |

TABLE V
Results for various corrosion performance evaluation
tests conducted on the formulations of Table 10

| Sample | Column | Column | Column | Column | Column | Column |
|---|---|---|---|---|---|---|
| Number | A | B | C | D | E | F |
| 1E | 84.77 | 76.25 | 11.10 | 50 | 73 | 100 |
| 2E | 80.00 | 73.75 | 17.63 | 70 | 72 | 75 |
| 3E | 44.47 | 78.75 | 8.76 | 100 | 9 | 75 |
| 4E | 48.45 | 83.13 | 2.88 | 60 | 73 | 50 |
| 5E | 43.98 | 79.38 | 6.85 | 40 | 14 | 100 |
| 6E | 89.54 | 82.50 | 23.10 | 100 | 44 | 100 |
| 7E | 31.76 | 56.25 | 55.44 | 80 | 53 | 0 |
| 8E | 47.78 | 78.75 | 14.95 | 90 | 82 | 100 |
| 9E | 36.02 | 81.88 | 14.07 | 90 | 159 | 100 |

Discussion: The orthogonal arrays are designed so that each parameter when fixed at a given level interactions with the other parameters at all the other 3 levels It is clear from the Tables I-V that for any parameter there is no one level where all the properties being optimized are the best. As such, trade offs are resorted to and the optimized systems are chosen where most of the properties are at the best response. Table VI, listed below, includes the subjective determinations drawn on which formulation for each Table was optimized.

TABLE VI
Optimization of the Superprimer Formulations of Tables 6-10

| | Table | Table | Table | Table | Table |
|---|---|---|---|---|---|
| Parameter | 6 | 7 | 8 | 9 | 10 |
| ECOCRYL | 7.0 g | 7.0 g | 7.0 g | 5.0 g | 5.0 g |
| 9790 | | | | | |
| EPI REZ | 3.0 g | 3.0 g | 3.0 g | 2.0 g | 3.0 g |
| WD 510 | | | | | |
| Silane | 1.5 g | 1.5 g | 1.5 g | 1.5 g | 1.5 g |
| Cross- | A-Link | A-Link | A-Link | A-Link | A-Link |
| linker | 15 | 25 | 15 | 25 | 15 |

### Experiment 17

Components: (1) Silanes—bis-(triethoxysilypropyl)ethane, BTSE silane (available from General Electric,); bis-(triethylsilylpropyl)tetrasulfide, bis-sulfur silane (available from General Electric,).

(2) Resin—ECOCRYL 9790, a 42% by weight anionic water dispersion of acrylate copolymer in water (available from Shell Chemical LP,); EPI-REZ WD-510, a bisphenol epoxy resin (available from Resolution Performance Products,).

(3) Additives—(3) Additives—Silquest® A-Link™ 25 Silane, a crosslinking agent (available from General Electric,).

Formulation and Preparation: The Superprimer was prepared by mixing 3 grams of EPI-REZ WD-510, 7 grams of ECOCRYL 9790, 3 grams of BTSE silane, and 0.25 grams of A-Link 25. To this resulting mixture was added 4 grams of deionized water and mixed in a high shear blender at 3500 rpm for 5 minutes.

Substrates and Preparation: Multiple polyethylene terephthalate substrates were cleaned by using alcohol swabs to free the substrate of any grease or dust particles.

Application and Cure: Two sets of polyethylene terephthalate substrates were coated with the superprimer formulation by paint brush. Alternately dipping, or spraying could also be used. Two curing temperatures of 55° C. and 80° C. were used to cure respective sets of the coated samples. The samples were cured at their respective temperature for 3 hours. A third set of polyethylene terephthalate substrates were uncoated and not exposed to any elevated temperature.

Testing & Results: The samples were mounted on top of beakers containing DI water and were sealed with silicone grease as shown in the following representation.

[image]

The entire assembly of the beaker with the sample on top of it was weighed at time, t=0 minutes. This was then put inside an oven at 70° C. and at periodic intervals the entire assembly was weighed and the changes in weight were recorded. The elevated temperature caused the water to evaporate and since the only outlet was through the opening of the beaker, which was covered and sealed off, the loss of weight in the system could take place only through the diffusion of the evaporated water through the plastic. This arrangement enabled a comparison between “Superprimer” coated panels to determine the extent to which the permeability of the plastic had been changed.

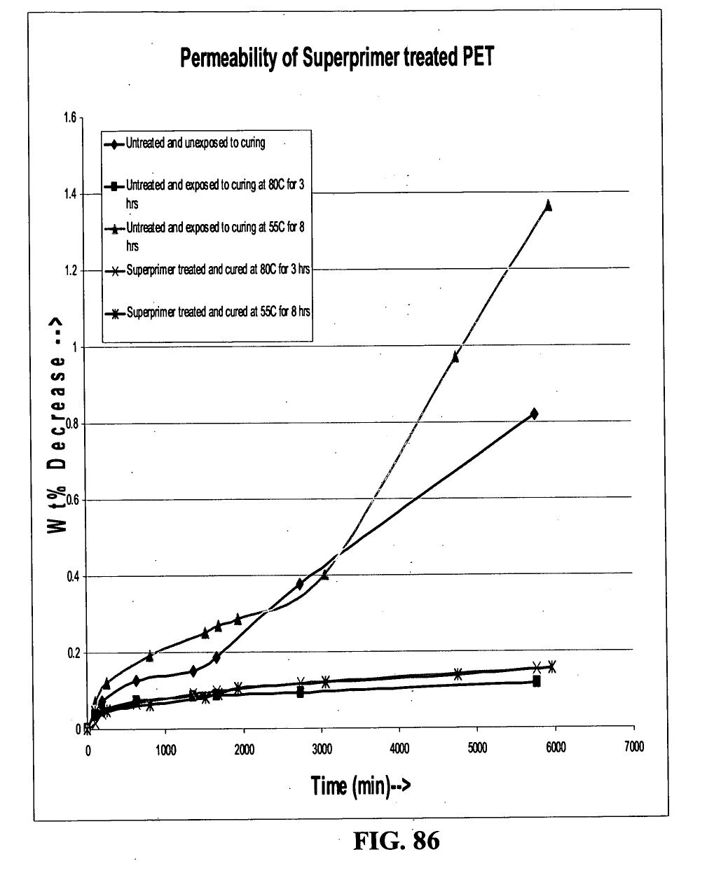

The results of the study as a function of time have been shown in Tables 11-14 and in FIG. 86.

TABLE 11
The weight (grams) recorded at time intervals for the samples described

| Description of | Time (minutes) | | | | | | | |
|---|---|---|---|---|---|---|---|---|
| Sample | 0 | 105 | 195 | 630 | 1350 | 1650 | 2730 | 5760 |
| Untreated unexposed | 172.093 | 171.999 | 171.970 | 171.878 | 171.834 | 171.776 | 171.445 | 170.686 |
| to curing heat | | | | | | | | |
| Untreated exposed | 164.687 | 164.625 | 164.608 | 164.567 | 164.547 | 164.543 | 164.533 | 164.493 |
| to curing heat at | | | | | | | | |
| 80° C. | | | | | | | | |
| Superprimer treated | 174.025 | 174.002 | 173.951 | 173.909 | 173.867 | 173.861 | 173.824 | 173.760 |
| sample cured at | | | | | | | | |
| 80° C. | | | | | | | | |

TABLE 12
The weight (grams) recorded at time intervals for the samples described

| Description of | Time (minutes) | | | | | | | |
|---|---|---|---|---|---|---|---|---|
| Sample | 0 | 105 | 255 | 810 | 1515 | 1680 | 1935 | 3060 |
| Untreated unexposed | 177.975 | 177.853 | 177.761 | 177.637 | 177.530 | 177.494 | 177.463 | 177.259 |
| to curing heat at | | | | | | | | |
| 55° C. | | | | | | | | |
| Superprimer treated | 166.655 | 166.580 | 166.574 | 166.549 | 166.522 | 166.507 | 166.481 | 166.456 |
| sample cured at | | | | | | | | |
| 55° C. | | | | | | | | |

TABLE 13
Weight % Decrease calculated from data in Table 1.

| Description of | Time (minutes) | | | | | | | |
|---|---|---|---|---|---|---|---|---|
| Sample | 0 | 105 | 195 | 630 | 1350 | 1650 | 2730 | 5760 |
| Untreated unexposed | 0 | 0.054563 | 0.071647 | 0.125106 | 0.150616 | 0.184086 | 0.376714 | 0.817462 |
| to curing heat | | | | | | | | |
| Untreated exposed | 0 | 0.037283 | 0.047788 | 0.072623 | 0.084767 | 0.087317 | 0.093086 | 0.11786 |
| to curing heat at | | | | | | | | |
| 80° C. | | | | | | | | |
| Superprimer treated | 0 | 0.013676 | 0.042465 | 0.067059 | 0.090791 | 0.094641 | 0.1155 | 0.152736 |
| sample cured at | | | | | | | | |
| 80° C. | | | | | | | | |

TABLE 14
Weight % Decrease calculated from data in Table 2.

| Description of | Time (minutes) | | | | | | | |
|---|---|---|---|---|---|---|---|---|
| Sample | 0 | 105 | 255 | 810 | 1515 | 1680 | 1935 | 3060 |
| Untreated unexposed | 0 | 0.068436 | 0.11996 | 0.190139 | 0.249866 | 0.270037 | 0.287399 | 0.402528 |
| to curing heat at | | | | | | | | |
| 55° C. | | | | | | | | |
| Superprimer treated | 0 | 0.045003 | 0.048123 | 0.063604 | 0.079506 | 0.088386 | 0.104107 | 0.118928 |
| sample cured at | | | | | | | | |
| 55° C. | | | | | | | | |

Discussion: As can be seen from Tables 11-14, the coated samples result in lesser weight loss as compared with the uncoated ones, thereby suggesting that is it possible to form a “superprimer” coating on plastics which can reduce the permeability of water. It has been demonstrated that it possible to coat the superprimer on PET. Similarly, other plastics can also be coated with a superprimer to decrease water and water vapor permeability. The samples in this experiment were coated could be bent and rolled with ease and that did not result in the cracking of the superprimer coating. This demonstrates the flexibility of the coated plastics and shows that the original flexibility of the PET substrate is not lost by application of the superprimer coating of the plastic. The adhesion obtained on the PET substrates was excellent and no delamination or peeling was observed.

The superprimer coating has application in the bottling industry where the diffusion of gases through the bottle medium needs to be prevented for preservation of the food and beverages. This coating could also be used for coating of bathroom appliances and other plastic ware to make it extremely hydrophobic.

### Experiment 18

Components: (1) Silane—bis-(triethylsilylpropyl)tetrasulfide, bis-sulfur silane (available from GE Silicones, www.gesilicones.com).

(2) Resin—ECOCRYL 9790, a 42% by weight anionic water dispersion of acrylate copolymer in water (available from Shell Chemical LP,); EPI-REZ WD-510, a bisphenol epoxy resin (available from Resolution Performance Products,).

(3) Additives—acetone (available from Fisher Scientific, www1.fishersci.com); and, 30% by volume aqueous hydrogen peroxide (available from Fisher Scientific, www1.fishersci.com).

Formulation and Preparation: The Superprimer was prepared by mixing 3 grams of EPI-REZ WD-510, 7 grams of ECOCRYL 9790, and 1.5 grams of bis-sulfur silane. To this mixture was added 4 grams of acetone and 1.5 grams of hydrogen peroxide. This resulting mixture was mixed in a high shear blender at 2500 rpm for 3-5 minutes.

Substrates and Preparation: Multiple polypropylene substrates were cleaned by first scrubbing the surface of with a Scotch-Brite dipped in ethanol, followed by 15 minutes of ultrasonic cleaning in ethanol, followed by rinsing the substrates in water. These steps were followed by thorough wipes with Kim-wipes dipped in acetone.

Application and Cure: Multiple polypropylene substrates were coated with the superprimer formulation using a #28 drawdown bar while the acetone film from wiping with Kim-swipes had not dried up and was still visible. The coated sample was cured at 110° C. for 2 hours.

Testing & Results: ASTM D3359 tape adhesion tests were conducted on the polypropylene samples for evaluating the adhesion at the polypropylene-superprimer interface. Two crosshatch marks comprising of two sets of 6 parallel lines perpendicular to each other were made using a tungsten carbide tipped scribing tool into each polypropylene substrate. This resulted in two sets of twenty-five tiny squares cut into the superprimer coating. The tape adhesion was conducted on the crosshatch marks immediately after the two hours cure and after 24 hours. The area that was tested immediately after the cure had seven out of the twenty five square patches of coating peel off completely and one peeled off half way during the test. This translates to a 70% adhesion and 30% delamination of the coating. However, when the sample was left to cool and the test was repeated on the second crosshatch mark after twenty-four hours, only one of the twenty-five patches peeled off. This translates to a 96% adhesion value and a 4% delamination, which classifies as a 5A-5B as per the evaluation standards laid out in the ASTM D 3359 testing.

Discussion: It can be seen from the results of this experiment that it is possible to coat a plastic surface like polypropylene with a superprimer. In the case of polypropylene, the superprimer coatings could also be loaded with additives like pigments, fillers like carbon black, talc, colorant, etc. These additives would provide mechanical properties like hardness and impact resistance that is critical for such an application. The amount of peroxide and other components used for cure is important for a good coating formulation in such an application.

### Experiment 19

Components: (1) Silane—1,4-bis(trimethoxysilylethyl)benzene SIB 1831, bis-benzene silane (available from Gelest, Inc., www.gelest.com).

(2) Resin—DPW-6520, a dispersion of solid bisphenol A epoxy resin with a non-HAPS (available from Resolution Performance Products,); EPI-REZ WD-510, a bisphenol epoxy resin (available from Resolution Performance Products,).

(3) Additives—DPC-6870, curing agent comprising an aqueous dispersion of an amine adduct curing agent (available from available from Resolution Performance Products,).

Formulation and Preparation: Two Superprimer formulations were prepared in the instant experiment. The first superprimer formulation comprised 80 grams of DPW-6520 added to 20 grams of DPC-6870. The second superprimer formulation comprised 80 grams of DPW-6520 added to 20 grams of DPC-6870 and to 20 grams of bis-benzene silane. After the respective components of each superprimer formulation had been added, the resulting mixture was mixed until the mixture became essentially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure: Each of the two superprimer formulations were applied to one of the two sets of steel substrates using a #28 draw down bar. Each set of steel substrates was broken down into three groups based upon the three differing curing processes. The first curing process included curing the superprimer formulations at 60° C. for 1 hour, followed by 150° C. for 1 hour. A second curing process included curing the superprimer formulations at ambient conditions for 14 days, while a third curing process included curing the superprimer formulations at ambient conditions for 14 days, followed by curing at 150° C. for 10 minutes.

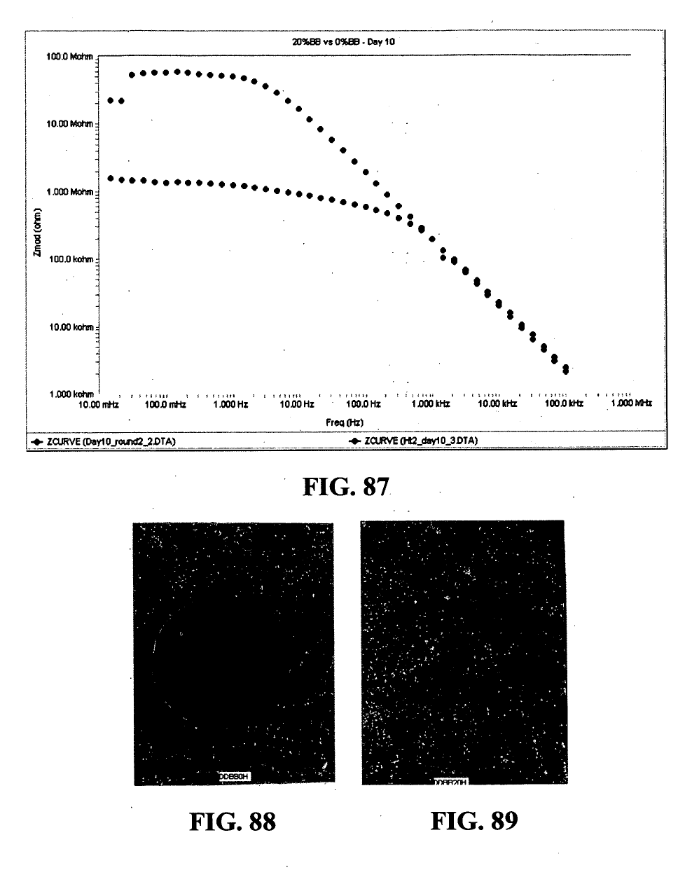

Testing & Results: Electrochemical Impedance Spectroscopy (EIS) was used to evaluate the corrosion behavior of the coating systems on two groups of steel substrates immersed in a 3.5% by weight NaCl solution for 10 days. FIG. 87 is a plot of EIS data for the two groups of steel substrates, each having one of the two superprimer formulations applied thereto, being cured at 60° C. for 1 hour. FIGS. 88 and 89 are photographs of steel substrates under the O ring—after 35 days, with FIG. 88 corresponding to the first superprimer formulation, while FIG. 89 corresponds to the second superprimer formulation.

EIS measurements were carried out on HDG steel substrates coated with one of the two superprimer formulations discussed above. An area of 5.06 cm² of the coated substrates was exposed to a corrosive 0.6 M NaCl electrolyte. An SR810 frequency response analyzer connected to a Gamry CMS100 potentiostat was used for this purpose. Measurements were made at frequencies ranging between 10-2 to 105 Hz, with an AC excitation amplitude of 10 mV. A standard calomel electrode was used as the reference electrode with a graphite rod acting as the counter electrode.

An (methyl ethyl ketone) MEK double rub test, in most cases, is an excellent way of determining the extent of curing and drying of most of the coatings. This test involves repetitive rubbing of a coating using cheese cloth dipped in MEK till the coating material is removed from the coating surface. It was carried out on cured steel substrates according to ASTM D4752-03 standards. This test is particularly beneficial for room temperature cured coatings. This test was used for performance evaluation as well as for characterization studies.

Pencil hardness tests were also conducted on the substrates and provides a simple and quick way of detecting roughly, the extent of cure and drying of a film. Cured films of the two formulations were allowed sufficient curing time (in this study, it was 14 days for room temperature cured coatings) and the test was carried out in accordance with the ASTM-D 3363-00 standard. This test involves scratching a coating using pencils of increasing hardness. The coating's hardness is indicated by the first pencil which can scratch it. This test too is particularly beneficial for room temperature cured coatings.

Contact angle measurements were also performed on the steel substrates for the two formulation using a contact angle goniometer VCA2000 manufactured by AST Products, Inc Billerica, Mass. The basic elements of a goniometer include a light source, sample stage, lens and image capture. Contact angle can be assessed directly by measuring the angle formed between the solid and the tangent to the drop surface. A water drop of controlled volume was dispensed on the coated panels with a syringe. Contact angle measurements were obtained from the software given by the manufacturer. In general, the greater the contact angle, the greater the barrier (lower wettability) against water penetration and corrosion. A contact angle of greater than or equal to 90° is an indication of total hydrophobicity.

### MEK Double Rub and Hardness Tests

| | MEK | | Pencil Hardness | |
|---|---|---|---|---|
| Formulation | Cure II | CureIII | Cure II | CureIII |
| First Superprimer Formulation | 7 | 400 | 2H | 4H |
| Second Superprimer Formulation | 16 | 1000 | 5H | 5H |

### Contact Angle Test

### First Superprimer Formulation (Curing Process #3): 65°

### Second Superprimer Formulation (Curing Process #3): 80°

Discussion: The incorporation of bis-benzene silanes in epoxy primers leads to increased barrier property (increased low frequency impedance in EIS), increased curing and solvent resistance (MEK double rub test and hardness testing) and increased hydrophobicity (increased contact angle).

### Experiment 20

Components: (1) Silane—bis-(triethoxysilypropyl)ethane, BTSE silane (available from GE Silicones as Silquest Y 9805);

(2) Resin—DPW-6520, a dispersion of solid bisphenol A epoxy resin with a non-HAPS (available from Resolution Performance Products,).

(3) Additives—DPC-6870, curing agent comprising an aqueous dispersion of an amine adduct curing agent (available from available from Resolution Performance Products,); Phosguard J0806, a micronized zinc phosphate/molybdate corrosion inhibitor (available from Rockwood Pigments,); Tronox RF-K-2, a micronized rutile pigment coated with aluminum compound to improve hydrophobicity (available from Kerr McGee Pigments,); and, Alsibronz 06, an ultra-fine sized, chemically inert potassium silicate platelets (available from Engelhard Corporation, Iselin, N.J., USA).

Formulation and Preparation: Two Superprimer formulations were prepared in the instant experiment. The first superprimer formulation comprised 80 grams of DPW-6520 added to 15 grams of deionized water, added to 10 grams of Phosguard, added to 2.5 grams of Tronox, added to 2.5 grams of Alsibronz, added to 20 grams of DPC-6870. The second superprimer formulation comprised 80 grams of DPW-6520 added to 20 grams of at least partially hydrolyzed BTSE silane, added to 10 grams of Phosguard, added to 2.5 grams of Tronox, added to 2.5 grams of Alsibronz, added to 20 grams of DPC-6870. The BTSE silane was prepared using a 1:1 volume mixture of water and neat BTSE for three hours at 300 rpm. After the respective components of each superprimer formulation had been added, the resulting mixture was mixed until the mixture became essentially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure. Each of the two superprimer formulations were applied to one of the two sets of steel substrates using a #28 draw down bar. A third set of steel substrates was coated with a commercially available non-chromated alkyd primer, Devguard, obtained from ICI Devoe coatings Cleveland, Ohio, using a #28 draw down bar. All of the steel substrates were cured at ambient conditions for 14 days subsequent to application of one of the primer formulations.

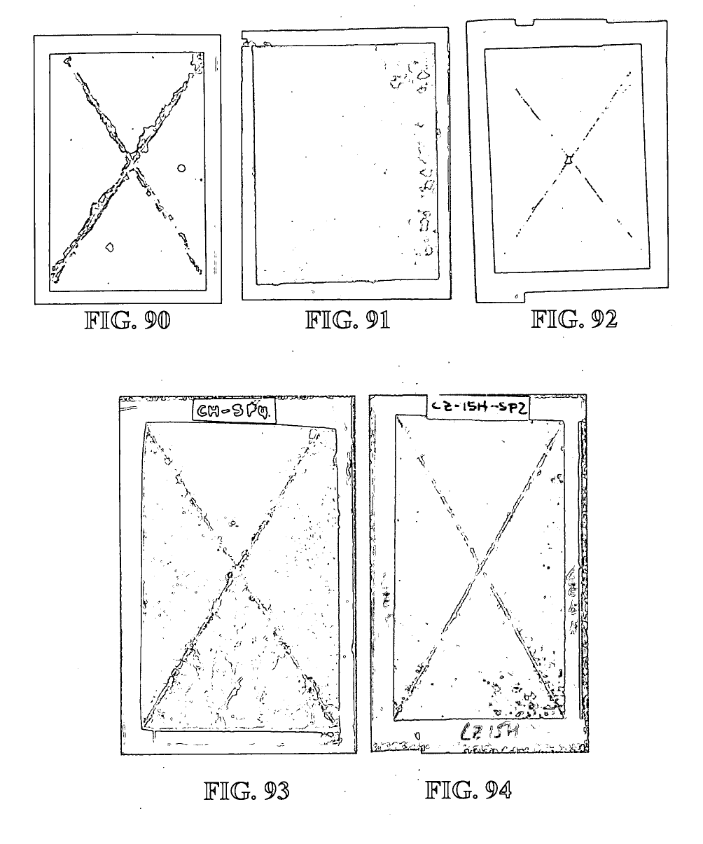

Testing & Results: Immersion of coated cross-scribed HDG panels in a solution of 5 wt % NaCl and 0.6 wt % H₂O₂, for two days. Equivalent to 500 hours of ASTM B117 test. FIGS. 90-92 are photographs of exemplary panels after undergoing the ASTM B117 test that were coated with the Devguard primer, the first superprimer formulation, and the second superprimer formulation, respectively.

A Machu test was carried out on the HDG panels, which is an accelerated corrosion test for painted HDG widely used in Europe. The solution used in this test directly attacks the paint-metal interface due to the presence of the oxidizer H₂O₂ and the test results are claimed to correlate with 500 hours of ASTM B117 salt spray test. This test is especially useful for galvanized steels. The painted panels are cross-scribed on the surfaces, and then immersed in a solution of 5% NaCl+0.6% H₂O₂ at 37° C. for two days. On the second day 0.6% H₂O₂ is added to maintain the peroxide levels. After 2 days of immersion, the panels are taken out and adhesive tape is used to pull off any delaminated paints. Alternatively, a knife can be used to lightly scrape off the paint in any delaminated areas along the scribe lines. The extent of delamination around the scribe is a measure of paint adhesion and corrosion performance of the entire system.

Discussion: The incorporation of an at least partially hydrolyzed BTSE silane in an epoxy primer greatly improves the adhesion of the primer to the substrate and the overall protection against corrosion. The incorporation of an at least partially hydrolyzed hydrolyzed BTSE silane in an epoxy primer also improves the dispersion of the pigments in the coating. The Machu test results shown in the images of the panels are obvious. The first superprimer formulation (superprimer without BTSE silane) and third formulation (commercial control) show scribe/edge delamination along with significant white rust. However, the second superprimer formulation (superprimer with hydrolyzed BTSE) does not show any delamination or white rust, indicating the superior adhesion and anticorrosion properties of the hydrolyzed BTSE based superprimer.

### Experiment 21

Components: (1) Silane—bis[3-(trieithoxysilyl)propyl]tetrasulfide, bis-sulfur silane (available from GE Silicones as Silquest A1289,).

(2) Resin—DPW-6520, a dispersion of solid bisphenol A epoxy resin with a non-HAPS (available from Resolution Performance Products,).

(3) Additives—DPC-6870, curing agent comprising an aqueous dispersion of an amine adduct curing agent (available from available from Resolution Performance Products,); Molywhite CZM, a calcium-zinc molybdate corrosion inhibitor (available from Molywhite Pigments Group,); Corrostain 228, a synergistic corrosion inhibitor (available from Wayne Pigment Corporation, www.waynepigment.com); cerium silica; Phosguard J0806, a micronized zinc phosphate/molybdate corrosion inhibitor (available from Rockwood Pigments,); Tronox RF-K-2, a micronized rutile pigment coated with aluminum compound to improve hydrophobicity (available from Kerr McGee Pigments,); Alsibronz 06, an ultra-fine sized, chemically inert potassium silicate platelets (available from Engelhard Corporation, Iselin, N.J., USA); and, Nanoactive S titanium dioxide, a 12-15% by weight suspension of titanium in water (available from NanoScale Materials, Inc., www.nanoactive.com).

Formulation and Preparation: Five superprimer formulations were prepared in the instant experiment. The first superprimer formulation comprised 80 grams of DPW-6520 added to 5 grams of deionized water, added to 10 grams of bis-sulfur silane, added to 20 grams of DPC 6870. The second superprimer formulation comprised 80 grams of DPW-6520 added to 10 grams of deionized water, added to 15 grams of Molywhite CZM, added to 10 grams of bis-sulfur silane, added to 20 grams of DPC 6870. The third superprimer formulation comprised 160 grams of DPW-6520 added to 20 grams of bis-sulfur silane, added to 10 grams of Nanoactive S titanium, added to 20 grams of deionized water, added to 20 grams of Corrostain 228, added to 5 grams of Tronox RF-K-2, added to 5 grams of Alsibronz 06, added to 40 grams of DPC 6870. The fourth superprimer formulation comprised 160 grams of DPW-6520 added to 20 grams of bis-sulfur silane, added to 10 grams of Nanoactive S titanium, added to 20 grams of deionized water, added to 10 grams of Cerium silica, added to 10 grams of Tronox RF-K-2, added to 10 grams of Alsibronz 06, added to 40 grams of DPC 6870. The fifth superprimer formulation comprised 160 grams of DPW-6520 added to 20 grams of bis-sulfur silane, added to 10 grams of Nanoactive S titanium, added to 20 grams of deionized water, added to 10 grams of cerium silica, added to 10 grams of Corrostain 228, added to 10 grams of Phosguard, added to 40 grams of DPC 6870. The components of each formulation were added together and mixed until each formulation was substantially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure: Each of the five superprimer formulations were applied to one of the five sequential sets of steel substrates using a #28 draw down bar. A sixth set of steel substrates was coated with the first superprimer formulation using a #28 draw down bar. First two sets of steel panels having the first and second formulations applied thereto were cured at 60° C. for 1 hour, followed by 1 hour at 150° C. The last four sets of steel panels having the first and third through fifth formulations applied thereto were cured at ambient conditions for 14 days, followed by 1 hour at 150° C.

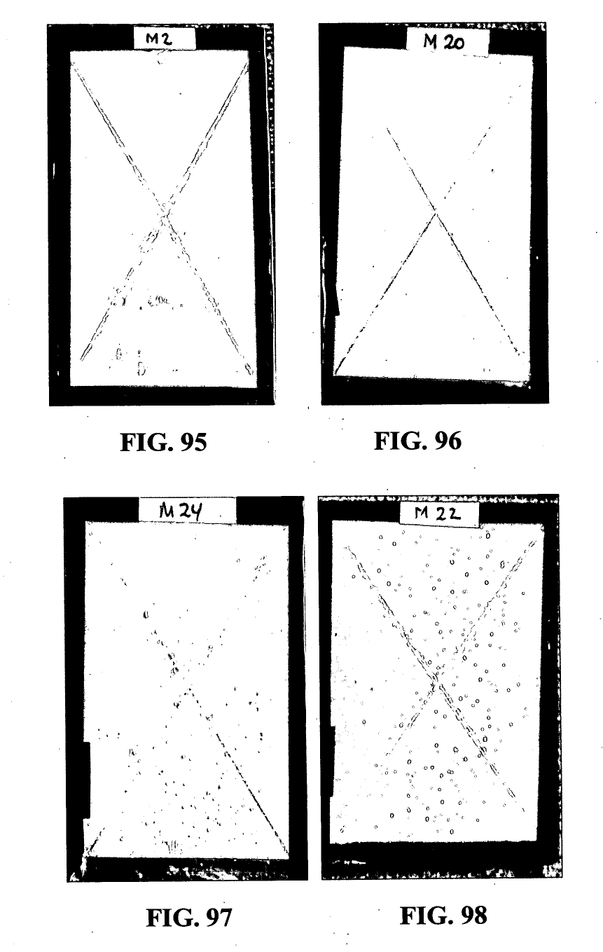

Testing & Results: Referring to FIGS. 93 and 94, corresponding to formulations 1 and 2, we can see that due to the presence of CZM in formulation 2, it does not show white rust as seen in formulation 1. Referring to FIGS. 95-98, with FIG. 95 corresponding to formulation 1 (cured at ambient conditions for 14 days, followed by 1 hour at 150° C.), and FIGS. 96-98 corresponding to formulations 3, 4 and 5, we can notice the absence of any scribe creep or corrosion in formulations 3, 4 and 5 (unlike formulation 1) due to the inhibitors present in them.

ASTM B117 salt spray test were conducted upon the steel substrates coated with the instant superprimer formulations. ASTM B117 are widely used in the coatings industry to evaluate the corrosion resistance of coated metal substrates. In this test, coated panels of HDG (coated with primer and without any topcoat) after being cross-scribed were exposed 5% salt solution (NaCl) are atomized in a salt spray chamber at 35° C. with the solution pH around 7 (to be more precise, this test is the ASTM 1654-92. The actual B117 test does not involve scribing of the panels. However both tests are known by the ‘B117’ name in the industry). The exposed panels are periodically checked for corrosion in the scribe, formation of blisters and delamination in the general coating area/near the scribe. Thus, this test evaluates the corrosion protection and adhesion performance of the coatings.

Discussion: The three inhibitors, Corrostain 228, Molywhite CZM, Zinc Phosphate (Phosguard) and cerium silica, tested work either individually or in combination with other inhibitors to inhibit corrosion of the underlying substrate. The presence of fillers like Titania (Tronox Rf-K-2) and Mica (Alsibronz 06) increase the barrier effect of the film. The presence of Titania suspension (nanoactive S) increases the hiding power (i.e., the ability of a pigmented coating to hide completely the original color of the substrate) of the film as well as aids pigment dispersion in the primer formulation.

### Experiment 22

Components: (1) Silane—bis[3-(trieithoxysilyl)propyl]tetrasulfide, bis-sulfur silane (available from GE Silicones as Silquest A1289,).

(2) Resin—DPW-6520, a dispersion of solid bisphenol A epoxy resin with a non-HAPS (available from Resolution Performance Products,).

(3) Additives—DPC-6870, curing agent comprising an aqueous dispersion of an amine adduct curing agent (available from available from Resolution Performance Products,); Phosguard J0806, a micronized zinc phosphate/molybdate corrosion inhibitor (available from Rockwood Pigments,); Archer RC, a nonvolatile coalescing agent for latex pigments (available from Archer Daniels Midland Company, www.admworld.com); and, Nanoactive S titanium dioxide, a 12-15% by weight suspension of titanium in water (available from NanoScale Materials, Inc., www.nanoactive.com).

Formulation and Preparation: Three superprimer formulations were prepared in the instant experiment. The first superprimer formulation comprised 160 grams of DPW-6520 added to 20 grams of bis-sulfur silane, added to 30 grams of Phosguard, added to 10 grams of deionized water, added to 40 grams of DPC 6870, added to 10 grams of Nanoactive S titanium, added to 10 grams of acetone. The second superprimer formulation comprised 160 grams of DPW-6520 added to 20 grams of bis-sulfur silane, added to 30 grams of Phosguard, added to 20 grams of deionized water, added to 40 grams of DPC 6870, added to 10 grams of Nanoactive S titanium. The third superprimer formulation comprised 160 grams of DPW-6520 added to 20 grams of bis-sulfur silane, added to 30 grams of Phosguard, added to 10 grams of deionized water, added to 40 grams of DPC 6870, added to 10 grams of Nanoactive S titanium, added to 10 grams of Archer RC. The components of each formulation were added together and mixed until each formulation was substantially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure: Each of the three superprimer formulations were applied to one of the three sequential sets of steel substrates using a #28 draw down bar and cured at ambient conditions for 14 days.

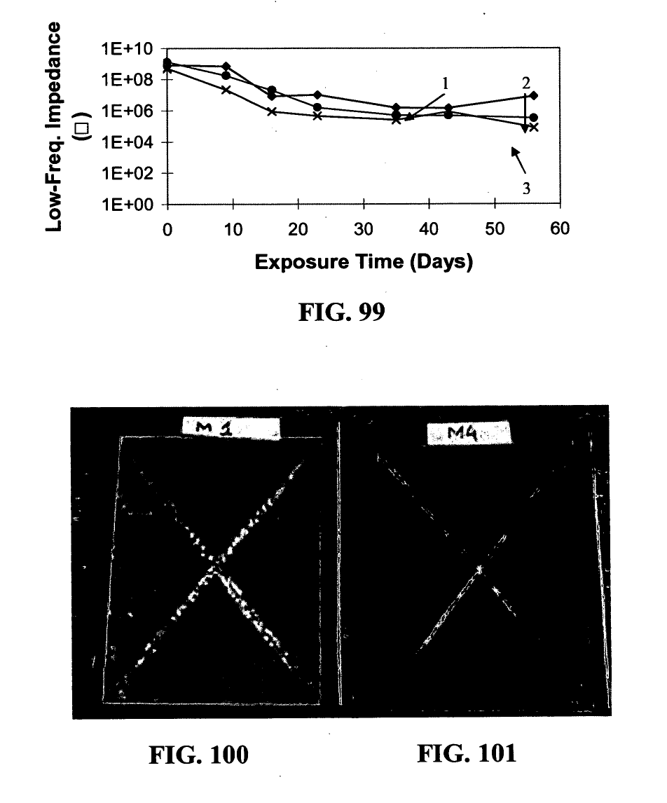

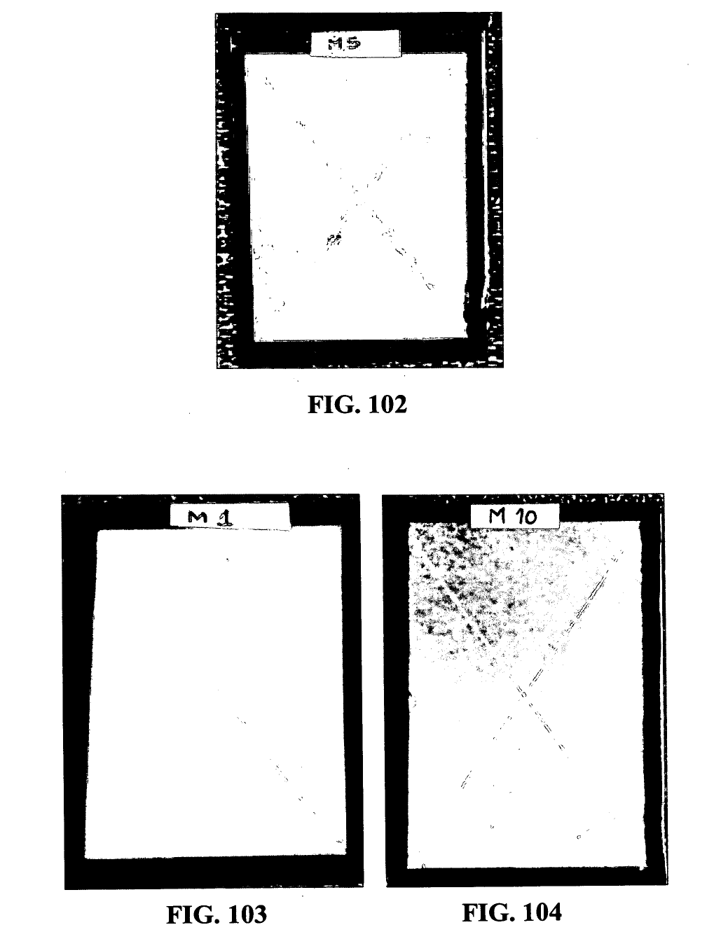

Testing & Results: ASTM B117 salt spray test were conducted upon the steel substrates coated with the instant superprimer formulations. FIG. 99 is a plot of impedance versus time in days, for each of the three superprimer formulations. FIG. 100 is a picture of a steel substrate coated with the first superprimer formulation after 35 days of salt spray testing. FIGS. 101 and 102 are pictures of steel substrates coated with the second and third superprimer formulations, respectively, after 35 days of salt spray testing.

Discussion: As can be seen from FIGS. 99-102, the substitution of water with an organic co-solvent such as acetone/Archer RC does not deteriorate the performance of the epoxy films (notably because of the mild differences in the impedance curves and similar scribe conditions). Further, the addition of the organic co-solvent facilitates the manipulation of the primers rheology, making the primer more workable. For example, the primer can be made less viscous (by adding acetone) or more viscous (by adding Archer). If pigments are added to the system, the co-solvent can aid their dispersion (acetone) or prevent settling (Archer). Also, the room temperature drying of the superprimer can be accelerated by addition of an organic cosolvent (acetone). There are many other promising co-solvents—VOC exempt or otherwise, which can offer similar advantages and can be compatible with epoxy based superprimer. Some examples include solvents such as p-chlorobenzotrifluoride (obtained as oxsol-100 from Kowa chemicals, Japan), 2-butoxyethanol, or a 7:3 mixture of these. In the formulations, the presence of NanoActive S Titania suspension does not only act as pigmenting additive, but it also provides more water to the pigmented primer system and also aids the dispersion of the other pigment (phosguard).

### Experiment 23

Components: (1) Silane—bis[3-(trieithoxysilyl)propyl]tetrasulfide, bis-sulfur silane (available from GE Silicones as Silquest A1289,).

(2) Resin—DPW-6520, a dispersion of solid bisphenol A epoxy resin with a non-HAPS (available from Resolution Performance Products,).

(3) Additives—DPC-6870, curing agent comprising an aqueous dispersion of an amine adduct curing agent (available from available from Resolution Performance Products,); Phosguard J0806, a micronized zinc phosphate/molybdate corrosion inhibitor (available from Rockwood Pigments,); DBTL, dibutyltin dilaurate, a crosslinker for silanes (available from Sigma-Aldrich, www.sigmaaldrich.com); and, Nanoactive S titanium dioxide, a 12-15% by weight suspension of titanium in water (available from NanoScale Materials, Inc., www.nanoactive.com).

Formulation and Preparation: Two superprimer formulations were prepared in the instant experiment. The first superprimer formulation comprised 80 grams of DPW-6520 added to 20 grams of deionized water, added to 15 grams of Phosguard, added to 10 grams of bis-sulfur silane, added to 20 grams of DPC 6870. The second superprimer formulation comprised 160 grams of DPW-6520 added to 20 grams of bis-sulfur silane, added to 10 grams of Nanoactive S titanium, added to 20 grams of deionized water, added to 30 grams of Phosguard, added to 2 grams of DBTL, added to 40 grams of DPC 6870. The components of each formulation were added together and mixed until each formulation was substantially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure: Each of the two superprimer formulations were applied to one of the two sequential sets of steel substrates using a #28 draw down bar and cured at ambient conditions for 14 days.

Testing & Results: ASTM B117 salt spray tests and pencil hardness tests were conducted upon steel substrates having one of the two superprimer formulations. FIGS. 103 and 104 are photographs of steel substrates coated with the first superprimer formulation and the second superprimer formulation, respectively, after 1350 hours of the salt spray testing. The results of the pencil hardness test are listed below.

### Pencil Hardness

### Formulation 1: 2H

### Formulation 2: 5H

Discussion: An increase in film hardness was observed with the addition of DBTL. Also, from the salt spray images, the corrosion protection ability of the films is not affected as the scribe conditions (creep and corrosion) are similar for formulations. In sum, the addition of a small amount of DBTL to a water-borne epoxy superprimer increases its hardness without affecting its ability to protect the metal against corrosion. The similar conditions of the coatings with and without DBTL (after being subjected to the B117 test) shows that the inclusion of DBTL does not deteriorate the water barrier and anti-corrosion property of the coating. On the other hand, the incorporation of DBTL increases the hardness as shown the increased pencil hardness values. Thus, DBTL can be used to achieve increased hardness without deteriorating the water barrier and anti-corrosion properties of the superprimers.

### Experiment 24

Components: (1) Silane—bis-[trimethoxysilylproply]amine, bis-amino silane (available from GE Silicones as Silquest A1170,); bis[3-(trieithoxysilyl)propyl]tetrasulfide, bis-sulfur silane (available from GE Silicones as Silquest A1289,); TEOS, tetraethoxysilane (available from Stochem Specialty Chemicals,); vinyltriacetoxysilane, (available from Gelest,); and, AV5, 5:1 weight % ratio of a silane mixture containing VTAS (vinyltriacetoxysilane, available from Gelest,) and A 1170 (bis-trimethoxysilylpropylamine, available from General Electric,) in a ratio of 5:1 by volume.

(2) Resin—DPW-6520, a dispersion of solid bisphenol A epoxy resin with a non-HAPS (available from Resolution Performance Products,).

(3) Additives—DPC-6870, curing agent comprising an aqueous dispersion of an amine adduct curing agent (available from available from Resolution Performance Products,); EPIKURE 8290-Y-60, a water-reducible, high molecular weight amine adduct (60% solids) (available from Resolution Performance LLC,); EPI-REZ 5522-WY-55 is a diglycidyl ether of bisphenol A (DGEBA) epoxy 55% water dispersion in water and 2-propoxyethanol (available from Resolution Performance LLC,); EPI-REZ 3540-WY-55, a 55% solid dispersion of epoxy resin in water and 2-propoxyethanol (available from Resolution Performance Products,); Ancarez AR550, a waterborne solid epoxy resin dispersion that does not gel immediately with certain silanes (available from Air Products and Chemicals, Inc.); Neorez R-972, a water-based polyurethane resin (available from DSM NeoResins,); and, Surfynol MD 20, a microdefoamer (available from Air Products and Chemicals, Inc.).

Formulation and Preparation: Six superprimer formulations were prepared in the instant experiment. The first superprimer formulation comprised 80 grams of EPI-REZ 3540 added to 9 grams of AV5 (10% by volume diluted with deionized water and pH adjusted to 6 using an acetic acid buffer), added to 10 grams of A1289, added to 1 gram of TEOS. The second superprimer formulation comprised 80 grams of EPI-REZ 3540 added to 9 grams of AV5 (10% by volume diluted with deionized water and pH adjusted to 6 using an acetic acid buffer), added to 10 grams of A1289, added to 1 gram of TEOS, added to 10 grams of EPIKURE 8290. The third superprimer formulation comprised 80 grams of EPI-REZ 5522 added to 9 grams of AV5 (10% by volume diluted with deionized water and pH adjusted to 6 using an acetic acid buffer), added to 10 grams of A1289, added to 1 gram of TEOS, added to 10 grams of EPIKURE 8290. The fourth superprimer formulation comprised 80 grams of DPW 6520 added to 9 grams of AV5 (10% by volume diluted with deionized water and pH adjusted to 6 using an acetic acid buffer), added to 10 grams of A1289, added to 1 gram of TEOS, added to 10 grams of EPIKURE 8290. The fifth superprimer formulation comprised 80 grams of DPW 6520 added to 20 grams of DPC 6870, added to 10 grams of A1289. The sixth superprimer formulation comprised 35 grams of Ancarez AR 550 added to 10 grams of Neorez 972, added to 5 grams of A1289, added to 0.05 grams of Surfynol MD 20, added to 30 grams of DPW 6520, added to 20 grams of DPC 6870. The components of each formulation were added together and mixed until each formulation was substantially homogenous.

Substrates and Preparation: Multiple Hot Dip Galvanized (HDG) steel substrates were wiped with cotton swabs dipped in acetone and scrubbed with a scrotchbrite pad. The steel substrates were then ultrasonically cleaned in ethanol and acetone successively for 10 minutes each. The steel substrates were finally dipped in an alkaline cleaner at 65° C. for 3 minutes, rinsed with distilled water, and forced air dried.

Application and Cure: Each of the six superprimer formulations were applied to one of the six sequential sets of steel substrates using a #28 draw down bar and cured at 60° C. for one hour, followed by curing at 150° C. for one hour.

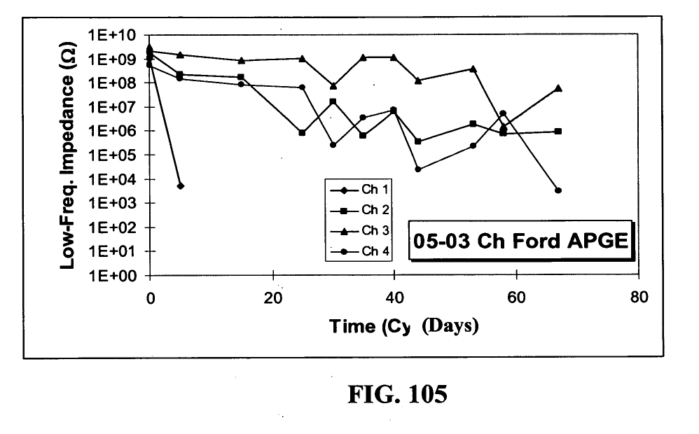

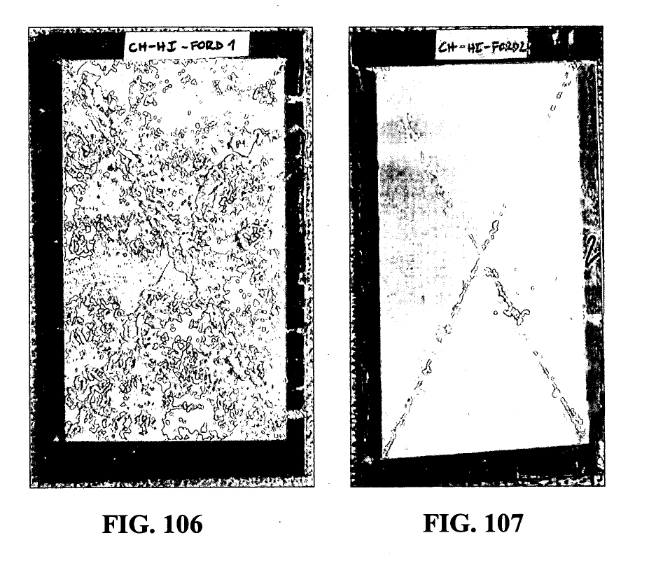

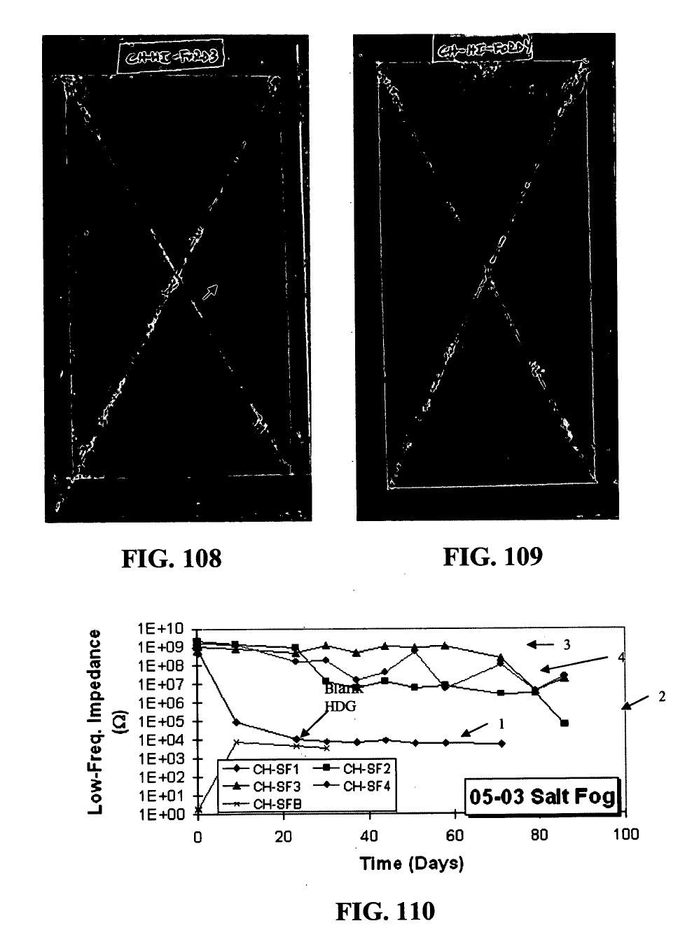

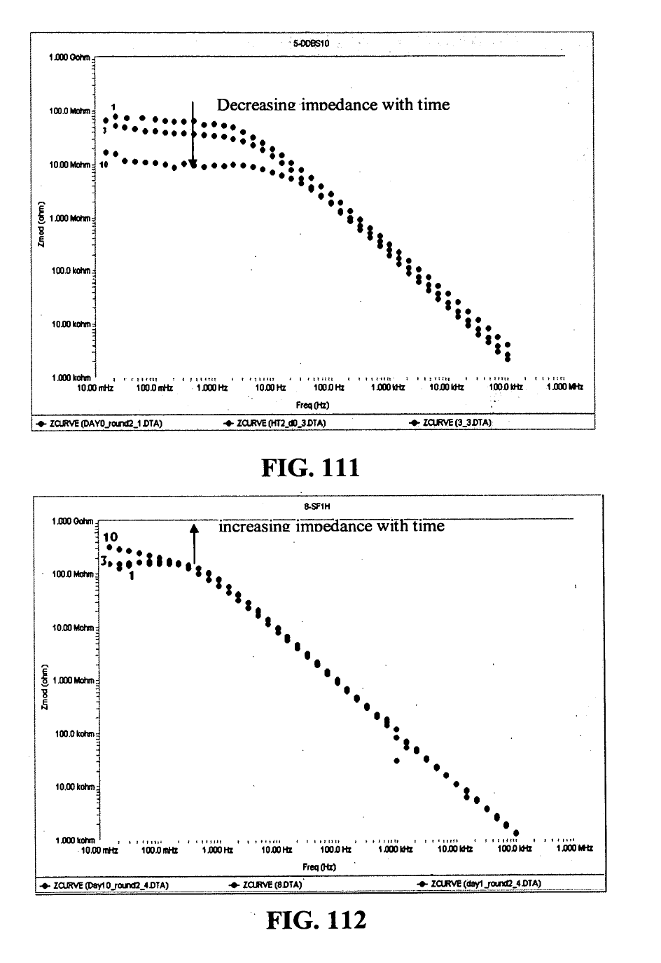

Testing & Results: ASTM B117 salt spray tests were conducted, and EIS measurements were made, on the steel substrates having one of six exemplary superprimer formulations. In addition, Ford AGPE tests were conducted on the steel substrates having one of six exemplary superprimer formulations that were cross-scribed. The Ford AGPE test is a cyclic accelerated corrosion test developed for evaluation of the perforation resistance of painted steel. The test includes a seven day cycle, where the first five days of the cycle include their own sub-cycle. The sub-cycle consists of each substrate being immersed in a 5 weight percent solution of NaCl at room temperature for 15 minutes, followed by 105 minutes of ambient drying, followed by 22 hours at 60° C. and 90 percent humidity. For the final two days, the substrates are maintained at 60° C. and 90 percent humidity. Other automotive companies have similar cyclic tests, differing in detail of exposure conditions. The exposure period was 20 weeks. Periodically, the specimens were removed and EIS measurements were taken using the procedure described above. FIG. 105 is a plot of impedance versus time in days associated with the Ford AGPE tests for the first four superprimer formulations. FIG. 106 is a photograph of an exemplary steel substrate coated with the first superprimer formulation after 2 cycles. FIG. 107 is a photograph of an exemplary steel substrate coated with the second superprimer formulation after 8 cycles. FIG. 108 is a photograph of an exemplary steel substrate coated with the third superprimer formulation after 8 cycles. FIG. 109 is a photograph of an exemplary steel substrate coated with the fourth superprimer formulation after 8 cycles. FIG. 110 is a plot of impedance versus time in days associated with the salt spray tests for the first four superprimer formulations, and also includes a fifth data set corresponding to an uncoated substrate. FIGS. 111 and 112 are EIS plots of substrates coated with the fifth and sixth superprimer formulations, respectively.

Discussion: Comparison of the Ford test results and ASTM B117 results of the first and second superprimer formulations show the enormously beneficial effect of the crosslinker EPIKURE 8290-Y-60 on the eventual films. Without the crosslinker, the superprimer's barrier property on HDG substrate drops drastically (indicated by the drop in impedance value). By including the crosslinker in the second formulation, the film becomes more stable over time. The resins EPI-REZ 5522-WY-55 and DPW 6520 form better films than EPI-REZ 3540-WY-55, with forming being marginally better than the latter. Inclusion of Ancarez Ar 550 epoxy dispersion, Neorez R 972 and Ecocryl 9790 leads to the formation of films which show improvement over the time of electrolyte exposure (increasing impedance in #6), while the base superprimer without these additions (#5) degrades over time. The addition of a defoamer is important when including Ancarez Ar550, as it is susceptible to much foaming.

### Experiment 25

Components: (1) Silane—bis-triethoxysilylpropylethane, BTSE (available from GE Silicones as Y-9805®,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,)

(3) Additives—Nanogel Translucent Aerogel, a trimethysilyloxy modified silica (available from Cabot Corporation, www.cabot-corp.com).

Formulation and Preparation: The superprimer coating is based upon the following formulation. The individual components were stir-mixed according to the ratio given below. A homogeneous mixture should be achieved before coating application.

| | | Weight percentage in |
|---|---|---|
| | Weight part | wet formulation |
| ECO-CRYL 9790 | 8 | 46.5 |
| EPI-REZ WD 510 | 1 | 5.8 |
| BTSE | 1 | 5.8 |
| Nanogel Translucent Aerogel | 0.2 | 1.2 |
| Deionized Water | 7 | 40.7 |
| Total | 30.86 | |

Substrates and Preparation: Oxidized copper panels were cleaned with a 7% Chemclean (purchased from Chemetall/Oakite Inc) at 60° C., followed by tap water rinsing and forced air drying.

Application and Cure: The cleaned panels were spray-coated with a HVLP spray gun. The wet coating was cured at 65° C. for 1 hour.

Testing & Results: Adhesion and chemical resistance tests were conducted on a 1-day cured coating according to ASTM D3359-B and ASTM D1308, respectively. Visual inspection was also done after the tests. Benchmark test results for the coated copper panels are listed below in Table 15.

TABLE 15

| Tests | Result |
|---|---|
| ASTM D 3359-B (adhesion) | 5B (excellent) |
| 24- hr DI water immersion (40° C.) | No blisters |
| ASTM D 1308 (Chemical resistance) | 6N HCl (no effect); |
| | 6N NaOH (no effect) |
| Visual inspection | Matte coating appearance |

Discussion: A decorative coating appearance, such as matte surface, is desired in some applications. To acquire this matte appearance, a certain amount of matting agent, such as silica nano-particles, is added to the coating formulation. In many cases, the addition of a matting agent degrades coating performance in terms of corrosion protection and chemical resistance. The formulation designed here, however, does not cause degradation in coating performance, as is evidenced by the test results listed in Table 15.

### Experiment 26

Components: (1) Silane—bis-triethoxysilylpropyloctane, BTSO (available from GE Silicones as Y-15445,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,).

(3) Additives—Surfynol 465, a wetting agent (available from Air Products Inc,); and, Dynol 604, a wetting agent (available from Air Products Inc.,).

Formulation and Preparation: The superprimer coating is based upon the following formulation. The individual components were stir-mixed according to the ratio given below. A homogeneous mixture should be achieved before coating application. The amount of DI water is adjustable, from 5.5 to 16.5 (weight part).

| | | Weight percentage in |
|---|---|---|
| | Weight part | wet formulation |
| ECO-CRYL 9790¹ | 9 | 53.80 |
| EPI-REZ WD 510² | 0.5 | 2.98 |
| BTSO³ | 1.5 | 8.96 |
| Surfynol 465⁴ | 0.12 | 0.71 |
| Dynol 604⁵ | 0.12 | 0.71 |
| Deionized Water | 5.5 | 32.86 |
| Total | 16.74 | |

Substrates and Preparation: Brass panels were cleaned with a 7% Chemclean (purchased from Chemetall/Oakite Inc) at 60° C., followed by tap water rinsing and forced air drying.

Application and Cure: The cleaned brass panels were dipped into the above mixture, followed by 110° C. curing for 1 hour.

Testing & Results: ASTM B117, ASTM B-3363, ASTM D3359-B and metal leachate tests were conducted on the above panels. The control system is coated brass. Table 16 presents the benchmark results for the coated brass panels. Table 17 gives the results for metal and organic leachate tests (19 days of immersion).

TABLE 16

| Tests | Result |
|---|---|
| ASTM D 3359-B (adhesion) | 5B (excellent) |
| ASTM B-3363 (pencil hardness) | 2H (after 4 days of ambient curing) |
| ASTM B117 (Salt spray test) | 32 days (no severe corrosion and film |
| | delamination) |

TABLE 17

| | Copper (μg/L) | Zinc (μg/L) |
|---|---|---|
| Untreated | 95.0 | 116.0 |
| Coated brass | 23 | 42.0 |

Discussion: The experiment includes a formulation for a brass substrate clear coat. This coating is capable of preventing the major metallic elements of brass, such as Cu and Zn, from leaching out of the surface. As can be seen in Table 16, this instant coating is fairly hard (2H pencil hardness) and adheres to the brass substrate very well (5B). The 32-day salt spray test result also demonstrates the coating's good corrosion protective performance. The uncoated brass, on the contrary, was corroded in less than 4 hrs when subjected to a salt spray test (test results are not provided here). Table 17 gives a 19-day immersion test results in the form of the concentration of Cu and Zn ions leaching into the test solution. Clearly, the coated brass exhibits much smaller concentration of Cu and Zn ions than the uncoated substrate, indicating that less Cu and Zn has leached out of brass. In other words, the coating efficiently retards the leaching of Cu and Zn from brass.

### Experiment 27

Components: (1) Silane—Silquest A 1289, a bis-[triethoxysilylproyl]tetrasulfide silane (available from General Electric,);

(2) Latex—Duratop A.C.W. W-7735 AV, an acrylate latex (available from The Thermoclad Company).

Formulation and Preparation: The superprimer coating is based upon the following formulation. The individual components were stir-mixed according to the ratio given below. A homogeneous mixture should be achieved before coating application. The silane content in wet formulation is between 2% to 5%. It should be noted that other silanes such as, without limitation, BTSE, and BTSO may be used in place of the A1289 silane.

| | Volume part volume |
|---|---|
| | percentage in wet formulation |
| Duratop A.C.W. W-7735 AV¹ | 97 |
| Silquest ® A-1289² | 3 |
| Total | 100 |

Substrates and Preparation: Hot-dip galvanized steel, HDG, panels were cleaned with a 7% Chemclean (purchased from Chemetall/Oakite Inc) at 65° C., followed by tap water rinsing and forced air drying.

Application and Cure: A coating of 2 to 5 μm thick was spray-applied onto the cleaned HDG panels. The wet coating cured at 70° C. for 1 hr, followed by 3 days of ambient curing before testing.

Testing & Results: ASTM B117 was conducted on the above panels. The control system was a HDG panel coated with Duratop A.C.W. W-7735 AV without the addition of silane. FIGS. 113-115 are photographs of panels show the ASTM B117 test results for coatings with and without silanes.

Discussion: As can be seen, the silane-containing coating (FIG. 115) shows no corrosion after 335 hrs of salt spray exposure, while the coating without silane (FIG. 114) exhibits severe corrosion along the edges of the substrate. Moreover, the untreated HDG substrate (FIG. 113) shows 100% corrosion after 17 hrs of exposure. In conclusion, the addition of silane provides an acceptable latex-based coating.

### Experiment 28

Components: (1) Silane—bis-(triethoxysilypropyl)ethane, BTSE silane (available from GE Silicones,).

(2) Resin—EPI-REZ WD-510, a water dispersible bisphenol A epoxy resin (available from Resolution Performance Products,); ECOCRYL 9790, a 42% anionic water dispersion of acrylate copolymer in water (available from Shell Chemical LP,).

(3) Additives—EnviroGem AE 03, a wetting agent and defoamer (available from Air Products Chemicals, Inc.; Triton X-100, an emulsifier (available from Dow Chemical Company, Midland, Mich., USA); V-9250 BLUE, an inorganic color pigment (available from Ferro Corporation, Washington, Pa., USA).

Formulation and Preparation: The superprimer coating is based upon the following formulation. The coating is based upon a 2-component formulation, with the two components being mixed together to achieve a substantially homogeneous mixture. The silane content in wet formulation is between 2% to 5%.

| | |
|---|---|
| Weight % | Weight % |
| Dry Film | Wet Formulation |

Part A

| | | |
|---|---|---|
| EPI-REZ WD 510 | 30 | 7.5 |
| BTSE | 10 | 2.5 |

Part B

| | | |
|---|---|---|
| DI Water | 60 | 15.0 |
| EnviroGem AE03 | 2 | 1.0 |
| Triton X-100 | 1 | 0.5 |
| V-9250 BLUE | 65 | 16.25 |

High shear mixing

| | | |
|---|---|---|
| ECO-CRYL 9790 | 60 | 62.5 |

High shear mixing for another 5 minutes

| | | |
|---|---|---|
| EnviroGem AE03 | 2 | — |
| ECO-CRYL 9790 | 180 | — |
| Total | 410 | |

Substrates and Preparation: Stainless steel panels were wipe cleaned with acetone and dip-cleaned with a 7% Chemclean (purchased from Chemetall/Oakite Inc) at 65° C., followed by tap water rinsing and air drying.

Application and Cure: A coating of 30 to 50 μm thick was spray-applied onto the cleaned stainless steel panels. The wet coating cured at 70° C. for 1 hr, followed by 3 days of ambient curing before testing.

Testing & Results: ASTM D3359-B and ASTM B117 were conducted on the above panels. Table 18 shows the test results for blue coatings.

TABLE 18

| Tests | Result |
|---|---|
| ASTM D 3359-B (adhesion) | 5B (excellent) |
| ASTM D 1308 (Chemical resistance) | 6N HCl (no effect); |
| | 6N NaOH (no effect) |
| ASTM B117 (salt spray test) | 1000 hr (no blisters, |
| | no delamination) |
| Visual inspection | Blue coating |

Discussion: In this experiment, a decorative blue coating was designed for stainless steel. As can be seen in the above table, the addition of blue pigment does detract from coating performance criteria such as adhesion, chemical resistance and corrosion protection performance in a salt spray test.

### Experiment 29

Components: (1) Silane—bis[3-(trieithoxysilyl)propyl]tetrasulfide, bis-sulfur silane (available from GE Silicones as Silquest A1289,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,).

(3) Additives—Alink-25, a crosslinker (available from General Electric,); calcium zinc phosphomolybdate (CZPM) (available from Moly-White Pigments Group, http://www.moly-white.com); and, zinc phosphate (available from Alfa Aesar, www.alfa.com).

Formulation and Preparation: Two superprimer formulations were prepared in the instant experiment using a base formulation comprising 70 grams of ECO-CRYL 9790 added to 30 grams of EPI-REZ WD 510, added to 15 grams of A1289, added to 2.5 grams of Alink-25. The first formulation included the base formulation mixed with 50.4 grams of CZPM. The second formulation included the base formulation mixed with 50.4 grams of zinc phosphate. After the addition was made to the base formulation, the resulting composition was high shear mixed for 6 minutes.

Substrates and Preparation: Aluminum alloy 7075-T6 (AA7075) substrates were sanded and alkaline cleaned.

Application and Cure: Each of the two superprimer formulations were applied to one of the two sequential sets of AA7075 substrates using a #28 draw down bar and cured for two days at ambient conditions. Subsequent to curing of the superprimer coatings, the substrates were scribed in an “X” shaped pattern.

Testing & Results: The two set of AA7075 substrates each coated with a superprimer coating, along with a set of bare AA7075 substrates, were immersed for 40 days in a 3.5% by weight NaCl solution. The results of the immersion are shown pictorially in FIGS. 116-118

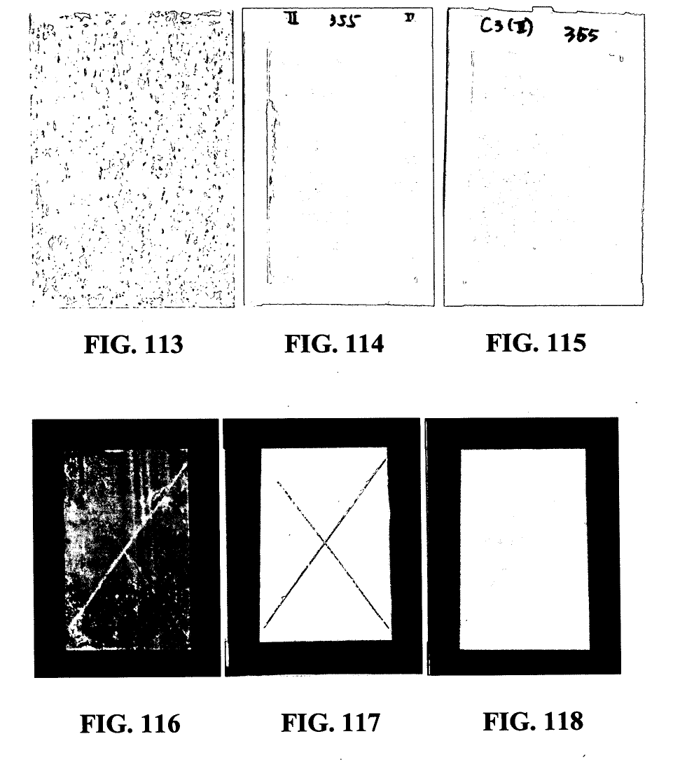

Discussion: As shown in FIG. 116, after 40 days immersion in 3.5% by weight NaCl solution, obvious corrosion occurred at the scribe on the unpigmented coating. Corrosion cells were formed at the scribe, and the coating was delaminated in local areas near the scribe. However, the scribe on the superprimer coating loaded with 30% zinc phosphate (FIG. 118) or CZPM (FIG. 117) exhibited no corrosion or delamination near the scribe. The addition of CZPM or zinc phosphate to the superprimer coatings appeared to prevent substantial corrosion at the scribe and achieved a self-healing condition analogous to chromate conversion coatings.

### Experiment 30

Components: (1) Silane—bis[3-(trieithoxysilyl)propyl]tetrasulfide, bis-sulfur silane (available from GE Silicones as Silquest A1289,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,).

(3) Additives—Alink-25, a crosslinker (available from General Electric,); iron oxide colorant (available from, Bayer AG, Germany, www.bayferrox.com); and, zinc phosphate (available from Alfa Aesar, www.alfa.com).

Formulation and Preparation: A single superprimer formulation was prepared in the instant experiment using a base formulation comprising 70 grams of ECO-CRYL 9790 added to 30 grams of EPI-REZ WD 510, added to 15 grams of A1289, added to 2.5 grams of Alink-25. The superprimer formulation includes the base formulation mixed with 50.4 grams of zinc phosphate and 2 grams of iron oxide, and thereafter high shear mixed for 6 minutes.

Substrates and Preparation: Aluminum alloy 7075-T6 (AA7075) substrates were sanded and alkaline cleaned.

Application and Cure: The superprimer formulation was applied to a set of AA7075 substrates using a #28 draw down bar and cured for two days at ambient conditions. Subsequent to curing of the superprimer coating, half of the substrates were scribed in an “X” shaped pattern.

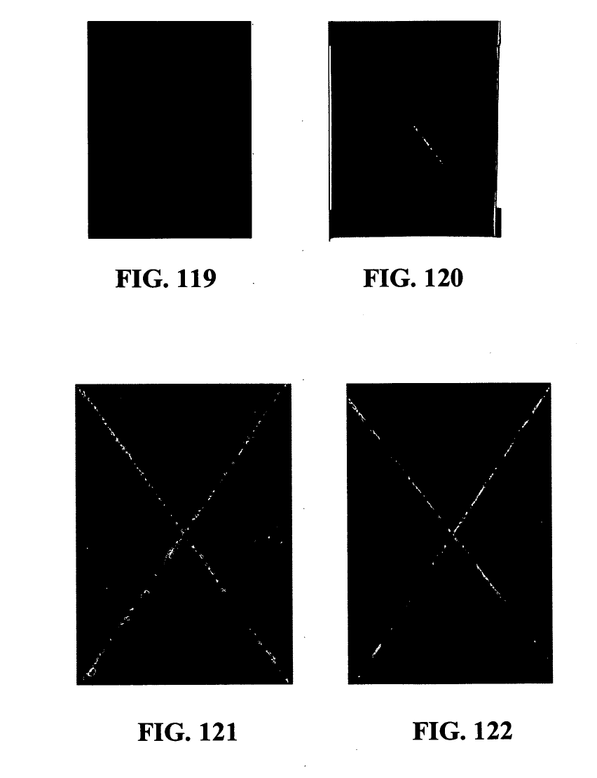

Testing & Results: The AA7075 substrates were immersed for 30 days in a 3.5% by weight NaCl solution. The results of the immersion are shown pictorially in FIGS. 119 and 120, with FIG. 120 being scribed with an “X”.

Discussion: Referencing FIGS. 119 and 120, with iron oxide added as colorant, the superprimer coating loaded with 30% zinc phosphate didn't fail prior to 30 days of immersion. The results show that the addition of iron oxide does not impair the anticorrosive property of the superprimer formulation. The addition of iron oxide adds to the superprimer coating with color and visibility, which may be advantageous to ensure coverage of the superprimer over a substrate.

### Experiment 31

Components: (1) Silane—bis-triethoxysilylpropylethane, BTSE (available from GE Silicones as Y-9805®,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,).

(3) Additives—cerium vanadium oxide, a corrosion inhibitor (available from Alfa Aesa, Inc., .com).

Formulation and Preparation: A single superprimer formulation was prepared in the instant experiment using a base formulation comprising 70 grams of ECO-CRYL 9790 added to 30 grams of EPI-REZ WD 510, added to 20 grams of BTSE. The superprimer formulation includes the base formulation mixed with 12.3 grams of cerium vandium oxide in a high shear mixer for 6 minutes.

Substrates and Preparation: Aluminum alloy A-2024 T3 substrates were sanded and alkaline cleaned.

Application and Cure. The superprimer formulation was applied to a set of A-2024 T3 substrates using a #28 draw down bar and cured for two days at ambient conditions. Subsequent to curing of the superprimer coating, the substrates were scribed in an “X” shaped pattern.

Testing & Results: The A-2024 T3 substrates were immersed for 30 days in a 3.5% by weight NaCl solution. The results of the immersion are shown pictorially in FIGS. 121 and 122, with FIG. 121 showing a substrate coated with the base formulation (without CeVO₄), while FIG. 122 shows a substrate coated with the superprimer formulation (with CeVO₄).

Discussion: Referring to FIG. 122, the superprimer with 10% CeVO₄ shows good protection against corrosion, even in the areas where the substrate was scribed. This protection is analogous to the protection offered by so-called self-healing chromate-based coatings.

### Experiment 32

Components: (1) Silane—bis-triethoxysilylpropylethane, BTSE (available from GE Silicones as Y-9805®,).

(2) Resin—ECO-CRYL 9790, a 42% acrylic copolymer in 45% water and 13% co-solvents (available from Resolution Performance LLC,; and, EPI-REZ WD 510, a diglycidyl ether of bisphenol A (DGEBA) epoxy resin (available from Resolution Performance LLC,).

(3) Additives—cerium acetate (available from Alfa Aesa, Inc.,); benzotriazole (BTA) (available from PMC, Inc.,); and plasma monomer octfluorotoluene (OFT) (available from Alfa Aesa, Inc.,).

Formulation and Preparation: The corrosion inhibitor was processed in a reactor using 100 grams of cerium acetate at 50 mtorr, thereafter having OFT monomer at 10 sccm flow rate (the monomer was continually introduced to the reactor at this flow rate) introduced until the pressure increased to 350 mtorr. The OFT monomer was activated by applying 60 watts radio frequency electromagnetic wave to generate a plasma (the chemical composition of the plasma is a polymer radical fragmented from the monomer). The plasma processing continues for 1 hour. This previous composition is extracted from the reactor and mixed with BTA in a 1:1 weight ratio. 2.65 grams of the resultant composition, a corrosion inhibitor mixture, was mixed in a high shear mixer at 300 rpm for 6 minutes with a base superprimer formulation comprising 80 grams of ECO-CRYL 9790 added to 20 grams of EPI-REZ WD 510, added to 30 grams of BTSE, thereby resulting in the improved superprimer.

Substrates and Preparation: Aluminum alloy A-2024 T3 substrates were sanded and alkaline cleaned.

Application and Cure: The improved superprimer formulation was applied to a set of A-2024 T3 substrates using a #28 draw down bar and cured for two days at ambient conditions.

Subsequent to curing of the superprimer coating, the substrates were scribed in an “X” shaped pattern.

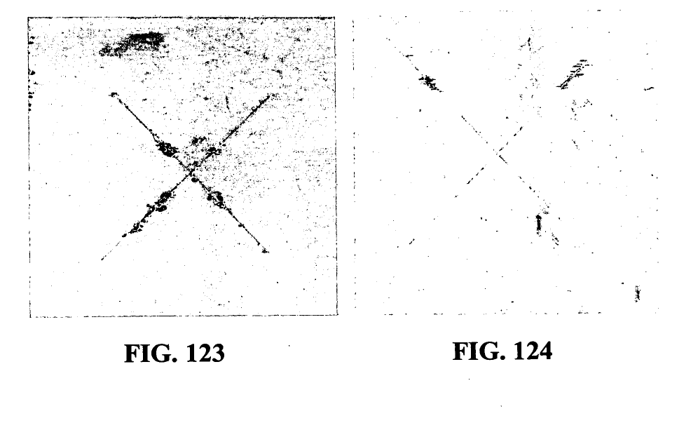

Testing & Results: The Aluminum alloy A-2024 T3 substrates were immersed for 17 days in a 3.5% by weight NaCl solution. The results of the NaCl immersion test are shown pictorially in FIGS. 123 and 124, with FIG. 123 a substrate coated with the base superprimer formulation, and FIG. 124 corresponding to a substrate coated with the improved superprimer formulation.

Discussion: As evidenced in FIG. 124 by the exemplary improved superprimer formulation, the exemplary plasma coating process can be applied to convert hydrophilic pigment into hydrophobic corrosion inhibitors suitable for primer coating. The inhibitor can be various combinations of organic pigments and plasma treated organic pigments, such as a combination of untreated BTA, plasma treated sodium vanadate and plasma treated cerium acetate. Moreover, the hydrophobicity of corrosion inhibitors can be tuned according to the requirements by selecting the plasma monomer or adjusting the monomer pressure and excitation power.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention as defined by the following proposed points of novelty. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A composition capable of coating a substrate and curing to provide a hydrophobic film inhibiting corrosion, the composition comprising:
a bis-silane comprising between about 0.5 weight percent to about 50 weight percent of the composition; and
a water soluble or dispersible polymer comprising between 10 weight percent to about 80 weight percent of the composition.

2. The composition of claim 1, further comprising at least one of an emulsifier, a surfactant, a film builder, a thickener, a toughening agent, an ultraviolet absorber, and an ultraviolet reflector.

3. The composition of claim 1, further comprising a leachable inhibitor.

4. The composition of claim 3, wherein the leachable inhibitor includes at least one of a salt of trivalent cerium (Ce), a salt of trivalent lanthanum (Le), a salt of yttrium (Y), a molybdate, a phosphate, a phosphonate, a phosphomolybdate, a vanadate, a borate, an amine, a glycolate, a sulfenamide, and a tungstate.

6. The composition of claim 1, wherein the bis-silane comprises a mixture of silanes comprising at least one partially hydrolyzed bis-silane.

7. The composition of claim 1, wherein the bis-silane comprises a mixture of bis-silanes.

8. The composition of claim 1, further comprising a crosslinking agent for at least one of the resin and the silane.

9. The composition of claim 1, further comprising nanoparticles.

10. The composition of claim 1, further comprising at least one of oxidic particles and non-oxidic particles comprising between about 1 weight percent to about 95 weight percent of the composition.

11. The composition of claim 10, wherein the composition includes at least one of zinc dust, carbon black, silica, and iron oxide.

12. A method of a coating inhibiting the permeability of a fluid comprising the steps of:
mixing a bis-silane and a water soluble or dispersible polymer to comprise a resultant mixture, where the bis-silane comprises between 0.5 weight percent to about 50 weight percent of the resultant mixture, and where the water soluble or dispersible polymer comprises between 10 weight percent to about 80 weight percent of the resultant mixture;
applying the resultant mixture to a substrate; and
curing the resultant mixture on the substrate to create a corrosion barrier.

13. The method of claim 12, wherein the mixing step further includes mixing at least a partially hydrolyzed bis-silane with a water soluble or dispersible polymer.

14. The method of claim 12, wherein the mixing step further includes mixing multiple silanes, including a bis-silane, with the water soluble or dispersible polymer.

15. A liquid coating composition, adapted to be applied to a substrate to form a coating, comprising between about 30-95 weight percent zinc dust, between about 5-22 weight percent organic binder, and between about 0.2-4 weight percent silane.

16. The coating of claim 15, further comprising a curing agent from about 0.1 to about 4 weight percent of the liquid coating composition.

17. A method of forming a liquid coating composition comprising:
mixing zinc dust, a solvent, and a resin to form a first part;
mixing a silane and a curing agent to form a second part; and
mixing the first part and the second part to provide a liquid coating composition comprising between about 15-80 weight percent zinc dust, between about 5-22 weight percent water soluble resin, between about 0.5-50 weight percent silane, between about 1-4 weight percent curing agent, and between about 5-40 weight percent solvent.

18. The method of claim 17, wherein:
the act of mixing the first part and the second part is carried out under high shear conditions.

19. A method of forming a coating composition comprising:
mixing zinc dust, a solvent, and a resin to form a first part;
mixing a silane, the first part, and a curing agent to provide a liquid coating composition comprising between about 15-80 weight percent zinc dust, between about 5-22 weight percent water soluble resin, between about 0.5-50 weight percent silane, between about 1-4 weight percent curing agent, and between about 5-40 weight percent solvent.

20. The method of claim 19, wherein:
the act of mixing a silane, the first part, and a curing agent is carried out under high shear conditions.

21. A method of forming a coating composition comprising:
mixing a non-aqueous solvent and a resin to form a first part;
mixing a silane and the first part to provide a liquid coating composition comprising between about 5-60 weight percent water soluble resin, between about 0.5-50 weight percent silane, and between about 5-40 weight percent solvent.

22. The method of claim 21, wherein:
the act of mixing a silane, the first part, and a curing agent is carried out under high shear conditions.

23. A method of forming a coating composition comprising:
mixing zinc dust, non-aqueous solvent, and a resin to form a water based first part; and
mixing the first part with a silane to provide a liquid composition comprising between about 15-80 weight percent zinc dust, between about 5-22 weight percent water soluble resin, between about 0.5-50 weight percent silane, and between about 5-40 weight percent solvent.

24. A method of forming a coating composition comprising mixing zinc dust, a resin, and a silane substantially simultaneously to comprise a water based liquid composition comprising between about 30-75 weight percent zinc dust, between about 5-22 weight percent water soluble resin, between about 0.5-50 weight percent silane, between about 1-4 weight percent curing agent, and between about 5-40 weight percent solvent, where the coating composition is adapted to be applied to a substrate to form a coating.

25. The method of claim 17, further comprising the step of adding a corrosion inhibitor to the composition, wherein the coating composition comprises between about 1-50 weight percent corrosion inhibitor.

26. The method of claim 17, wherein at least one of the mixing steps occurs under high shear conditions.

27. A composition capable of coating a substrate and curing to provide a hydrophobic film inhibiting corrosion, the composition comprising:
a mixture of silanes;
a dispersible or soluble resin; and
an aqueous or non-aqueous solvent.

28. The composition of claim 27, wherein the mixture of silanes includes at least one of a bis-sulfur silane, a bis-benzene silane, a bis-alkane silane, a bis-alkene silane, and a bis-amino silane.

29. The composition of claim 28, wherein:
the bis-amino silane includes bis-trimethoxysilylpropylamine, bis-trimethoxysilylpropyldiamine;
the bis-sulfur silane includes at least one of bis-(triethylsilylpropyl)disulfide and bis[3-(triethoxysilyl)propyl]disulfide;
the bis-benzene silane includes 1,4-bis(trimethoxysilylethyl)benzene; and
the bis-alkane silane includes bis-(triethoxysilyl)ethane and bis-triethoxysilyloctane.

30. The composition of claim 27, wherein:
the silane includes a mixture of bis-silanes;
the dispersible or soluble resin includes at least one of an epoxy resin, polyurethane resin, an amino resin, a polyisocyanate resin, a polyester resin, a polyalkyd resin, and an acrylic resin; and
the aqueous or non-aqueous solvent includes water, acetone, ketones, alcohols, and alcohol derivatives.

31. The composition of claim 30, wherein:
the epoxy resin includes a novalac or a diglycidyl ether of bisphenol A;
the polyurethane resin includes a polyether urea component; and
the amino resin includes an aliphatic amine.

32. The composition of claim 27, wherein:
the bis-silane comprises between about 0.5 percent by weight to about 50 percent by weight of the composition; and
the dispersible of soluble resin comprises between about 5 percent by weight to about 90 percent by weight of the composition.

33. The composition of claim 27, further comprising at least one of zinc dust, carbon black, potassium silicate platelets, titanium dioxide, trimethysilyloxy modified silica, silica, talc, clays, iron oxide, and precipitated silica.

34. The composition of claim 33, wherein the zinc dust and/or the carbon black comprises between about 1 percent by weight to about 90 percent by weight of the composition.

35. The composition of claim 27, further comprising at least one of a curing agent, an anti-settling agent; a defoaming agent, a wetting agent, a crosslinker, a corrosion inhibitor, a coalescing agent, an emulsifier, and an inorganic color pigment.

36. The composition of claim 35, wherein the crosslinker comprises between about 0.1 percent by weight to about 5 percent by weight of the composition.

37. The composition of claim 35, wherein the crosslinker includes at least one of an isocyanurate, an amine, dibutyltin dilaurate, and an imine.

38. The composition of claim 35, wherein the curing agent comprises between about 0.1 percent by weight to about 5 percent by weight of the composition.

39. The composition of claim 35, wherein the curing agent includes at least one of a polyisocyanate and an amine adduct.

40. The composition of claim 35, wherein the anti-settling agent comprises between about 0.1 percent by weight to about 5 percent by weight of the composition.

41. The composition of claim 35, wherein the corrosion inhibitor comprises between about 0.01 percent by weight to about 25 percent by weight of the composition.

42. The composition of claim 35, wherein the corrosion inhibitor includes at least one of zinc phosphate, zinc molybdate, calcium-zinc molybdate, cerium vanadium oxide, calcium-zinc phosphosilicate, cerium acetate, sodium metavanadate, and calcium zinc phosphomolybdate.

43. The composition of claim 35, wherein the coalescing agent comprises between about 0.1 percent by weight to about 5 percent by weight of the composition.

44. The composition of claim 35, wherein the coalescing agent includes a coalescing agent for a latex.

45. The composition of claim 27, further comprising a latex.

46. The composition of claim 45, wherein the latex includes an acrylate latex.

47. The composition of claim 35, wherein the inorganic color pigment includes iron oxide, cobalt, cobalt complexes, titania, metallic nanoparticles, and metallic flakes.

48. A method of formulating a liquid coating, the method comprising:
mixing a silane mixture with a dispersed or water soluble resin to form a liquid coating composition.

49. The method of claim 48, wherein the silane mixture includes a bis-silane mixture.

50. The method of claim 49, wherein the silane includes at least one of a bis-sulfur silane, a bis-benzene silane, a bis-alkane silane, a bis-alkene silane, and a bis-amino silane.

51. The method of claim 48, wherein:
the silane includes a first silane mixture comprising a vinyltriacetoxysilane and a bis-trimethoxysilylpropylamine silane in a 5:1 weight ratio; and
the silane includes a second silane component comprising at least one of a bis-[triethoxysilylpropyl]tetrasulfide silane and tetraethoxysilane.

52. The method of claim 48, further comprising:
diluting the first silane mixture with a aqueous or non-aqueous solvent to create a first silane component;
mixing the first silane component with the dispersed or soluble resin to form a liquid coating composition.

53. The method of claim 48, wherein the act of mixing the silane mixture and the disbursed or soluble resin is carried out under high shear conditions.

54. The method of claim 48, wherein:
the silane mixture comprises between about 0.5 to about 75 weight percent of the liquid coating composition; and
the dispersed or soluble resin comprises between about 25 to about 95 weight percent of the liquid coating composition.

55. The method of claim 48, further comprising:
mixing at least one of carbon black and zinc dust with at least one of the silane mixture and the dispersed or soluble resin.

56. The method of claim 55, wherein the zinc dust comprises between about 5 to about 50 weight percent of the liquid coating composition.

57. The method of claim 48, wherein the dispersed or soluble resin includes at least one of an epoxy, an acrylic, a polyurethane, and an acrylate copolymer.

58. The method of claims 48, further comprising:
mixing a crosslinker with at least one of the silane mixture and the dispersed or soluble resin.

59. The method of claim 58, wherein the crosslinker comprises between about 0.01 to about 5 weight percent of the liquid coating composition.

60. The method of claim 48, further comprising:
mixing an aqueous solvent with at least one of the silane mixture and the dispersed or soluble resin.

61. The method of claim 60, wherein the aqueous solvent comprises between about 10 to about 50 weight percent of the liquid coating composition.

62. The method of claim 48, further comprising:
mixing a non-aqueous solvent with at least one of the silane mixture and the dispersed or soluble resin.

63. The method of claim 62, wherein the non-aqueous solvent comprises between about 10 to about 50 weight percent of the liquid coating composition.

64. The method of claim 48, further comprising:
mixing an additive with at least one of the silane mixture and the dispersed or soluble resin, the additive comprising at least one of a curing agent, a thickening agent, a corrosion inhibitor, and a wetting agent.

65. The method of claim 64, wherein the additive comprises between about 0.5 to about 50 weight percent of the liquid coating.

66. The method of claim 64, wherein the curing agent includes an aliphatic amine.

67. The method of claim 62, wherein the non-aqueous solvent includes at least one of acetone, a ketone, and an alcohol.

68. The method of claim 48, wherein the liquid coating further comprises a latex.

69. A silane containing coating comprising:
zinc dust, comprising between about 70 to about 90 weight percent of a resulting coating;
a dispersible resin comprising between about 10 to about 30 weight percent of the resulting coating; and
a silane comprising between about 0.5 to about 20 weight percent of the resulting coating.

70. A silane containing coating comprising:
carbon black, comprising between about 40 to about 80 weight percent of a resulting coating;
a dispersible resin comprising between about 10 to about 30 weight percent of the resulting coating; and
a silane comprising between about 0.5 to about 50 weight percent of the resulting coating.
